(19) United States
(12) Patent Application Publication
(10) Pub. No.: US 2007/0187257 A1
(43) Pub. Date: Aug. 16, 2007

(54) Electrolytic processing apparatus and electrolytic processing method

(75) Inventors: Ikutaro Noji, Tokyo (JP); Hozumi Yasuda, Tokyo (JP); Takeshi Iizumi, Tokyo (JP); Itsuki Kobata, Tokyo (JP); Kazuto Hirokawa, Tokyo (JP); Takayuki Saito, Fujisawa (JP); Tsukuru Suzuki, Fujisawa-shi (JP); Yasushi Toma, Fujisawa-shi (JP); Akira Kodera, Fujisawa-shi (JP)

Correspondence Address: WENDEROTH, LIND & PONACK, L.L.P., 2033 K STREET N. W., SUITE 800, WASHINGTON, DC, 20006-1021, US

(73) Assignee: EBARA CORPORATION, TOKYO (JP)

(21) Appl. No.: 10/592,673

(22) PCT Filed: Mar. 16, 2005
(86) PCT No.: PCT/JP05/05301

§ 371 Date: Sep. 13, 2006

(30) Foreign Application Priority Data
Mar. 19, 2004 (JP) 2004-081178
Jun. 21, 2004 (JP) 2004-182771
Jun. 25, 2004 (JP) 2004-188958
Jun. 25, 2004 (JP) 2004-188959

(51) Int. Cl. B23H 7/00

(52) U.S. Cl. 205/640; 204/297.01

(57) ABSTRACT

An electrolytic processing apparatus can maintain a difference in electric resistance between a recessed portion and a raised portion in the surface of a workpiece, thereby providing a processed surface with improved flatness. The electrolytic processing apparatus including: a processing electrode capable of bringing into contact with or closing to a workpiece; a feeding electrode for feeding electricity to the workpiece; a contact member disposed between the workpiece and at least one of the processing electrode and the feeding electrode, the degree of deformation of said contact member by a contact load applied from the workpiece being smal

### TECHNICAL FIELD

The present invention relates to an electrolytic processing apparatus and an electrolytic processing method, and more particularly to an electrolytic processing apparatus and an electrolytic processing method useful for processing a conductive material formed in a surface of a substrate, such as a semiconductor wafer, or for removing impurities adhering to a surface of a substrate. The present invention also relates to a conditioning method for a contact member provided in such an electrolytic processing apparatus.

### BACKGROUND ART

In recent years, instead of using aluminum or aluminum alloys as a material for forming circuits on a substrate such as a semiconductor wafer, there is an eminent movement towards using copper (Cu) which has a low electric resistivity and high electromigration resistance. Copper interconnects are generally formed by filling copper into fine interconnect recesses formed in a surface of a substrate. There are known various techniques for forming such copper interconnects, including chemical vapor deposition (CVD), sputtering, and plating. According to any such technique, a copper film is formed in the substantially entire surface of a substrate, followed by removal of unnecessary copper by chemical mechanical polishing (CMP).

FIGS. 1A through 1C illustrate, in a sequence of process steps, an example of forming such a substrate W having copper interconnects. As shown in FIG. 1A, an insulating film 2, such as an oxide film of SiO₂ or a film of low-k material, is deposited on a conductive layer 1a on a semiconductor base 1 on which semiconductor devices are formed. Contact holes 3 and trenches 4 are formed in the insulating film 2 by performing a lithography/etching technique so as to provide interconnect recesses. Thereafter, a barrier layer 5 of TaN or the like is formed on the insulating film 2, and a seed layer 7 as an electric supply layer for electroplating is formed on the barrier layer by sputtering, or CVD, or the like.

Then, as shown in FIG. 1B, copper plating is performed onto the surface of the substrate W to fill the contact holes 3 and the trenches 4 with copper and, at the same time, deposit a copper film 6 on the insulating film 2. Thereafter, the copper film 6, the seed layer 7 and the barrier layer 5 on the insulating film 2 are removed by chemical mechanical polishing (CMP) so as to make the surface of the copper film 6 filled in the contact holes 3 and the trenches 4, and the surface of the insulating film 2 lie substantially on the same plane. Interconnects composed of the copper film 6 are thus formed in the insulating film 2, as shown in FIG. 1C.

Components in various types of equipments have recently become finer and have required higher accuracy. As sub-micron manufacturing technology is becoming common, the properties of materials are more and more influenced by the processing method. Under these circumstances, in such a conventional machining method that a desired portion in a workpiece is physically destroyed and removed from a surface thereof by a tool, a large number of defects may be produced to deteriorate the properties of the workpiece. Therefore, it becomes important to perform processing without deteriorating the properties of the materials.

Some processing methods, such as chemical polishing, electrolytic processing, and electrolytic polishing, have been developed in order to solve this problem. In contrast with the conventional physical processing, these methods perform removal processing or the like through chemical dissolution reaction. Therefore, these methods do not suffer from defects, such as formation of a damaged layer and dislocation, due to plastic deformation, so that processing can be performed without deteriorating the properties of the materials.

Chemical mechanical polishing (CMP), for example, generally necessitates a complicated operation and control, and needs a considerably long processing time. In addition, a sufficient cleaning of a polished surface must be conducted after the polishing treatment. This also imposes a considerable load on the slurry or cleaning liquid waste disposal. Accordingly, there is a strong demand for omitting CMP entirely or reducing a load upon CMP. Also in this connection, it is to be pointed out that though a low-k material, which has a low dielectric constant, is expected to be predominantly used in the future as a material for the insulating film (interlevel dielectric layer), the low-k material has a low mechanical strength and therefore is hard to endure the stress applied during CMP processing. Thus, also from this standpoint, there is a demand for a process that enables the flattering of a substrate without giving any stress thereto.

In order to solve such problems, it has been proposed to carry out electrolytic processing by disposing a contact member (e.g. ion exchanger) between an electrode and a workpiece, and using a liquid having a high electric resistance, such as pure water or ultrapure water, as an electrolytic liquid, thereby eliminating a mechanical stress to the workpiece and simplifying post-cleaning (see, for example, Japanese Patent Laid-Open publication No. 2003-145354).

According to this electrolytic processing method, an ion exchanger 100 in the form of a sheet or film is provided, as shown in FIG. 2A, and the ion exchanger 100 is mounted to a flat plate-shaped electrode 102 by support members 104 such that the ion exchanger 100 covers a surface of the electrode 102, as shown in FIG. 2B.

A pair of such electrodes 102, each having the ion exchanger 100 mounted thereto, is disposed such that the ion exchanger 100 is close to or in contact with a surface of a workpiece 106, as shown in FIG. 3. One electrode 102 is connected to the cathode of a power source 112 and the other electrode 102 is connected to the anode of the power source 112, while a liquid 110, such as pure water or ultrapure water, is continually supplied from a liquid supply section 108 to between the electrodes 102 and the workpiece 106. In the case of copper processing, the electrode 102 connected to the cathode of the power source 112 serves as a processing electrode 102a and the electrode 102 connected to the anode serves as a feeding electrode 102b, and that portion of the workpiece 106, which faces the processing electrode 102a, is processed.

Alternatively, as shown in FIG. 4, one electrode 102 having the ion exchanger 100 mounted thereto is disposed such that the ion exchanger 100 is close to or in contact with the workpiece 106, and the other electrode 102 without an ion exchanger is disposed close to or in contact with the workpiece 106. The one electrode 102 is connected to the cathode of the power source 112 and the other electrode 102 is connected to the anode of the power source 112, while the liquid 110, such as pure water or ultrapure water, is continually supplied from the liquid supply section 108 to between the electrodes 102 and the workpiece 106. In the case of copper processing, the electrode 102 with the ion exchanger 100 mounted thereto, connected to the cathode of the power source 112, serves as a processing electrode 102a, and the electrode 102 without an ion exchanger, connected to the anode, serves as a feeding electrode 102b, and that portion of the workpiece 106, which faces the processing electrode 102a, is processed.

Such an electrolytic processing method, because of the moderate flexibility of ion exchanger 100, enables processing of the workpiece 106 without excessive stress and damage to the workpiece 106. On the other hand, during electrolytic processing, ion exchanger 100 contacts the workpiece 106 over a fairly wide region of the surface of the ion exchanger 100, i.e., over the entire region of the surface of the electrode 102 facing the workpiece 106. Accordingly, due to wear or breakage of the ion exchanger 100 during its contact with the workpiece 106, it is sometimes difficult to practice electrolytic processing over a long time.

### DISCLOSURE OF INVENTION

In flattening processing of a workpiece by electrolytic processing using a processing electrode, a difference in processing rate is produced between a recessed portion and a raised portion in the surface of the workpiece due to a difference in electric resistance therebetween which in turn is produced by the level difference between the recessed portion and the raised portion, whereby flattening of the processing surface proceeds. Thus, making a larger difference in electric resistance between a recessed portion and a raised portion in the surface of a workpiece leads to improved flattening of the workpiece surface. It is to be noted in this regard that in a common electrolytic processing, a difference in electric resistance between a recessed portion and a raised portion in the surface of a workpiece depends on the distances between a processing electrode and the recessed and raised portions of the workpiece as well as the electric conductivity of an electrolytic liquid present therebetween.

In electrolytic processing using a contact member comprised of, for example, an ion exchanger, processing proceeds selectively in that portion of the processing surface of a workpiece which is close to or in contact with the contact member disposed between the workpiece and at least one of a processing electrode and a feeding electrode. In order to process the workpiece at a uniform processing rate over the entire processing surface of the workpiece and obtain a high-quality processed surface, it is preferred to allow a plurality of processing electrodes and feeding electrodes to evenly pass any point in the processing surface of the workpiece a plurality of times. The number and arrangement of processing electrodes and feeding electrodes are, however, inevitably restricted by such factors as prevention of a short circuit between a processing electrode and a feeding electrode, fixing of a contact member at a predetermined position, provision of a fluid supply section for supply of a fluid, etc. It is, therefore, generally difficult to dispose a number of processing electrodes and/or feeding electrodes efficiently and uniformly close to a workpiece so as to process the workpiece at a uniform processing rate over the entire processing surface of the workpiece.

In electrolytic processing carried out by bringing a contact member, comprised of an ion exchanger, into contact with a workpiece, processing proceeds selectively in the contact portion of the workpiece with the contact member and its vicinity. Accordingly, in order to always maintain processing characteristics, such as processing rate and in-plane uniformity of processing, it is required to keep the degree of contact and/or the contact pressure between a workpiece and a contact member at a predetermined value with good reproducibility.

The degree of contact and/or the contact pressure between a workpiece and a contact member, however, can change due to a dimensional change before and after a change of contact member, deterioration of contact member, etc. This change will change the contact area between a workpiece and a contact member, leading to a change in the voltage applied between a processing electrode and a feeding electrode, a change in the distribution of electric current flowing between the workpiece and the processing electrode and/or the feeding electrode, and a change in the amount of a fluid flowing in, thus adversely affecting the processing characteristics and the life of the contact member. Especially when the contact area between the workpiece and the contact member is small, an electric current flows intensively in the contact portion of the contact member with the workpiece. This may induce adhesion of a processing product to the surface of the contact member and local heat generation in the contact portion, which could melt the contact portion of the contact member. Further, when the contact pressure between the workpiece and the contact member becomes higher, the surface of the workpiece can be damaged and scratches or the like can be produced in the surface.

Further, it is desirable for electrolytic processing to keep the distance between a workpiece and a processing electrode and/or a feeding electrode at a predetermined value with good reproducibility. However, due to a dimensional change before and after a change of processing electrode and/or feeding electrode, etc., a difference may be produced between the intended distance and the actual distance between the workpiece and the processing electrode and/or the feeding electrode. This change will lead to a change in the amount of a fluid flowing in, a change in the voltage applied between the processing electrode and the feeding electrode, a change in the distribution of electric current flowing between the workpiece and the processing electrode and/or the feeding electrode, etc., thus adversely affecting the processing characteristics such as processing rate and in-plane uniformity of processing.

As described above, in electrolytic processing carried out by bringing a contact member, comprised of an ion exchanger, into contact with a workpiece, the processing proceeds selectively in the contact portion of the workpiece with the contact member, and its vicinity. Accordingly, in order to maintain desired processing characteristics such as processing rate and in-plane uniformity of processing, it is required that the conditions (flatness and surface roughness) of the contact surface of the contact member for contact with the workpiece be kept constant.

The conditions (flatness and surface roughness) of the contact surface of a contact member for contact with a workpiece, however, can change upon a change of contact member, due to deterioration of the contact surface of the contact member through its use, etc. This change will change the processing characteristics, such as processing rate and in-plane uniformity of processing, of a workpiece to be electrolytically processed through its contact with the contact member. For example, the contact area between the processing surface of the workpiece and the contact member can change, which could adversely affect the processing characteristics and the life of the contact member, as described previously.

The present invention has been made in view of the above situation in the background art. It is therefore a first object of the present invention to provide an electrolytic processing apparatus and an electrolytic processing method which can maintain a difference in electric resistance between a recessed portion and a raised portion in the surface of a workpiece, thereby providing a processed surface with improved flatness.

It is a second object of the present invention to provide an electrolytic processing apparatus and an electrolytic processing method which can reduce wear or breakage of a contact member, such as an ion exchanger, due to its contact with a workpiece during processing of the workpiece, thus enabling a long-term processing.

It is a third object of the present invention to provide an electrolytic processing apparatus and an electrolytic processing method which can partly inhibit passage of an ion current through a contact member so that one processing electrode and/or one feeding electrode can act as if a plurality of processing electrodes and/or feeding electrodes were present, making it possible to process the processing surface of a workpiece at a uniform processing rate over the entire processing surface and provide a high-quality processed surface.

It is a fourth object of the present invention to provide an electrolytic processing apparatus and an electrolytic processing method which make it possible to constantly perform processing with good reproducibility without adversely affecting processing characteristics.

It is a fifth object of the present invention to provide an electrolytic processing apparatus which makes it possible to constantly perform good uniform electrolytic processing without adversely affecting processing characteristics and the life of a contact member, and to provide a method for conditioning a contact member provided in the electrolytic processing apparatus.

The present invention provides an electrolytic processing apparatus comprising: a processing electrode capable of bringing into contact with or closing to a workpiece; a feeding electrode for feeding electricity to the workpiece; a contact member disposed between the workpiece and at least one of the processing electrode and the feeding electrode, the degree of deformation of said contact member by a contact load applied from the workpiece being smaller than the initial level difference of surface irregularities of the workpiece; a power source for applying a voltage between the processing electrode and the feeding electrode; and a fluid supply section for supplying a fluid between the workpiece and at least one of the processing electrode and the feeding electrode.

FIGS. 5 and 6 illustrate the principle of processing according to the present invention. FIG. 5 shows the ionic state in the reaction system when an ion exchanger 12a mounted on a processing electrode 14 and an ion exchanger 12b mounted on a feeding electrode 16 are brought into contact with or close to a surface of a workpiece 10, while a voltage is applied from a power source 17 to between the processing electrode 14 and the feeding electrode 16, and a fluid 18, such as ultrapure water, is supplied from a fluid supply section 19 to between the processing electrode 14, the feeding electrode 16 and the workpiece 10. FIG. 6 shows the ionic state in the reaction system when the ion exchanger 12 amounted on the processing electrode 14 is brought into contact with or close to the surface of the workpiece 10 and the feeding electrode 16 is directly contacted with the workpiece 10, while a voltage is applied from the power source 17 to between the processing electrode 14 and the feeding electrode 16, and the fluid 18, such as ultrapure water, is supplied from the fluid supply section 19 to between the processing electrode 14 and the workpiece 10.

When using a liquid, like ultrapure water, which itself has a large resistivity, it is preferred to bring the ion exchanger 12a into “contact” with the surface of the workpiece 10. This can lower the electric resistance, lower the voltage applied, and reduce the power consumption. Thus, the “contact” in the processing according to the present invention does not imply “press” for giving a physical energy (stress) to a workpiece as in CMP.

In FIGS. 5 and 6, water molecules 20 in the fluid 18, such as ultrapure water, are dissociated by the ion exchangers 12a and 12b into hydroxide ions 22 and hydrogen ions 24. The hydroxide ions 22 thus produced, for example, are carried, by the electric field between the workpiece 10 and the processing electrode 14 and by the flow of the liquid 18, to the surface of the workpiece facing the processing electrode 14, whereby the density of the hydroxide ions 22 in the vicinity of the workpiece 10 is increased, and the hydroxide ions 22 are reacted with the atoms 10a of the workpiece 10. The reaction product 26 produced by reaction is dissolved in the fluid 18, such as ultrapure water, and removed from the workpiece 10 by the flow of the fluid 18 along the surface of the workpiece 10. Removal processing of the surface layer of the workpiece 10 is thus effected.

As will be appreciated from the above, the removal processing according to the present method is effected purely by the electrochemical interaction between the reactant ions and the workpiece. According to this method, the portion of the workpiece 10 facing the processing electrode 14 is processed. Therefore, by moving the processing electrode 14, the workpiece 10 can be processed into a desired surface configuration.

The electrolytic processing apparatus according to the present invention can perform processing at a lower pressure as compared to a conventional CMP apparatus, enabling removal processing to be carried out without impairing the properties of a material even if the material is one having a low mechanical strength, such as a low-k material. Further, the use as a processing liquid of a fluid having an electric conductivity of not more than 500 μS/cm, preferably pure water, more preferably ultrapure water, can significantly reduce contamination of the surface of a workpiece and facilitate disposal of the waste liquid after processing. The present invention is also applicable to electrolytic processing using an electrolyte solution or a chelating agent, and a contact type electrolytic processing apparatus, such as a composite electrolytic processing using an abrasive or a slurry.

According to the present invention, the degree of deformation of the contact member by a contact load applied from the workpiece is made smaller than the initial level difference of surface irregularities of the workpiece so as to maintain a difference in electric resistance between a recessed portion and a raised portion in the surface of the workpiece, whereby a processed surface with enhanced flatness can be obtained.

In particular, as shown in FIG. 7A, when carrying out processing by bringing a contact member 28, for example having a high rigidity and exhibiting a small deformation by a contact load, into contact with a surface of a workpiece 27 having surface irregularities, intrusion of the contact member 28 into recessed portions in the surface of the workpiece 27 is restricted and therefore a difference in electric resistance between a raised portion and a recessed portion in the surface of the workpiece 27 is maintained, producing a difference in processing rate between the recessed portion and the raised portion. Thus, the top of the raised portion is preferentially processed at a high rate, while the bottom of the recessed portion is processed at a low rate, whereby a flattened processed surface 27a without the initial irregularities can be obtained, as shown in FIG. 7B.

On the other hand, when carrying out processing by bringing a contact member 28a, for example having a low rigidity, into contact with the surface of the workpiece 27 having surface irregularities, as shown in FIG. 8A, the contact member 28a easily intrudes into recessed portions in the surface of the workpiece 27, and therefore the electric resistance of a recessed portion can become almost equal to that of a raised portion, producing no substantial difference in processing rate between the recessed portion and the raised portion. Thus, the entire surface of the workpiece 27, including the top portions of raised portions and the bottom portions of recessed portions, is processed at substantially the same processing rate, providing a processed surface 27b with the initial irregularities remaining unremoved, as shown in FIG. 8B.

The present invention also provides another electrolytic processing apparatus comprising: a processing electrode capable of bringing into contact with or closing to a workpiece; a feeding electrode for feeding electricity to the workpiece; a contact member disposed between the workpiece and at least one of the processing electrode and the feeding electrode, said contact member having a Young's modulus of not less than 100 MPa; a power source for applying a voltage between the processing electrode and the feeding electrode; and a fluid supply section for supplying a fluid between the workpiece and at least one of the processing electrode and the feeding electrode.

A contact member having a high Young's modulus has a high rigidity and thus is less likely to deform by a contact load. It has been confirmed experimentally that use of a contact member having a Young's modulus of less than 100 MPa in electrolytic processing cannot sufficiently attain elimination of surface level difference. Thus, in order to attain sufficient elimination of surface level difference, the contact member used should preferably have a Young's modulus of not less than 100 MPa, more preferably not less than 110 MPa.

The present invention also provides yet another electrolytic processing apparatus comprising: a processing electrode capable of bringing into contact with or closing to a workpiece; a feeding electrode for feeding electricity to the workpiece; a contact member disposed between the workpiece and at least one of the processing electrode and the feeding electrode, said contact member being oriented in such a direction as to make the second moment of area larger; a power source for applying a voltage between the processing electrode and the feeding electrode; and a fluid supply section for supplying a fluid between the workpiece and at least one of the processing electrode and the feeding electrode.

The degree of deformation of a contact member by a contact load can be made small also by orienting the contact member in such a direction as to make the second moment of area larger. When a contact member 29, for example having a rectangular cross-section with a width b and a height h (b<h), is oriented vertically as shown in FIG. 9A, the second moment of area I₁, can be calculated as follows: I₁=bh³/12

On the other hand, when the contact member 29 is oriented horizontally as shown in FIG. 9B, the second moment of area I₂ can be calculated as follows: I₂=hb³/12 (<I₁=bh³/12)

Thus, when a contact member having a rectangular cross-section is employed, the second moment of area can be maximized by orienting the contact member in the vertical direction.

The present invention also provides yet another electrolytic processing apparatus comprising; a processing electrode capable of bringing into contact with or closing to a workpiece; a feeding electrode for feeding electricity to the workpiece; a contact member disposed between the workpiece and at least one of the processing electrode and the feeding electrode, said contact member being of the form of a sheet or film and disposed such that an end surface faces the work piece; a power source for applying a voltage between the processing electrode and the feeding electrode; and a fluid supply section for supplying a fluid between the workpiece and at least one of the processing electrode and the feeding electrode.

By using a contact member, for example an ion exchanger, in the form of a thin sheet or film, and disposing the contact member such that its one end surface faces a workpiece during processing so that only the end surface contacts the workpiece, the contact member is allowed to make a linear contact with the workpiece with a narrow contact width. This can reduce wear or breakage of the contact member due to its contact with the workpiece, enabling a long-term processing.

The contact member is preferably comprised of an ion exchanger, an insulator or an electric conductor, or a laminate of any combination thereof.

By using an ion exchanger as a contact member and carrying out electrolytic processing of a surface of a workpiece by bringing the ion exchanger into contact with the surface, it becomes possible to promote dissociation of water molecules in a liquid, such as ultrapure water, into hydroxide ions and hydrogen ions, thus increasing the amount of dissociated products.

The present invention also provides yet another electrolytic processing apparatus comprising: a processing electrode capable of bringing into contact with or closing to a workpiece; a feeding electrode for feeding electricity to the workpiece; a contact member disposed between the workpiece and at least one of the processing electrode and the feeding electrode, said contact member comprising a rigid support covered with a cover material for contact with the workpiece; a power source for applying a voltage between the processing electrode and the feeding electrode; and a fluid supply section for supplying a fluid between the workpiece and at least one of the processing electrode and the feeding electrode.

The use of a support having a high rigidity can reduce the degree of deformation of the contact member by a contact load applied from a workpiece, and enables the cover material, covering the support, to function as a contact member for contact with the surface of the workpiece.

The support preferably has a Young's modulus of not less than 100 MPa, more preferably not less than 110 MPa.

The support is preferably composed of an insulating material.

The cover material is preferably comprised of an ion exchanger, an insulator or an electric conductor, or a laminate of any combination thereof.

The contact member is preferably supported floatingly by at least one of the processing electrode and the feeding electrode.

This makes it possible to more precisely control a contact load applied from a workpiece to the contact member so that the degree of deformation of the contact member by the contact load can be made smaller than the initial level difference of surface irregularities of the workpiece. The contact member may be floatingly supported by an elastic body, such as a spring, or a fluid (air or water).

The contact member may be a polishing pad or cloth.

The fluid is, for example, pure water, ultrapure water or a liquid having an electric conductivity of not more than 500 μS/cm, or an electrolyte solution.

The present invention also provides an electrolytic processing method comprising: bringing a processing electrode close to a workpiece; applying a voltage between the processing electrode and a feeding electrode for feeding electricity to the workpiece; disposing a contact member between the workpiece and at least one of the processing electrode and the feeding electrode; supplying a fluid between the workpiece and at least one of the processing electrode and the feeding electrode; and bringing the contact member into contact with a surface of the workpiece such that the degree of deformation of the contact member by a contact load is smaller than the initial level difference of surface irregularities of the workpiece, thereby processing the surface of the workpiece.

The present invention also provides another electrolytic processing method comprising: bringing a processing electrode close to a workpiece; applying a voltage between the processing electrode and a feeding electrode for feeding electricity to the workpiece; disposing a contact member having a Young's modulus of not less than 100 MPa between the workpiece and at least one of the processing electrode and the feeding electrode; supplying a fluid between the workpiece and at least one of the processing electrode and the feeding electrode; and bringing the contact member into contact with a surface of the workpiece, thereby processing the surface of the workpiece.

The present invention also provides yet another electrolytic processing method comprising: bringing a processing electrode close to a workpiece; applying a voltage between the processing electrode and a feeding electrode for feeding electricity to the workpiece; disposing a contact member between the workpiece and at least one of the processing electrode and the feeding electrode such that the contact member is oriented in such a direction as to make the second moment of area larger; supplying a fluid between the workpiece and at least one of the processing electrode and the feeding electrode; and bringing the contact member into contact with a surface of the workpiece, thereby processing the surface of the workpiece.

The present invention also provides yet another electrolytic processing method comprising: bringing a processing electrode close to a workpiece; applying a voltage between the processing electrode and a feeding electrode for feeding electricity to the workpiece; disposing a contact member in the form of a sheet or film between the workpiece and at least one of the processing electrode and the feeding electrode such that an end surface of the contact member faces the workpiece; supplying a fluid between the workpiece and at least one of the processing electrode and the feeding electrode; and bringing the contact member into contact with a surface of the workpiece, thereby processing the surface of the workpiece.

The present invention also provides yet another electrolytic processing method comprising: bringing a processing electrode close to a workpiece; applying a voltage between the processing electrode and a feeding electrode for feeding electricity to the workpiece; disposing a contact member between the workpiece and at least one of the processing electrode and the feeding electrode, said contact member comprising a rigid support covered with a cover material for contact with the workpiece; supplying a fluid between the workpiece and at least one of the processing electrode and the feeding electrode; and bringing the contact member into contact with a surface of the workpiece, thereby processing the surface of the workpiece.

The present invention also provides yet another electrolytic processing apparatus comprising: a processing electrode capable of bringing into contact with or closing to a workpiece; a feeding electrode for feeding electricity to the workpiece; a contact member disposed between the workpiece and at least one of the processing electrode and the feeding electrode, said contact member comprising at least one electrolyte portion containing an electrolyte and at least one non-electrolyte portion not containing an electrolyte; a power source for applying a voltage between the processing electrode and the feeding electrode; a drive section for moving the workpiece and at least one of the processing electrode and the feeding electrode relative to each other; and a fluid supply section for supplying a fluid between the workpiece and at least one of the processing electrode and the feeding electrode.

The provision of the contact member, comprising at least one electrolyte portion containing an electrolyte and at least one non-electrolyte portion not containing an electrolyte, between a workpiece and at least one of the processing electrode and the feeding electrode allows an ion current to pass through only the electrolyte portion of the contact member while inhibiting passage of an ion current through the non-electrolyte portion. This allows one processing electrode, for example, when covered with the contact member, to act as if a plurality of processing electrodes were present.

The electrolyte refers to a substance dissociable into ions, i.e., an ionic conductor, and includes an acid, a base, a salt solution, a molten salt, a solid electrolyte, etc. An electrolyte in the form of a solution refers to an electrolyte solution, while an electrolyte in the form of a solid refers to a solid electrolyte. The electrolyte, in a limited sense, refers to a salt dissolved in an electrolyte solution, and in a more limited sense, refers to a supporting salt for imparting electric conductivity to an electrolyte solution. Not only a solution of a salt in a solvent, but a molten salt or an ionic liquid may also be used as an electrolyte. The solid electrolyte is a solid permeable to ions. An electrolyte is used in electric cells, electrolytic condensers, etc. Though most electric cells use a liquid electrolyte, some cells use a solid electrolyte.

The electrolyte preferably is a solid electrolyte.

The solid electrolyte refers to an electrolyte of the type that an ion moves in the solid, and is also called solid ionics. While an electrolyte solution carries two types or more of ions, a solid electrolytic usually carries only one type of ion. An ion-exchange membrane is a solid polymer electrolyte, and is used in solid polymer-type fuel cells and scolid oxide-type fuel cells. The use of a solid electrolyte in a cell has the advantage of eliminating the use of a diaphragm.

The electrolyte portion is preferably disposed so as to face at least one of the processing electrode and the feeding electrode.

In case a number of processing electrodes and/or feeding electrodes are disposed in the form of pins, the contact member can be disposed such that the electrolyte portion faces the processing electrodes and/or feeding electrodes and the non-electrolyte portion may not face the electrodes. By inhibiting the passage of an ion current in the non-electrolyte portion, the flow of an ion current can be controlled with ease.

Preferably, the contact member is disposed integrally with the processing electrode and the feeding electrode.

This facilitates the production of the contact member and also facilitates positioning of the contact member at a desired position.

The non-electrolyte portion maybe composed of an insulating material or a conductive material such as a conductive pad.

By interposing a non-electrolyte portion composed of a conductive material between the feeding electrode and a workpiece, electricity can be fed from the feeding electrode directly to the workpiece via the conductive material.

Preferably, the electrolyte portion and/or the non-electrolyte portion is disposed such that it passes any point in the processing surface of the workpiece a plurality of times during the relative movement between the workpiece and at least one of the processing electrode and the feeding electrode.

Even when a variation in the processing rate is produced in those portions in the processing surface of the workpiece which are close to or in contact with the electrolyte portions and/or non-electrolyte portions, the various processing rates can be averaged by allowing the electrolyte portions and/or the non-electrolyte portions of the contact member to pass any point in the processing surface of the workpiece a plurality of times, thereby uniformizing the processing rate over the entire surface of the workpiece.

The electrolyte portion and/or the non-electrolyte portion may also be disposed such that it passes any point in the processing surface of the workpiece substantially evenly during the relative movement between the workpiece and at least one of the processing electrode and the feeding electrode.

Also by thus allowing the electrolyte portions and/or the non-electrolyte portions of the contact member to pass any point in the processing surface of the workpiece substantially evenly, various processing rates in those portions in the processing surface of the workpiece which are close to or in contact with the electrolyte portions and/or the non-electrolyte portions can be averaged, thereby uniformizing the processing rate over the entire surface of the workpiece.

Preferably, the electrolyte portion is comprised of an ion-exchange group portion containing an ion-exchange group.

The use, as the electrolyte portion of the contact member, of an ion-exchange group portion containing an ion-exchange group can promote the dissociation of water molecules in the liquid, such as pure water, into hydroxide ions and hydrogen ions, thus increasing the amount of dissociated products. The ion-exchange group is at least one of a strongly acidic cation-exchange group, a weekly acidic cation-exchange group, a strongly basic anion-exchange group and a weakly basic anion-exchange group, or a combination thereof.

The present invention also provides yet another electrolytic processing apparatus comprising: a processing electrode capable of bringing into contact with or closing to a workpiece; a feeding electrode for feeding electricity to the workpiece; a contact member disposed between the workpiece and at least one of the processing electrode and the feeding electrode, said contact member comprising a laminate of at least one layer of electrolyte portion containing an electrolyte and at least one layer of non-electrolyte portion not containing an electrolyte; a power source for applying a voltage between the processing electrode and the feeding electrode; a drive section forming the workpiece and at least one of the processing electrode and the feeding electrode relative to each other; and a fluid supply section for supplying a fluid between the workpiece and at least one of the processing electrode and the feeding electrode.

The provision of the contact member, comprising a laminate of at least one layer of electrolyte portion containing an electrolyte and at least one layer of non-electrolyte portion not containing an electrolyte, between a workpiece and at least one of the processing electrode and the feeding electrode allows an ion current to pass through only the electrolyte portion of the contact member while inhibiting passage of an ion current through the non-electrolyte portion. This allows one processing electrode, for example, when covered with the contact member, to act as if the processing electrode were divided into a plurality of parts.

The laminate is preferably disposed such that an end surface of the electrolyte portion and an end surface of the non-electrolyte portion face the workpiece.

The present invention also provides yet another electrolytic processing method comprising: bringing a processing electrode close to a workpiece; applying a voltage between the processing electrode and a feeding electrode for feeding electricity to the workpiece; disposing a contact member between the workpiece and at least one of the processing electrode and the feeding electrode, said contact member comprising at least one electrolyte portion containing an electrolyte and at least one non-electrolyte portion not containing an electrolyte; and supplying a fluid between the workpiece and at least one of the processing electrode and the feeding electrode, while moving the workpiece and at least one of the processing electrode and the feeding electrode relative to each other.

The present invention also provides yet another electrolytic processing method comprising: bringing a processing electrode close to a workpiece; applying a voltage between the processing electrode and a feeding electrode for feeding electricity to the workpiece; disposing a contact member between the workpiece and at least one of the processing electrode and the feeding electrode, said contact member comprising a laminate of at least one layer of electrolyte portion containing an electrolyte and at least one layer of non-electrolyte portion not containing an electrolyte; and supplying a fluid between the workpiece and at least one of the processing electrode and the feeding electrode, while moving the workpiece and at least one of the processing electrode and the feeding electrode relative to each other.

The present invention also provides yet another electrolytic processing apparatus comprising: a processing electrode capable of bringing into contact with or closing to a workpiece; a feeding electrode for feeding electricity to the workpiece; a contact member capable of contacting the workpiece, disposed between the workpiece and at least one of the processing electrode and the feeding electrode; a power source for applying a voltage between the processing electrode and the feeding electrode; a drive section for moving the workpiece and at least one of the processing electrode and the feeding electrode relative to each other; a fluid supply section for supplying a fluid between the workpiece and at least one of the processing electrode and the feeding electrode; a detector for detecting the contact state between the contact member and the workpiece; and a control section for controlling the degree of contact between the contact member and the workpiece based on a signal from the detector.

In carrying out electrolytic processing by bringing a workpiece into contact with the contact member, the control section can control the degree of contact between the contact member and the workpiece by, for example, feedback control so as to maintain a constant degree of contact.

The present invention also provides yet another electrolytic processing apparatus comprising: a processing electrode capable of bringing into contact with or closing to a workpiece; a feeding electrode for feeding electricity to the workpiece; a contact member capable of contacting the workpiece, disposed between the workpiece and at least one of the processing electrode and the feeding electrode; a power source for applying a voltage between the processing electrode and the feeding electrode; a drive section for moving the workpiece and at least one of the processing electrode and the feeding electrode relative to each other; a fluid supply section for supplying a fluid between the workpiece and at least one of the processing electrode and the feeding electrode; a detector for detecting the contact state between the contact member and the workpiece; and a control section for controlling the contact pressure between the contact member and the workpiece based on a signal from the detector.

In carrying out electrolytic processing by bringing a workpiece into contact with the contact member, the control section can control the contact pressure between the contact member and the workpiece by, for example, feedback control so as to maintain a constant contact pressure.

The detector is, for example, an electric sensor for detecting a change in the electric resistance between the processing electrode and the feeding electrode upon contact between the contact member and the workpiece, a pressure sensor for detecting the contact pressure between the contact member and the workpiece, or an optical sensor for detecting the gap between the contact member and the workpiece with a laser beam, or a combination thereof.

By detecting the point of time at which the contact member comes into contact with the workpiece by an electric sensor or an optical sensor, and controlling the feed of the contact member by, for example, proportional control from the point of time at which the contact member comes into contact with the workpiece, the degree of contact or the contact pressure between the workpiece and the contact member can be kept constant. In the case of using a pressure sensor as the detector, based on an output from the pressure sensor or on a pre-determined relationship between the degree of contact and the contact pressure, feedback control can be performed so that the degree of contact or the contact pressure between the workpiece and the contact member can be kept constant.

In a preferred embodiment of the present invention, the control section controls the distance between the workpiece and at least one of the processing electrode and the feeding electrode based on a signal from the detector, thereby controlling the contact pressure between the contact member and the workpiece.

Preferably, the contact member is a conductive pad, and is disposed either between the workpiece and the processing electrode or between the workpiece and the feeding electrode.

The present invention also provides yet another electrolytic processing apparatus comprising: a processing electrode capable of bringing into contact with or closing to a workpiece; a feeding electrode for feeding electricity to the workpiece; a power source for applying a voltage between the processing electrode and the feeding electrode; a drive section for moving the workpiece and at least one of the processing electrode and the feeding electrode relative to each other; a fluid supply section for supplying a fluid between the workpiece and at least one of the processing electrode and the feeding electrode; a detector for detecting the distance between the workpiece and at least one of the processing electrode and the feeding electrode; and a control section for controlling the distance between the workpiece and at least one of the processing electrode and the feeding electrode based on a signal from the detector.

In carrying out electrolytic processing while keeping a workpiece and at least one of the processing electrode and the feeding electrode apart from each other, the control section can control, for example, by feedback control, the distance between the workpiece and at least one of the processing electrode and the feeding electrode so as to maintain a constant distance.

The present invention also provides yet another electrolytic processing method comprising: bringing a processing electrode close to a workpiece; applying a voltage between the processing electrode and a feeding electrode for feeding electricity to the workpiece; bringing a contact member, disposed between the workpiece and at least one of the processing electrode and the feeding electrode, into contact with the workpiece; moving the workpiece and at least one of the processing electrode and the feeding electrode relative to each other, while keeping the degree of contact between the workpiece and the contact member at a predetermined level; and supplying a fluid between the workpiece and at least one of the processing electrode and the feeding electrode.

The present invention also provides yet another electrolytic processing method comprising: bringing a processing electrode close to a workpiece; applying a voltage between the processing electrode and a feeding electrode for feeding electricity to the workpiece; bringing a contact member, disposed between the workpiece and at least one of the processing electrode and the feeding electrode, into contact with the workpiece; moving the workpiece and at least one of the processing electrode and the feeding electrode relative to each other, while keeping the contact pressure between the workpiece and the contact member at a predetermined value; and supplying a fluid between the workpiece and at least one of the processing electrode and the feeding electrode.

The present invention also provides yet another electrolytic processing method comprising: bringing a processing electrode close to a workpiece; applying a voltage between the processing electrode and a feeding electrode for feeding electricity to the workpiece; moving the workpiece and at least one of the processing electrode and the feeding electrode relative to each other, while keeping the distance between the workpiece and at least one of the processing electrode and the feeding electrode at a predetermined value; and supplying a fluid between the workpiece and at least one of the processing electrode and the feeding electrode.

The present invention also provides yet another electrolytic processing apparatus comprising: a processing electrode capable of bringing into contact with or closing to a workpiece; a feeding electrode for feeding electricity to the workpiece; a contact member capable of contacting the workpiece, disposed between the workpiece and at least one of the processing electrode and the feeding electrode; a power source for applying a voltage between the processing electrode and the feeding electrode; a drive section for moving the workpiece and at least one of the processing electrode and the feeding electrode relative to each other; a fluid supply section for supplying a fluid between the workpiece and at least one of the processing electrode and the feeding electrode; and a conditioning section including a conditioner for contacting a contact surface, which is for contact with the workpiece, of the contact member to condition the contact surface.

The contact surface of the contact member, which is to contact a workpiece during electrolytic processing, can be conditioned by the conditioner of the conditioning section so that the flatness and the surface roughness of the contact surface each become a predetermined value or lower.

The present invention also provides yet another electrolytic processing apparatus comprising: a processing electrode capable of bringing into contact with or closing to a workpiece; a feeding electrode for feeding electricity to the workpiece; a contact member capable of contacting the workpiece, disposed between the workpiece and at least one of the processing electrode and the feeding electrode; a power source for applying a voltage between the processing electrode and the feeding electrode; a drive section for moving the workpiece and at least one of the processing electrode and the feeding electrode relative to each other; a fluid supply section for supplying a fluid between the workpiece and at least one of the processing electrode and the feeding electrode; and a holder for selectively holding the workpiece or a conditioner for contacting a contact surface, which is for contact with the workpiece, of the contact member to condition the contact surface.

The contact surface of the contact member for contact with a workpiece can be conditioned with the conditioner by operating as if carrying out electrolytic processing of the conditioner. During the conditioning, the conditioner is held by the holder that holds the workpiece during electrolytic processing and releases the holding of the workpiece after electrolytic processing.

In a preferred embodiment of the present invention, at least that portion of the conditioner, which contacts the contact portion of the contact member, is comprised of a polishing body comprising fixed abrasive grains.

The polishing body (fixed abrasive) can provide a rigid polishing surface, with which a stable polishing rate and a highly flat polished surface can be obtained while preventing the formation of scratches in the contact surface of the contact member. Furthermore, conditioning of the contact member can be carried out while supplying a polishing liquid not containing a polishing abrasive, pure water, ultrapure water or a liquid having an electric conductivity of not more than 500 μS/cm. This makes it possible to carry out conditioning of contact member simultaneously with electrolytic processing and to reduce burdens on the environment.

Preferably, the flatness of the polishing surface of the polishing body for contact with the contact surface of the contact member is not more than 100 μm, and the diameter of the abrasive grains is not more than 5 μm.

This makes it possible to condition the contact member so that the flatness of the contact surface of the contact member for contact with the workpiece becomes not more than 100 μm and the surface roughness of the contact surface becomes not more than 5 μm.

The conditioner may also be a polishing pad for carrying out polishing using free abrasive grains preferably having a diameter of not more than 5 μm.

A polishing pad generally has a low rigidity. The use of a polishing pad having a high rigidity can provide a flatter polished surface.

The present invention also provides a method for conditioning a contact member comprising: bringing a conditioner into contact with a contact surface, which is for contact with a workpiece, of a contact member for contacting the workpiece to carry out electrolytic processing of the workpiece; and moving the contact member and the conditioner relative to each other in the presence of a liquid, thereby conditioning the contact member.

The conditioning of the contact member may be carried out after setting or change of the contact member, during an interval between electrolytic processings, or simultaneously with electrolytic processing of the workpiece.

The present invention also provides another method for conditioning a contact member comprising: holding a conditioner by a holder for detachably holding a workpiece; bringing the conditioner into contact with a contact surface, which is for contact with a workpiece, of a contact member for contacting the workpiece to carry out electrolytic processing of the workpiece; and moving the contact member and the conditioner relative to each other in the presence of a liquid, thereby conditioning the contact member.

It is preferred that the contact member be conditioned so that the flatness of the contact surface of the contact member for contact with the workpiece is made not more than 100 μm and the surface roughness of the contact surface is made not more than 5 μm.

### BRIEF DESCRIPTION OF DRAWINGS

FIGS. 1A through 1C are diagrams illustrating, in a sequence of process steps, an example of producing a substrate having copper interconnects;

FIGS. 2A and 2B are diagrams showing an electrode, to which anion exchanger is mounted, for use in a conventional electrolytic processing;

FIG. 3 is a diagram illustrating a manner of carrying out electrolytic processing using the electrode shown in FIG. 2;

FIG. 4 is a diagram illustrating another manner of carrying out electrolytic processing using the electrode shown in FIG. 2;

FIG. 5 is a diagram illustrating the principle of electrolytic processing according to the present invention as carried out by bringing a processing electrode and a feeding electrode, both having an ion exchanger mounted thereon, close to a substrate (workpiece), and supplying pure water or a liquid having an electric conductivity of not more than 500 μS/cm between the processing electrode, the feeding electrode and the substrate (workpiece);

FIG. 6 is a diagram illustrating the principle of electrolytic processing according to the present invention as carried out by mounting the ion exchanger only on the processing electrode and supplying pure water or a liquid having an electric conductivity of not more than 500 μS/cm between the processing electrode and the substrate (workpiece) while keeping the feeding electrode in contact with the substrate;

FIGS. 7A and 7B are diagrams illustrating processing of a workpiece having surface irregularities as carried out by using a contact member having a high rigidity;

FIGS. 8A and 8B are diagrams illustrating processing of a workpiece having surface irregularities as carried out by using a contact member having a low rigidity;

FIGS. 9 A and 9B are diagrams illustrating a difference in the second moment of area between vertical arrangement and horizontal arrangement of the same contact member;

FIG. 10 is a planview showing the construction of a substrate processing apparatus incorporating an electrolytic processing apparatus according to an embodiment of the present invention;

FIG. 11 is a plan view schematically showing the electrolytic processing apparatus shown in FIG. 10;

FIG. 12 is a vertical sectional front view of the electrolytic processing apparatus of FIG. 11;

FIG. 13A is a graph showing the relationship between electric current and time, as observed in electrolytic processing of a surface of a substrate having a film of two difference materials formed in the surface, and FIG. 13B is a graph showing the relationship between voltage and time, as observed in electrolytic processing of a surface of a substrate having a film of two different materials formed in the surface;

FIGS. 14A through 14C are diagrams showing various contact members;

FIG. 15 is a diagram showing yet another contact member;

FIG. 16 is a cross-sectional view of an electrolytic processing apparatus according to another embodiment of the present invention;

FIG. 17 is a planview showing the construction of a substrate processing apparatus incorporating an electrolytic processing apparatus according to yet another embodiment of the present invention;

FIG. 18 is a schematic vertical sectional view of the electrolytic processing apparatus shown in FIG. 17;

FIG. 19 is a plan view of an electrode section of the electrolytic processing apparatus shown in FIG. 17;

FIG. 20 is a perspective view of an electrode disposed in the electrode section of the electrolytic processing apparatus shown in FIG. 17;

FIGS. 21A and 21B are diagrams showing another electrode;

FIGS. 22A and 22B are diagrams showing yet another electrode;

FIGS. 23A and 23B are diagrams showing yet another electrode;

FIGS. 24A and 24B are diagrams showing yet another electrode;

FIGS. 25A through 25C are diagrams showing various other electrodes;

FIG. 26 is a plan view showing the construction of a substrate processing apparatus incorporating an electrolytic processing apparatus according to yet another embodiment of the present invention;

FIG. 27 is a schematic vertical sectional view of the electrolytic processing apparatus shown in FIG. 26;

FIG. 28A is a plan view schematically showing the relationship between an electrode section and a hollow motor of the electrolytic processing apparatus shown in FIG. 27, and FIG. 28B is a cross-sectional view taken along the line A-A of FIG. 28A;

FIG. 29 is a plan view of the electrolytic processing apparatus of FIG. 27;

FIG. 30 is a perspective view of an electrode used in Comparative Example 1;

FIG. 31 is a vertical sectional front view schematically showing an electrolytic processing apparatus according to yet another embodiment of the present invention;

FIG. 32A is a diagram showing another contact member, and FIG. 32B is a diagram showing yet another contact member mounted to another electrode section;

FIG. 33 is a vertical sectional front view schematically showing an electrolytic processing apparatus according to yet another embodiment of the present invention;

FIG. 34 is a plan view showing an electrode section of the electrolytic processing apparatus shown in FIG. 33;

FIG. 35 is a plan view schematically showing an electrolytic processing apparatus according to yet another embodiment of the present invention;

FIG. 36 is a vertical sectional front view of the electrolytic processing apparatus of FIG. 35;

FIG. 37 is a vertical sectional front view schematically showing an electrolytic processing apparatus according to yet another embodiment of the present invention;

FIG. 38 is a plan view of the electrolytic processing apparatus of FIG. 37;

FIG. 39 is a graph showing the relationship between the electric resistance between a processing electrode and a feeding electrode, and the distance between a substrate (workpiece) and a contact member as observed when bringing the substrate closer to and into contact with the contact member while applying a very low voltage between the processing electrode and the feeding electrode;

FIG. 40 is a vertical sectional front view schematically showing an electrolytic processing apparatus according to yet another embodiment of the present invention;

FIG. 41 is a vertical sectional front view schematically showing an electrolytic processing apparatus according to yet another embodiment of the present invention;

FIG. 42 is a vertical sectional front view schematically showing an electrolytic processing apparatus according to yet another embodiment of the present invention;

FIG. 43 is a plan view of the electrolytic processing apparatus of FIG. 42; and

FIG. 44 is a vertical sectional front view schematically showing an electrolytic processing apparatus according to yet another embodiment of the present invention.

### BEST MODE FOR CARRYING OUT THE INVENTION

Preferred embodiments of the present invention will now be described with reference to the drawings.

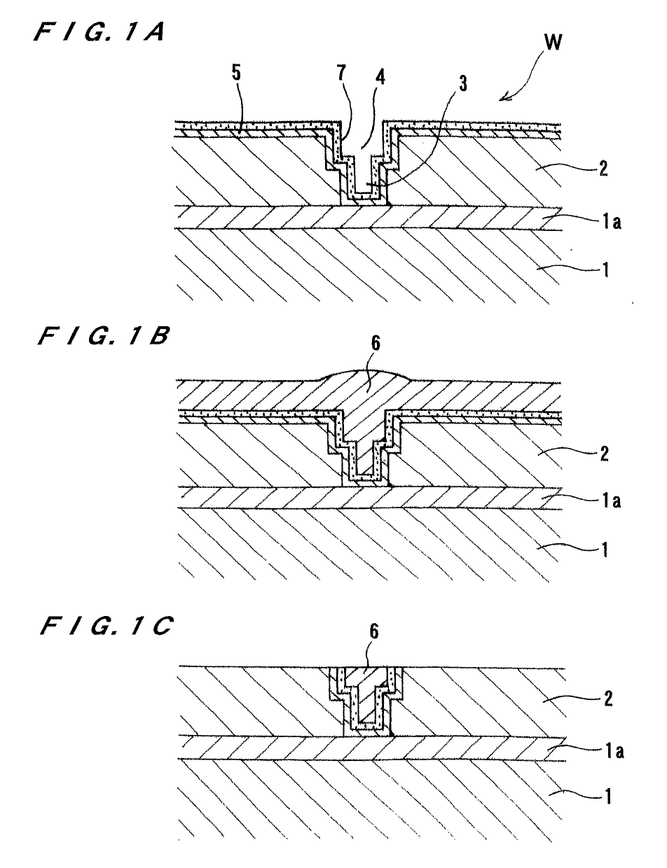

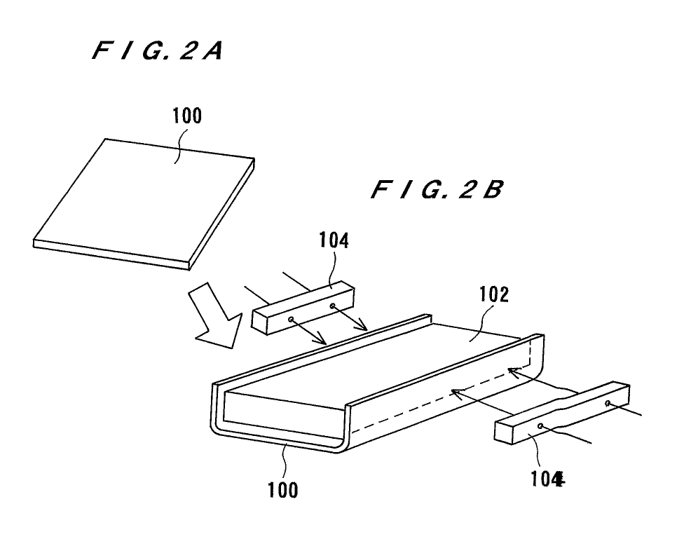

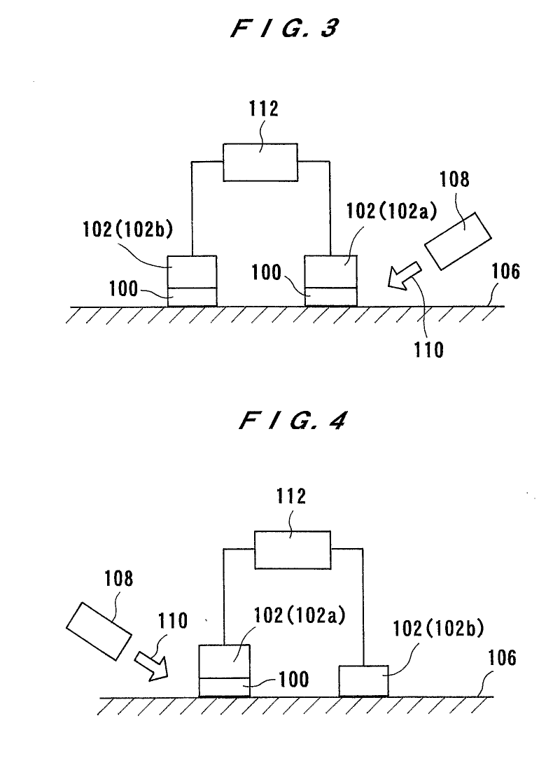

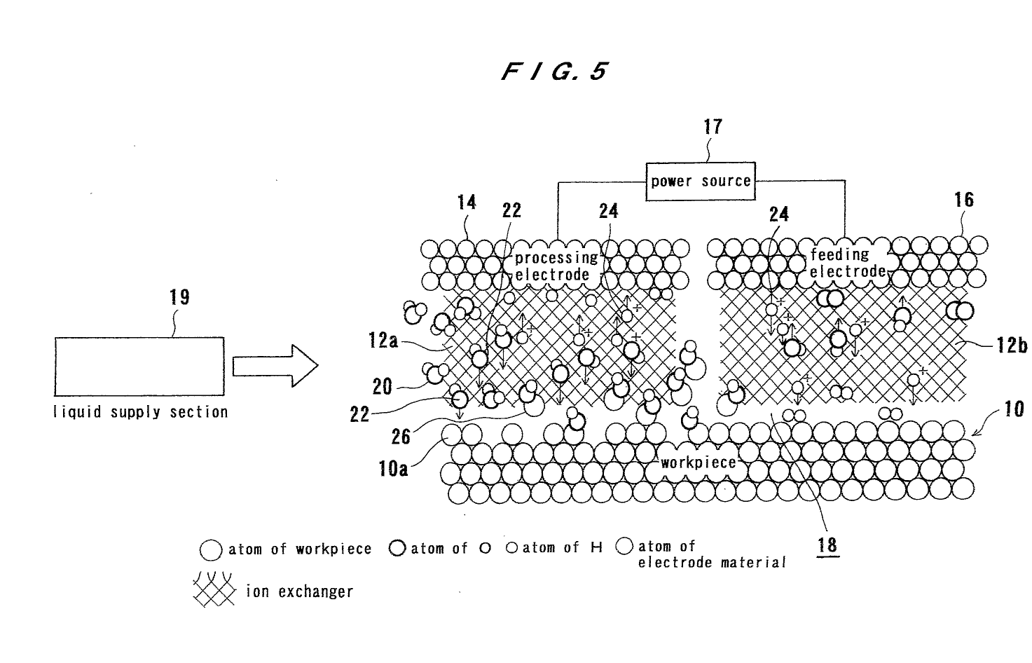

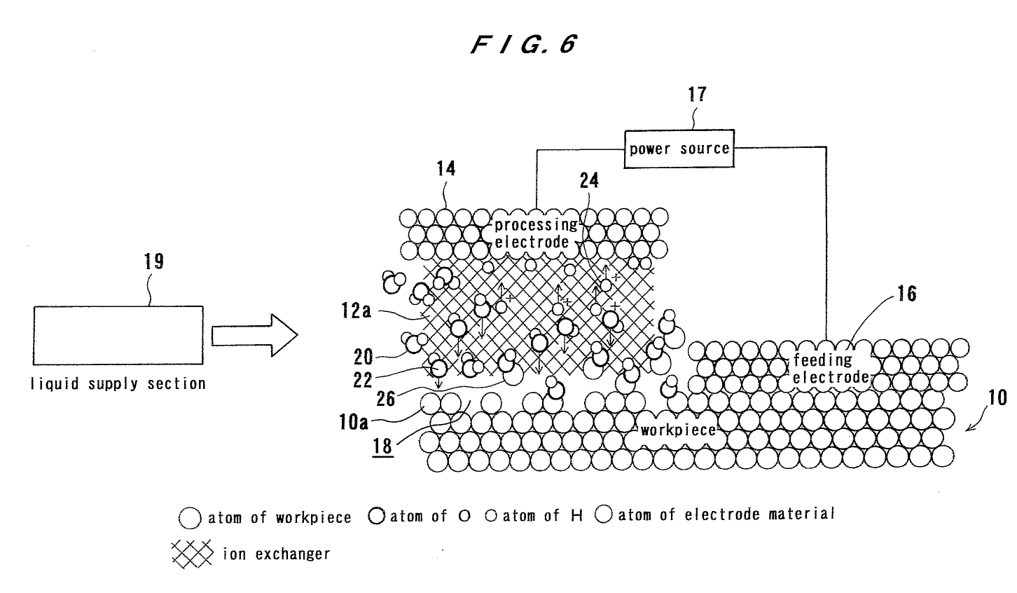

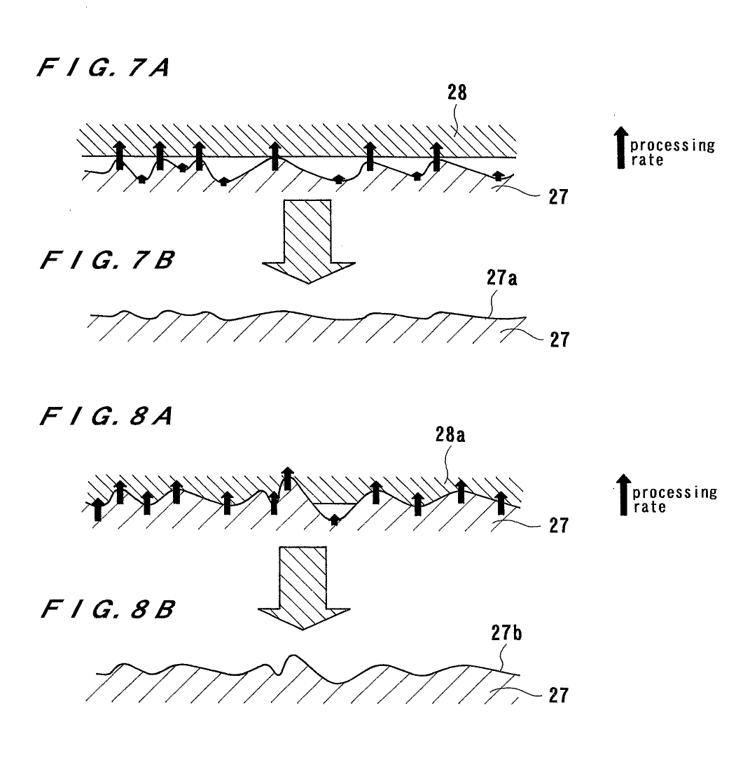

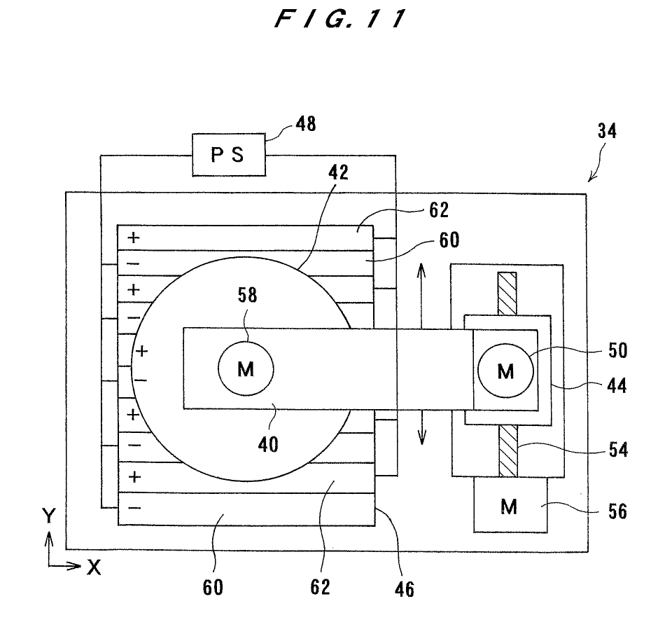

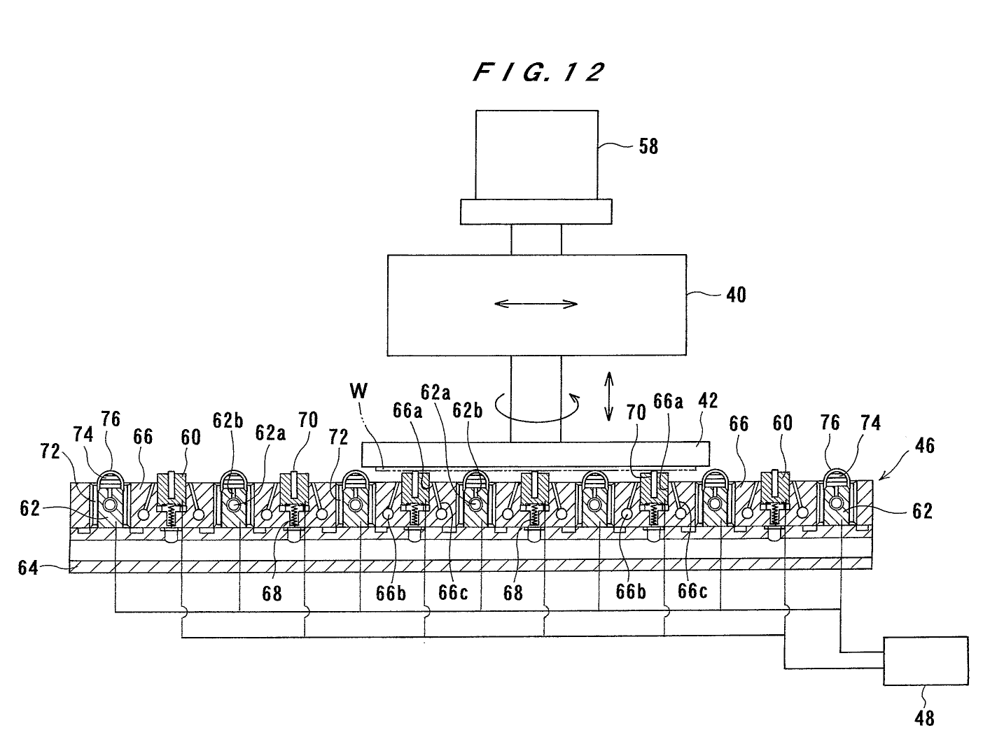

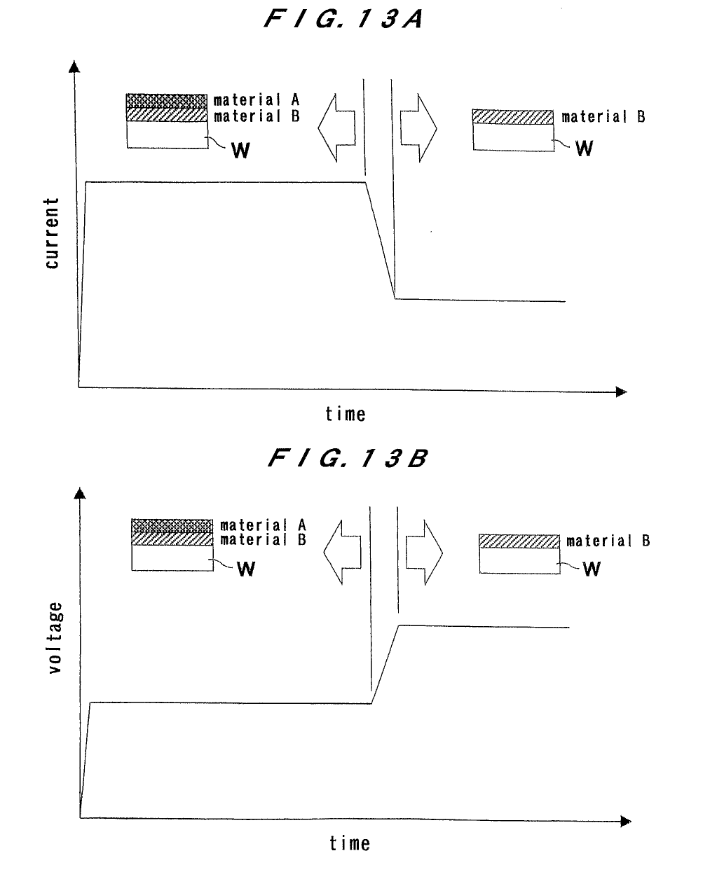

FIG. 10 is a plan view showing the construction of a substrate processing apparatus incorporated an electrolytic processing apparatus according to an embodiment of the present invention. As shown in FIG. 10, the substrate processing apparatus comprises a pair of loading/unloading sections 30 as a carry-in and carry-out section for carrying in and carrying out a cassette housing a substrate, e.g. a substrate W having a copper film 6 as a conductive film (processing object) in the surface as shown in FIG. 1B, a reversing machine 32 for reversing the substrate W, an electrolytic processing apparatus 34, and cleaning section 39 for cleaning and drying the substrate W after electrolytic processing. These devices are disposed in series. A transport robot 36 as a transport device, which can move parallel to these devices for transporting and transferring the substrate W therebetween, is provided. The substrate processing apparatus is also provided with a monitor section 38, disposed adjacent to the loading/unloading sections 30, for monitoring a voltage applied between the bellow-described processing electrodes 60 and the feeding electrodes 62 during electrolytic processing in the electrolytic processing apparatus 34, or an electric current flowing therebetween.

FIG. 11 is a plan view schematically showing the electrolytic processing apparatus 34 shown in FIG. 10, and FIG. 12 is a vertical sectional left side view (arrow X) of FIG. 11. As shown in FIGS. 11 and 12, the electrolytic processing apparatus 34 includes an arm 40 that can move vertically and make a reciprocation movement in a horizontal plane, a substrate holder 42, supported at the free end of the arm 40, for attracting and holding the substrate W with its front surface facing downward (face-down), moveable flame 44 to which the arm 40 is attached, a rectangular electrode section 46, and a power source 48 electrically connected to bellow-described processing electrodes 60 and feeding electrodes 62 of electrode section 46.

A vertical-movement motor 50 is mounted on the upper end of the moveable flame 44. A ball screw (not shown), which extends vertically, is connected to the vertical-movement motor 50. The base of the arm 40 is engaged with the ball screw, and the arm 40 moves up and down via the ball screw by the actuation of the vertical-movement motor 50 The moveable flame 44 is connected to a ball screw 54 that extends horizontally, and moves back-and-forth in a horizontal plane with the arm 40 by the actuation of a reciprocating motor 56.

The substrate holder 42 is connected to a substrate-rotating motor 58 supported at the free end of the arm 40. The substrate holder 42 is rotated (about its own axis) by the actuation of the substrate-rotating motor 58. The arm 40 can move vertically and make a reciprocation movement in the horizontal direction, as described above, the substrate holder 42 can move vertically and make a reciprocation movement in the horizontal direction integrated with the arm 40.

Next, the electrode section 46 of this embodiment will be described. The electrode section 46 has a plurality of processing electrodes 60 and feeding electrodes 62, extending in an X direction (see FIG. 11), which are arranged alternately in parallel on a rectangular tabular electrode base 64. According to this embodiment, the processing electrodes 60 are connected to the cathode of a power source 48 and the feeding electrodes 62 are connected to the anode of the power source 48. This applies to processing of e.g. copper, because electrolytic processing of copper proceeds on the cathode side.

Depending upon the material to be processed, the electrode connected to the cathode of the power source may serve as a feeding electrode, and the electrode connected to the anode may serve as a processing electrode. Thus, when the material to be processed is copper, molybdenum, iron, or the like, the electrolytic processing action occurs on the cathode side, and therefore the electrode connected to the cathode of the power source 48 becomes a processing electrode 60, and the electrode connected to the anode becomes a feeding electrode 62. On the other hand, when the material to be processed is aluminum, silicon, or the like, the electrolytic processing action occurs on the anode side, and therefore the electrode connected to the anode of the power source becomes a processing electrode and the electrode connected to the cathode becomes a feeding electrode.

By thus providing the processing electrodes 60 and the feeding electrodes 62 alternately in the Y direction of the electrode section 46 (direction perpendicular to the long direction of the processing electrodes 60 and the feeding electrodes 62), provision of a feeding section for feeding electricity to the conductive film (processing object) of the substrate W is no longer necessary, and processing of the entire surface of the substrate W becomes possible. Further, by changing the positive and negative of the voltage applied between the processing electrodes 60 and the feeding electrodes 62 in a pulse form (preferably square wave composed of a positive electrical potential and a zero electrical potential), it becomes possible to dissolve the electrolysis products, and improve the flatness of the processed surface through the multiplicity of repetition of processing.

With respect to the processing electrodes 60 and the feeding electrodes 62, oxidation or dissolution thereof due to an electrolytic reaction may be a problem. In view of this, as a material for the electrodes, it is possible to use, besides the conventional metals and metal compounds, carbon, relatively inactive noble metals, conductive oxides or conductive ceramics, preferably. A noble metal-based electrode may, for example, be one obtained by plating or coating platinum or iridium onto a titanium electrode, and then sintering the coated electrode at a high temperature to stabilize and strengthen the electrode. Ceramics products are generally obtained by heat-treating inorganic raw materials, and ceramics products having various properties are produced from various raw materials including oxides, carbides and nitrides of metals and nonmetals. Among them there are ceramics having an electric conductivity. When an electrode is oxidized, the value of the electric resistance generally increases to cause an increase of applied voltage. However, by protecting the surface of an electrode with a non-oxidative material such as platinum or with a conductive oxide such as an iridium oxide, the decrease of electric conductivity due to oxidation of the base material of an electrode can be prevented.

Each processing electrode 60 is movably but inescapably inserted into a recess 66a provided in a processing electrode support 66 mounted on an upper surface of the electrode base 64, and is biased upwardly by an elastic body 68 comprised of a helical compression spring. A contact member 70 comprised of, for example, an ion exchanger in the form of a sheet or film, is fixed with its end surface upward in the central portion in the width direction of the processing electrode 60. The processing electrode 60 and the contact member 70 are thus floatingly supported through the elastic body 68. When the end surface of the contact member 70 is brought into contact with the surface of the substrate W and pressed against the substrate W, as described in more detail below, the contact member 70, together with the processing electrode 60, lowers and the elastic body 68 contracts. By adjusting the degree of contraction of the elastic body 68, the contact pressure of the contact member 70 on the surface of the substrate W can be controlled more precisely.

The Young's modulus of the contact member 70 is not less than 100 MPa, preferably not less than 110 MPa. The use of the contact member 70 having a Young's modulus as high as not less than 100 MPa, because of the high rigidity, can reduce its deformation by a contact load. It has been confirmed experimentally that use of a contact member having a Young's modulus of less than 100 MPa in electrolytic processing cannot sufficiently attain elimination of surface level difference.

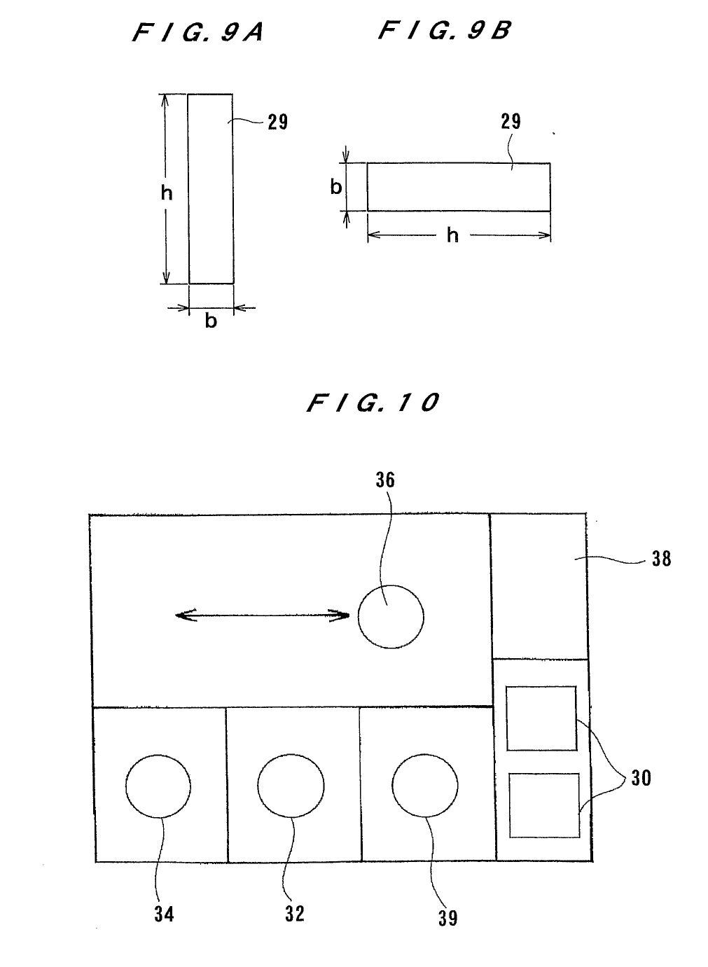

The contact member 70 has a rectangular cross-section and, as with the above-described case shown in FIG. 9A, is oriented vertically, with the short sides of the rectangle extending horizontally and the long sides extending vertically, in order to maximize the second moment of area. The degree of deformation of the contact member 70 by a contact load can be reduced also by orienting the contact member 70 in such a direction as to maximize the second moment of area. It is, of course, possible to use a contact member having any desired shape of cross-section that may provide a large second moment of area.

According to this embodiment, in carrying out processing while keeping the upper surface of the contact member 70 in contact with a processing object such as copper film 6 (see FIG. 1B) formed on the substrate W, as described in more detail below, the contact member 70 having a Young's modulus of not less than 100 MPa is used and the contact member 70 is floatingly supported through the elastic body 68, as described above, whereby the degree of deformation of the contact member 70 by a contact load applied from the processing object is made smaller than the initial level difference of surface irregularities of the processing object. This can maintain a difference in electric resistance between a recessed portion and a raised portion in the surface of the processing object, providing a processed surface with enhanced flatness.

Furthermore, by using the contact member 70 in the form of a thin sheet or film, and disposing the contact member 70 such that its one end surface faces the surface (processing object) of the substrate W so that only the end surface contacts the surface of the substrate W during electrolytic processing, the contact member 70 is allowed to make a linear contact with the surface of the substrate W with a narrow contact width. This can reduce wear or breakage of the contact member 70 due to its contact with the surface of the substrate W, enabling a long-term processing.

The contact member 70 is fixedly embedded in the processing electrode 60 such that its upper end slightly protrudes upwardly from the upper surface of the processing electrode 60. Accordingly, when the end surface of the contact member 70 is in contact with the surface of the substrate W, the upper surface of the processing electrode 60, facing the surface of the substrate W, is kept at a slight distance from the substrate W without contact.

Fluid flow passages 66b are provided on both sides of the processing electrode 60 in the interior of the processing electrode support 66. Further, fluid supply nozzles 66c, communicating with the fluid flow passage 66b, opening to the upper surface of the processing electrode support 66 and inclining toward the contact member 70, are provided at a given pitch along the long direction of the fluid flow passage 66b. A fluid, such as pure water, preferably ultrapure water, flows through the fluid flow passage 66b and is supplied from the fluid supply nozzles 66c to the upper surface of the processing electrode 60 and then to the exposed portion of the contact member 70.

On the other hand, holding plates 72 are disposed on both sides of each feeding electrode 62, and the feeding electrode 62 is sandwiched between the processing electrode supports 66 and fixed to the electrode base 64. Inside the feeding electrode 62 is provided a fluid flow passage 62a extending along the long direction of the feeding electrode 62. Further, inside the feeding electrode 62, fluid outlets 62b, communicating with the fluid flow passage 62a and opening upwardly, are provided at predetermined positions along the long direction of the fluid flow passage 62a. A fluid, such as pure water, preferably ultrapure water, flows through the fluid flow passage 62a and is supplied from the fluid outlets 62b to the upper surface of the feeding electrode 62.

A first ion exchanger 74 of a multi-layer structure having a large ion exchange capacity, for example, composed of anon-woven fabric, is mounted on the upper surface of the feeding electrode 62. The first ion exchanger 74 and the feeding electrode 62 are integrally covered with a second ion exchanger 76, for example, composed of an ion-exchange membrane. The top end of the second ion exchanger 76 is slightly lower than the top end of the contact member 70. Accordingly, the contact member 70 of the processing electrode 60 securely contacts the substrate W during processing of the substrate. Further, since the processing electrode 60 side is floatingly supported through the elastic body 68 according to this embodiment, the second ion exchanger 76 can securely contact the surface of the substrate W upon contact of the upper surface of the contact member 70 with the surface of the substrate W.

Next, electrolytic processing of a substrate using the substrate processing apparatus incorporating the electrolytic processing apparatus 34 of this embodiment will be described.

First, a cassette housing substrates W, for example, having a surface copper film 6 as a conductive film (processing object) as shown in FIG. 1B, is set in the loading/unloading section 30, and one substrate W is taken by the transport robot 36 out of the cassette. The transport robot 36 transports the substrate W to the reversing machine 32, if necessary, which reverses the substrate W so that the surface having the conductive film (copper film 6) faces downward.

The transport robot 36 receives the reversed substrate W, and transports it to the electrolytic processing apparatus 34 where the substrate W is attracted and held by the substrate holder 42. Thereafter, the arm 40 is moved to move the substrate holder 42 holding the substrate W to a processing position right above the electrode section 46. Next, the vertical-movement motor 50 is actuated to lower the substrate holder 42 to thereby bring the substrate W, held by the substrate holder 42, into contact with the upper surface of each contact member 70 of the electrode section 46. The substrate holder 42 is further lowered to thereby press the contact member 70 against the surface of the substrate W at a predetermined low load by the elastic body 68 floatingly supporting the contact member 70. At this point of time, also the top end of the second ion exchanger 76 covering the feeding electrode 62 securely contacts the surface of the substrate W. Though in this embodiment the processing electrode 60 is floated by the elastic body (spring) 60, it is also possible to employ an air chamber as a floating mechanism to press the processing electrode 60 against the substrate W at a desired pressure.

Next, the substrate-rotating motor 58 is actuated to rotate the substrate W together with the substrate holder 42, while the reciprocating motor 56 is actuated to reciprocate the substrate W, together with the substrate holder 42, in the Y direction shown in FIG. 11. While thus moving the substrate W, a fluid, such as pure water, preferably ultrapure water, is supplied from the fluid supply nozzles 66c and the fluid outlets 62b to between the substrate W and each processing electrode 60, and between the substrate W and each feeding electrode 62.

A given voltage is applied from the power source 48 to between the processing electrodes 60 and the feeding electrodes 62 to carry out electrolytic processing of the surface conductive film (copper 6) of the substrate W at the processing electrodes 60 by the action of hydrogen ions and hydroxide ions produced by the contact members 70 composed of an ion exchanger, the first ion exchanger 74 and the second ion exchanger 76. Though processing proceeds in those portions of the surface of the substrate W which face the processing electrodes 60, the relative movement between the substrate W and the processing electrodes 60 enables processing over the entire surface of the substrate W.

The degree of deformation of the contact member 70 by a contact load applied from the substrate W during processing is so controlled that it is smaller than the initial level difference of surface irregularities of the copper film 6. This can maintain a difference in electric resistance between a recessed portion and a raised portion in the surface of the copper film 6 and can thus produce a difference in processing rate between the recessed portion and the raised portion, providing a processed surface with enhanced flatness.

During electrolytic processing, the monitor section 38 monitors the voltage applied between the processing electrodes 60 and the feeding electrodes 62 or the electric current flowing therebetween to detect the end point (terminal of processing). It is noted in this connection that in electrolytic processing an electric current (applied voltage) varies, depending upon the material to be processed, even with the same voltage (electric current). For example, as shown in FIG. 13A, when an electric current is monitored in electrolytic processing of the surface of a substrate W to which a film of material B and a film of material A are laminated in this order, a constant electric current is observed during the processing of material A, but it changes upon the shift to the processing of the different material B. Likewise, when a voltage applied between the processing electrode and the feeding electrode is monitored, as shown in FIG. 13B, though a constant voltage is applied between the processing electrode and the feeding electrode during the processing of material A, the voltage applied changes upon the shift to the processing of the different material B. FIG. 13A illustrates, by way of example, a case in which an electric current is harder to flow in electrolytic processing of material B compared to electrolytic processing of material A, and FIG. 13B illustrates a case in which the applied voltage becomes higher in electrolytic processing of material B compared to electrolytic processing of material A. As will be appreciated from the above-described example, the monitoring of changes in electric current or in voltage can surely detect the end point.

Though this embodiment shows the case where the monitor section 38 monitors the voltage applied between the processing electrodes 60 and the feeding electrodes 62, or the electric current flowing there between to detect the end point of processing, it is also possible to allow the monitor section 38 to monitor a change in the state of the substrate being processed to detect an arbitrarily set end point of processing. In this case, “the end point of processing” refers to a point at which a desired processing amount is attained for a specified region in a surface to be processed, or a point at which an amount corresponding to a desired processing amount is attained in terms of a parameter correlated with a processing amount for a specified region in a surface to be processed. By thus arbitrarily setting and detecting the end point of processing even in the middle of processing, it becomes possible to conduct a multi-step electrolytic processing.

For example, the processing amount may be determined by detecting a change in frictional force due to a difference in friction coefficient produced when a different material is reached in a substrate, or a change in frictional force produced by removal of irregularities in the surface of the substrate. The end point of processing may be detected based on the processing amount thus determined. During electrolytic processing, heat is generated by the electric resistance of the processing surface of a substrate, or by collision between water molecules and ions moving in the liquid (pure water) between the processing surface of the substrate and the processing electrodes. In processing e.g. a copper film deposited on the surface of a substrate under a controlled constant voltage, when a barrier layer or an insulating film becomes exposed with the progress of electrolytic processing, the electric resistance increases and the current value decreases, and the heat value decreases. Accordingly, the processing amount may be determined by detecting the change in the heat value. The end point of processing may therefore be detected. Alternatively, the film thickness of a processing film on a substrate may be determined by detecting a change in the intensity of reflected light due to a difference in reflectance produced when a different material is reached in the substrate. The end point of processing may be detected based on the film thickness thus determined.

The film thickness of a processing film on a substrate may also be determined by generating an eddy current within a conductive film, for example, a copper film, and monitoring the eddy current flowing within the substrate to detect a change in e.g. the frequency or the impedance of a sensor monitoring the eddy current, thereby detecting the end point of processing. Further, in electrolytic processing, the processing rate depends on the value of the electric current flowing between the processing electrode and the feeding electrode, and the processing amount is proportional to the quantity of electricity, determined by the product of the current value and the processing time. Accordingly, the processing amount may be determined by integrating the quantity of electricity, and detecting the integrated value reaching a predetermined value. The end point of processing may thus be detected.

After completion of the electrolytic processing, the power source 48 is disconnected with the processing electrodes 60 and the feeding electrodes 62, and the rotation and the parallel movement of the substrate holder 42 are stopped. Thereafter, the substrate holder 42 is raised, and the substrate W is transferred to the transport robot 36 after moving the arm 40. The transport robot 36 takes the substrate W from the substrate holder 42 and, if necessary, transfers the substrate W to the reversing machine 32 for reversing it, and then transfers the substrate W to the cleaning section 39 for cleaning and drying it. The dried substrate W is then returned to the cassette in the loading/unloading section 30.

Pure water, which is supplied between the substrate W and the processing electrodes 60, etc., during electrolytic processing, herein refers to a water having an electric conductivity (referring herein to that at 25° C., 1 atm) of not more than 10 μS/cm. Ultrapure water refers to a water having an electric conductivity of not more than 0.1 μS/cm. The use of pure water or ultrapure water containing no electrolyte upon electrolytic processing can prevent extra impurities such as an electrolyte from adhering to and remaining on the surface of the substrate W. Further, copper ions or the like dissolved during electrolytic processing are immediately caught by the ion exchangers through the ion-exchange reaction. This can prevent the dissolved copper ions or the like from re-precipitating on the other portions of the substrate W, or from being oxidized to become fine particles which contaminate the surface of the substrate W.

It is possible to use, instead of pure water or ultrapure water, a liquid having an electric conductivity of not more than 500 μS/cm or an electrolytic solution obtained by adding an electrolyte to pure water or ultrapure water. The use of an electrolytic solution can further lower the electric resistance and reduce the power consumption. A solution of a neutral salt such as NaCl or Na₂SO₄, a solution of an acid such as HCl or H₂SO₄, or a solution of an alkali such as ammonia, may be used as the electrolytic solution, and these solutions may be selectively used according to the properties of the workpiece.

Further, it is also possible to use, instead of pure water or ultrapure water, a liquid obtained by adding a surfactant to pure water or ultrapure water, and having an electric conductivity of not more than 500 μS/cm, preferably not more than 50 μS/cm, more preferably not more than 0.1 μS/cm (resistivity of not less than 10 MΩ·cm). Due to the presence of a surfactant, the liquid can form a layer, which functions to inhibit ion migration evenly, at the interface between the substrate W and the ion exchangers, thereby moderating concentration of ion exchange (metal dissolution) to enhance the flatness of the processed surface. The surfactant concentration is desirably not more than 100 ppm.

The ion exchanger as the contact member 70 as well as the first ion exchanger 72 and the second ion exchanger 76 mounted to the feeding electrodes 62 should preferably have good water permeability. By allowing pure water or ultrapure water to pass through the ion exchangers, it becomes possible to supply a sufficient amount of water to functional groups (e.g. sulfonic acid groups in a strongly acidic cation exchanger) which promote the dissociation reaction of water, thereby increasing the amount of dissociated products. Furthermore, processing products (including gas) produced by a reaction between the processing object and hydroxide ions (or OH radicals) can be removed by the flow of water, thereby increasing the processing efficiency.

The above-described ion exchanger may be composed of a non-woven fabric that has an anion-exchange group or a cation-exchange group. A cation exchanger preferably carries a strongly acidic cation-exchange group (sulfonic acid group); however, a cation exchanger carrying a weakly acidic cation-exchange group (carboxyl group) may also be used. Though an anion exchanger preferably carries a strongly basic anion-exchange group (quaternary ammonium group), an anion exchanger carrying a weakly basic anion-exchange group (tertiary or lower amino group) may also be used.

The non-woven fabric carrying a strongly basic anion-exchange group can be prepared by, for example, the following method: A polyolefin non-woven fabric having a fiber diameter of 20-50 μm and a porosity of about 90% is subjected to the so-called radiation graft polymerization, comprising γ-ray irradiation onto the non-woven fabric and the subsequent graft polymerization, thereby introducing graft chains; and the graft chains thus introduced are then aminated to introduce quaternary ammonium groups thereinto. The capacity of the ion-exchange groups introduced can be determined by the amount of the graft chains introduced. The graft polymerization may be conducted by the use of a monomer such as acrylic acid, styrene, glicidyl methacrylate, sodium styrenesulfonate or chloromethylstyrene, or the like. The amount of the graft chains can be controlled by adjusting the monomer concentration, the reaction temperature and the reaction time Thus, the degree of grafting, i.e. the ratio of the weight of the non-woven fabric after graft polymerization to the weight of the non-woven fabric before graft polymerization, can be made 500% at its maximum. Consequently, the capacity of the ion-exchange groups introduced after graft polymerization can be made 5 meq/g at its maximum.

The non-woven fabric carrying a strongly acidic cation-exchange group can be prepared by the following method: As in the case of the non-woven fabric carrying a strongly basic anion-exchange group, a polyolefin non-woven fabric having a fiber diameter of 20-50 μm and a porosity of about 90% is subjected to the so-called radiation graft polymerization comprising γ-ray irradiation onto the non-woven fabric and the subsequent graft polymerization, thereby introducing graft chains; and the graft chains thus introduced are then treated with a heated sulfuric acid to introduce sulfonic acid groups thereinto. If the graft chains are treated with a heated phosphoric acid, phosphate groups can be introduced. The degree of grafting can reach 500% at its maximum, and the capacity of the ion-exchange groups thus introduced after graft polymerization can reach 5 meq/g at its maximum.

The base material of the ion exchanger may be a polyolefin such as polyethylene or polypropylene, or any other organic polymer. Further, besides the form of a non-woven fabric, the ion exchanger may be in the form of a woven fabric, a sheet, a porous material, or short fibers, etc. When polyethylene or polypropylene is used as the base material, graft polymerization can be effected by first irradiating radioactive rays (γ-rays and electron beam) onto the base material (pre-irradiation) to thereby generate a radical, and then reacting the radical with a monomer, whereby uniform graft chains with few impurities can be obtained. When an organic polymer other than polyolefin is used as the base material, on the other hand, radical polymerization can be effected by impregnating the base material with a monomer and irradiating radioactive rays (γ-rays, electron beam and UV-rays) onto the base material (simultaneous irradiation). Though this method fails to provide uniform graft chains, it is applicable to a wide variety of base materials.

By using a non-woven fabric having an anion-exchange group or a cation-exchange group as the ion exchanger, it becomes possible that pure water or ultrapure water, or a liquid such as an electrolytic solution can freely move within the non-woven fabric and easily arrive at the active points in the non-woven fabric having a catalytic activity for water dissociation, so that many water molecules are dissociated into hydrogen ions and hydroxide ions. Further, by the movement of pure water or ultrapure water, or a liquid such as an electrolytic solution, the hydroxide ions produced by the water dissociation can be efficiently carried to the surfaces of the processing electrodes 60, whereby a high electric current can be obtained even with a low voltage applied.

When the ion exchanger have only one of anion-exchange groups and cation-exchange groups, a limitation is imposed on electrolytically processible materials and, in addition, impurities are likely to form due to the polarity. In order to solve this problem, an anion exchanger carrying an anion-exchange group and a cation exchanger carrying a cation-exchange group may be superimposed, or the ion exchanger may carry both of an anion-exchange group and a cation-exchange group per se, whereby a range of materials to be processed can be broadened and the formation of impurities can be restrained.

According to the electrolytic processing apparatus 34 of the present invention, since a mechanical polishing action is not involved, a strong pressing by the substrate W as in CMP is not necessary. In the case where a fragile material is used as the interconnect material of the substrate W, it is preferred to adjust the pressure applied to the substrate W from the contact member 70 becomes not more than 19.6 kPa (200 gf/cm², 2.9 psi), more preferably not more than 6.86 kPa (70 gf/cm², 1.0 psi), most preferably not more than 686 Pa (7 gf/cm², 0.1 psi), and carry out processing of the substrate W under such a low load.

The present invention is applicable to various types of electrolytic processing apparatuses that may employ various combinations of processing liquids and contact members, and is not limited to electrolytic processing using an ion exchanger.

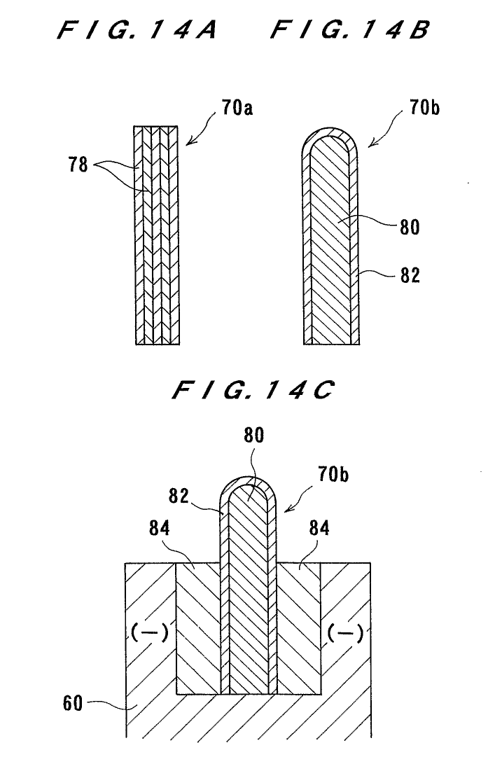

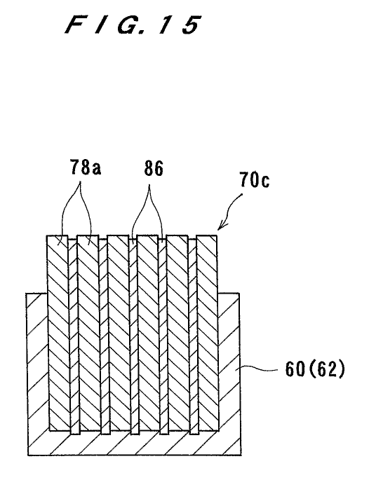

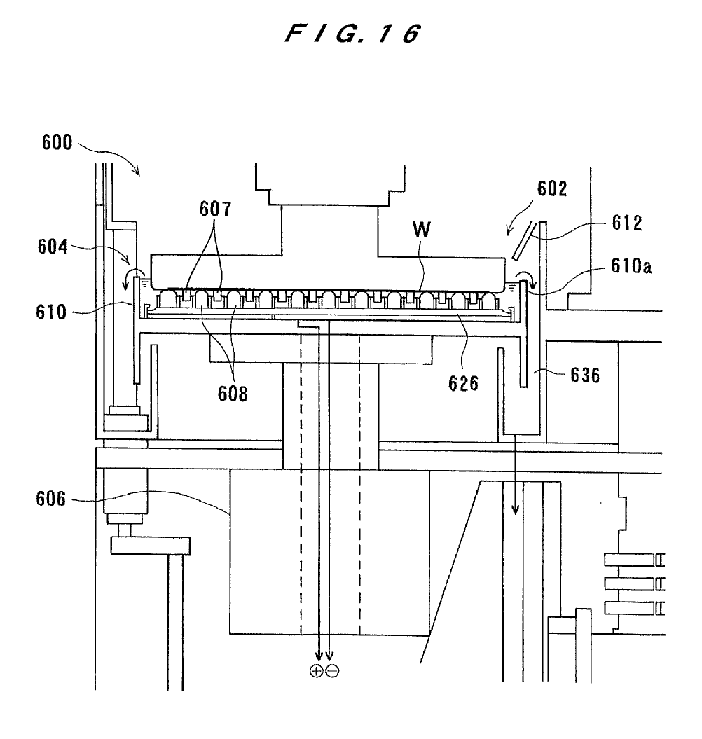

Though in the above-described embodiment the contact member 70 is comprised of a single material, it is also possible to use a contact member 70a comprising a laminate of a plurality of base materials 78 each composed of an ion exchanger (ion-exchange membrane), as shown in FIG. 14A, and having a young's modulus of not less than 100 MPa. It is also possible to use a contact member comprised of an insulating or conductive polishing pad or cloth, or a combination thereof.

Alternatively, as shown in FIG. 14B, it is possible to use a contact member 70b comprising a support 80, composed of an insulating material, covered with a cover material 82, for example composed of anion exchanger (ion-exchange membrane), for contact with a workpiece. The use of an insulating material for the support. 80 is to effect ion exchange by allowing ions to move along the surface of the contact member 70b. The use, as the support 80, of one having a high rigidity such as of a Young's modulus of not less than 100 MPa, can reduce the degree of deformation of the contact member 70b by a contact load, and enables the cover material 82, covering the support 80, to function as a contact member for contact with a workpiece. The cover material 82 may also be comprised of a polishing pad or cloth.

In mounting the contact member 70b shown in FIG. 14B to, for example, the processing electrode 60, it is possible to interpose an ion exchanger 84, for example composed of a non-woven fabric, having a large ion-exchange capacity between the processing electrode 60 and the cover material (ion exchanger) 82 of the contact member 70b, as shown in FIG. 14C. In case the ion-exchange capacity of the cover material 82 is insufficient, the use of the ion exchanger 84 can increase the total ion-exchange capacity. The same construction, of course, can be employed also on the feeding electrode side.

Alternatively, as shown in FIG. 15, it is possible to use a contact member 70c comprising a laminate of alternating layers of flat plate-shaped ion exchangers 78a and flat plate-shaped insulating materials 86 of, for example, a resin such as PVC or PPS, and having a Young's modulus of not less than 100 MPa, and to mount the contact member 70c in the processing electrode 60 (or feeding electrode 62) with the side end surfaces of the layers exposed. Such contact member 70c can have a sufficient rigidity for use as a contact member and an adequate ion-exchange capacity. In this case, instead of the insulating material 86, a polishing pad may also be used.

FIG. 16 is a vertical sectional view showing the main portion of an electrolytic processing apparatus according to another embodiment of the present invention. As shown in FIG. 16, the electrolytic processing apparatus 600 includes a substrate holder 602 for attracting and holding a substrate W with its front surface facing downwardly (face down), and a rectangular electrode section 604 disposed below the substrate holder 602. As with the substrate holder 42 of the preceding embodiment, the substrate holder 602 is rotatable and is movable vertically and horizontally. The electrode section 604 is provided with a hollow scroll motor 606 and, by the actuation of the hollow scroll motor 606, makes a circular movement without rotation about its own axis, a so-called scroll movement (translational rotation). It is, however, also possible to rotate the electrode section 604 about its own axis.

The electrode section 604 includes an electrode base 626 on which, as in the preceding embodiment, processing electrodes 607, each provided with a contact member (not shown), and feeding electrodes 608, both extending linearly, are arranged alternately, and an upwardly-open vessel 610 also serving as a support base. Above the vessel 610 is disposed a liquid supply nozzle 612 for supplying a liquid, such as ultrapure water or pure water, into the vessel 610. The processing electrodes 607 are connected to the cathode of a power source provided in the apparatus, and the feeding electrodes 608 are connected to the anode. An overflow passage 636 for discharging the liquid overflowing the peripheral wall 610a of the vessel 610 is provided around the vessel 610. The liquid overflowing the peripheral wall 610a passes through the overflow passage 636 and enters a waste tank (not shown).

According to this embodiment, processing of the substrate W is carried out by continually supplying a liquid, such as pure water, preferably ultrapure water, from the liquid supply nozzle 612 into the vessel 610 and allowing the liquid to overflow the peripheral wall 610a while keeping the substrate W, held by the substrate holder 602, immersed in the liquid in the vessel 610 and keeping the contact members, mounted to the processing electrodes 607, and the feeding electrodes 608 in contact with the surface of the substrate W, and allowing the electrode section 604 to make a scroll movement and, at the same time, rotating the substrate holder 602 together with the substrate W.

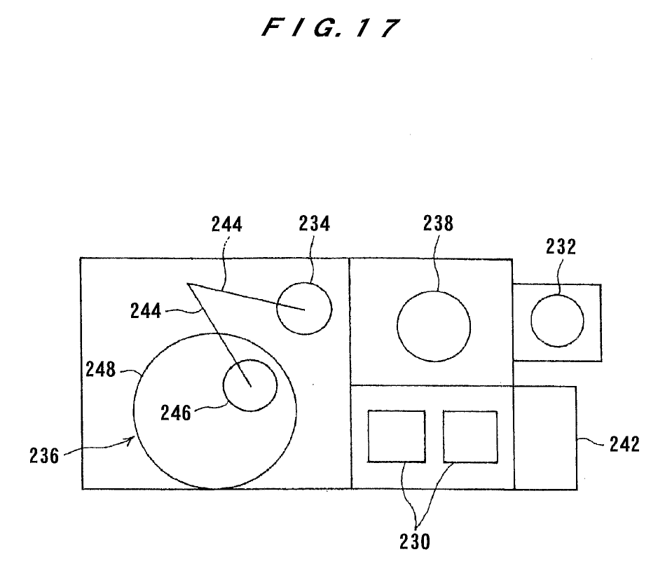

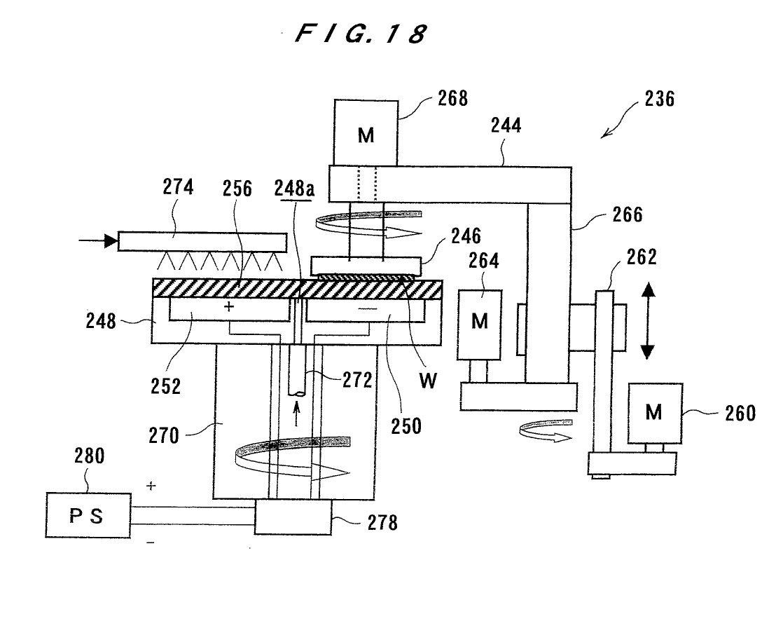

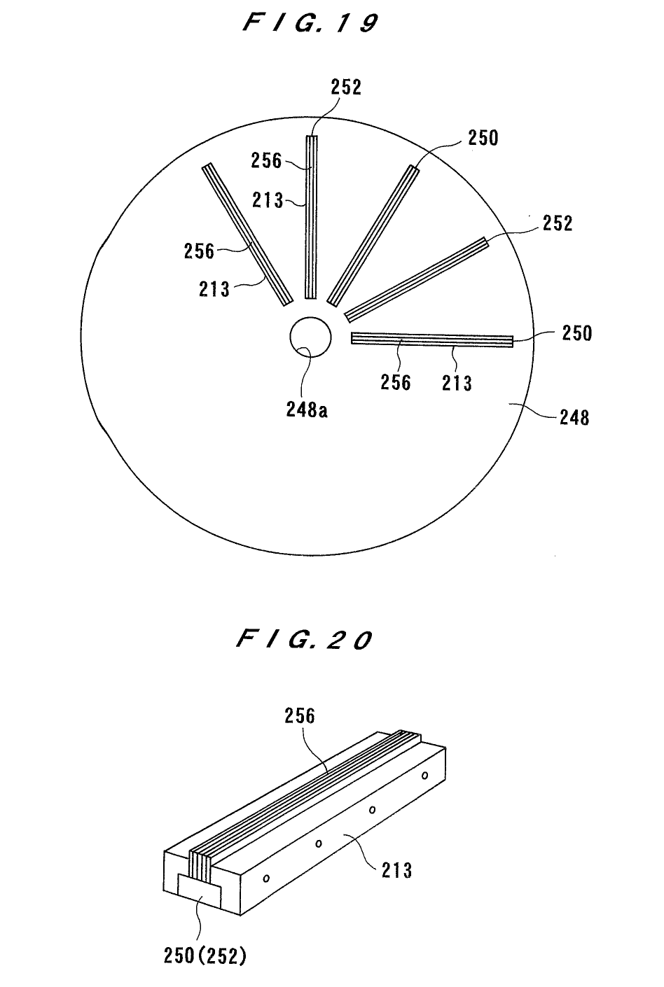

FIG. 17 shows a layout plan view of a substrate processing apparatus incorporating an electrolytic processing apparatus according to yet another embodiment of the present invention. As shown in FIG. 17, the substrate processing apparatus includes a pair of loading/unloading sections 230 as a carry-in-and-out section for carrying in and out a cassette housing substrate W, for example having a surface copper film 6 as a conductive film (processing object) as shown in FIG. 1B, a reversing machine 232 for reversing the substrate W, a pusher 234 for delivery and receipt of the substrate W, and an electrolytic processing apparatus 236. The electrolytic processing apparatus 236 includes a substrate holder 246 for holding the substrate W, and an electrode section 248 having processing electrodes 250 and feeding electrodes 252 (see FIGS. 18 and 19). At a position surrounded by the loading/unloading sections 230, the reversing machine 232 and the pusher 234 is disposed a fixed transport robot 238 as a transport device for transporting and delivering the substrate W therebetween. The substrate processing apparatus also includes a monitor section 242 for monitoring a voltage applied between the processing electrodes 250 and the feeding electrodes 252 or an electric current flowing therebetween during electrolytic processing in the electrolytic processing apparatus 236.

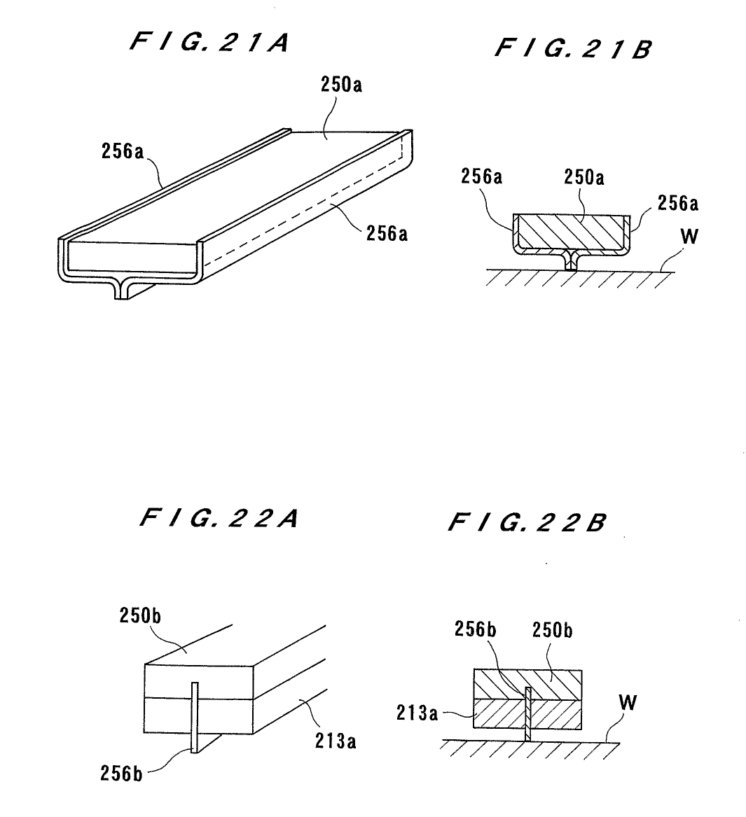

FIG. 18 shows a schematic sectional view of the electrolytic processing apparatus 236 shown in FIG. 17, and FIG. 19 shows an enlarged plan view of the electrode section 248 of the electrolytic processing apparatus 236. FIG. 20 shows a perspective view of an electrode provided in the electrode section 248.

As shown in FIG. 18, the electrolytic processing apparatus 236 includes the substrate holder 246, mounted to and suspended from the free end of a horizontally pivotable pivot arm 244, for attracting and holding the substrate W with its surface facing downwardly (face down), and the disc-shaped electrode section 248 of insulating material, disposed below the substrate holder 246. As shown in FIG. 19, the radially-extending processing electrodes 250 and feeding electrodes 252 are arranged alternately in the surface (upper surface) of the electrode section 248. According to this embodiment, a plurality of rectangular contact members 256 (five members are shown in FIG. 20) are mounted to the substrate holder 246 side surface (upper surface) of each processing electrode 250 and of each feeding electrode 252 such that one end surface of each contact member 256 is in contact with the electrode surface while the opposite end surface faces the surface (lower surface) of the substrate W held by the substrate holder 246. In particular, as shown in FIG. 20, the contact members 256 are sandwiched between support members 213 of PVC and fixed by bolts to each processing electrode 250 or feeding electrode 252.

By using the contact member 256 in the form of a thin sheet or film, and disposing the contact member 256 such that its one end surface faces the substrate W so that only the end surface contacts the surface (processing object) of the substrate W during processing, the contact member 256 is allowed to make a linear contact with the surface of the substrate W with a narrow contact width. This can reduce wear or breakage of the contact member 256 due to its contact with the substrate W, enabling a long-term processing. Further, by fixing a laminate of a plurality of such contact members 256 to the processing electrode 250, uniform electrolytic processing can be carried out easily in a wider processing area.

It is also possible to wrap a processing electrode 250a in two contact members 256a each in the form of a sheet or film, with the seam protruding from the processing electrode 250a, as shown in FIG. 21A, and bring the end surfaces at the seam, facing the surface (processing object) of the substrate W, into contact with the substrate W during processing, as shown in FIG. 21B. It is also possible to embed one end portion of a contact member 256b in the form of a sheet or film in a processing electrode 250b, with the opposite end portion protruding vertically from the processing electrode 250b, and fix the contact member 256b by a support member 213a, as shown in FIG. 22A, and bring the end surface, facing the surface (processing object) of the substrate W, of the protruding portion of the contact member 256b into contact with the substrate W during processing, as shown in FIG. 22B.

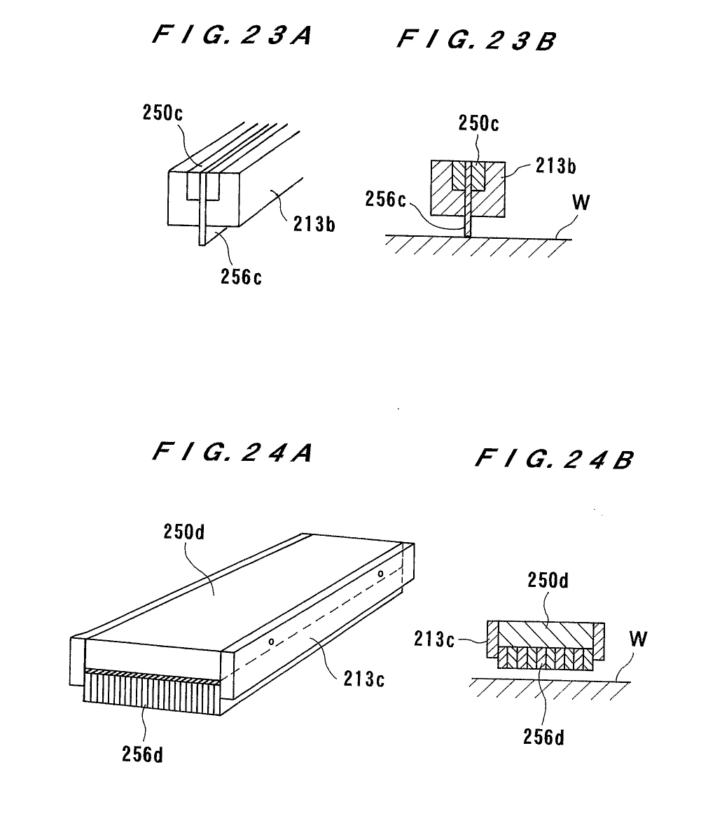

Alternatively, it is possible to sandwich a contact member 256c in the form a sheet or film between a pair of processing electrodes 250c, and sandwich and fix the assembly in a support member 213b, with one end portion of the contact member protruding vertically from the support member 213b, as shown in FIG. 23A, and bring the end surface, facing the surface (processing object) of the substrate W, into contact with the substrate W during processing, as shown in FIG. 23B.

Alternatively, it is also possible to mount a large number of rectangular contact members 256d, closely arranged in parallel over the full width of a processing electrode 250d, to the processing electrode 250d by a support member 213c, as shown in FIG. 24A, and bring the end surfaces, facing the surface (processing object) of the substrate W, of the contact members 256d into contact with the substrate W during processing, as shown in FIG. 24B. The provision of such a large number of contact members 256d enables uniform processing in a wider area.

Though various contact members in combination with processing electrodes have been described, the same holds for feeding electrodes.

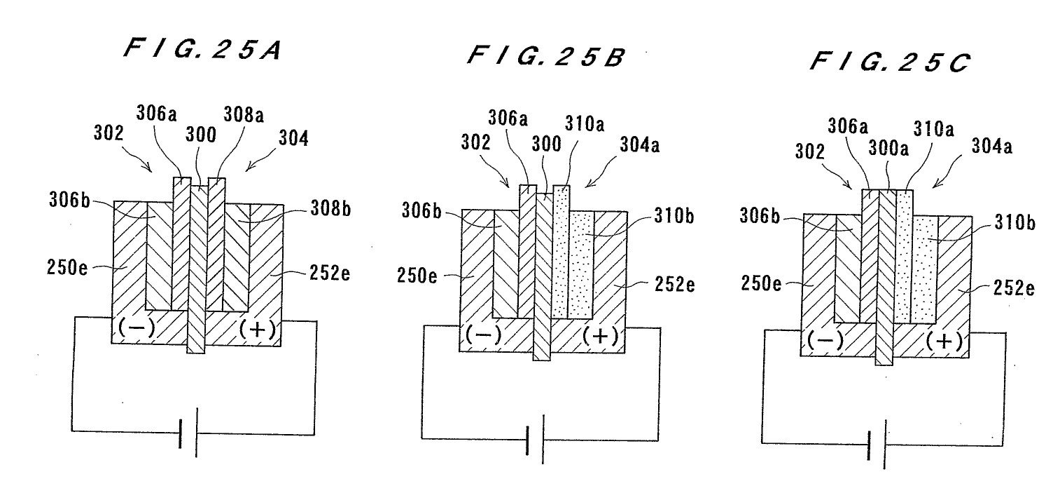

In this embodiment each processing electrode 250 and each feeding electrode 252, both provided with the contact members 256, are constructed and disposed separately. It is also possible to construct a processing electrode 250e and a feeding electrode 252e integrally, with an insulator 300 composed of a resin, such as PVC or PPS, interposed therebetween for electrical isolation, and interpose a first contact member 302 between the processing electrode 250e and the insulator 300, and a second contact member 304 between the feeding electrode 252e and the insulator 300, as shown in FIG. 25A. Such an integral construction of processing electrode 250e and feeding electrode 252e with the insulator interposed therebetween can reduce the size of the apparatus, and can dispose processing electrodes more densely, thereby increasing the processing rate.

FIG. 25A illustrates the case of using a laminate of two ion exchangers 306a, 306b as the first contact member 302 and a laminate of two ion exchangers 308a, 308b as the second contact member 304, and making end portions of the ion exchangers 306a, 308a on the insulator 300 sides protrude from the insulator 300 so that only the end surfaces of the ion exchangers 306a, 308b contact the surface (processing object) of a substrate.

As shown in FIG. 25B, it is also possible to interpose a second contact member 304a, comprising a laminate of two conductors 310a, 310b, between the feeding electrode 252e and the insulating material 300, with one end portion of the conductor 310a on the insulator 300 side protruding from the insulator 300. Alternatively, as shown in FIG. 25C, it is possible to use for the insulator 300a a polishing cloth material not permeable to water, for example, IC 1000 (manufactured by Lodel Inc.), and make one end surface of the insulator 300a flush with the end surface of the ion exchanger 306a of the first contact member 302 and with the end surface of the conductor 310a of the second contact member 304a so that the end surfaces of the ion exchanger 306a, the conductor 310a and the insulator 300a contact the surface (processing object) of a substrate. This can increase the insulating effect of the insulator 300a.

According to this embodiment, the electrode section 248 having the processing electrodes 250 and the feeding electrode 252 has a diameter at least twice the diameter of the substrate W held by the substrate holder 246 so as to electrolytically process the entire surface of the substrate W.

Further, the contact member 256 is comprised of an ion exchanger in the form a sheet or film, having an anion-exchange group or a cation-exchange group, for example. By using an ion exchanger having an anion-exchange group or a cation-exchange group as the contact member 256, a high electric current can be obtained with a low applied voltage even for a liquid having a high electric resistance, such as pure water (ultrapure water) or a low-concentration electrolyte solution, enabling successful processing with the use of such a liquid as an electrolytic liquid.

As shown in FIG. 18, the pivot arm 244 is coupled to the upper end of a pivot shaft 266 that moves vertically via a ball screw 262 by the actuation of a vertical-movement motor 260 and pivots by the actuation of a pivoting motor 264. The substrate holder 264 is connected to a substrate-rotating motor 268 mounted to the free end of the pivot arm 244 and rotates (about its own axis) by the actuation of the substrate-rotating motor 268.

The electrode section 248 is directly connected to a hollow motor 270 and rotates (about its own axis) by the actuation of the hollow motor 270. A through-hole 248a as a pure water supply section for supplying pure water, preferably ultrapure water, is provided at the center of the electrode section 248. The through-hole 248a is connected to a pure water supply pipe 272 extending in the hollow portion of the hollow motor 270. Pure water (ultrapure water) is passed through the through-hole 248a and supplied to the entire processing surface. It is also possible to provide a plurality of through-holes 248a connected to the pure water supply pipe 272 so as to facilitate spreading of processing liquid over the entire processing surface.

Above the electrode section 248 is disposed a pure water nozzle 274, extending in a radial direction of the electrode section 248, as a pure water supply section for supplying pure water (ultrapure water) onto the upper surface of the electrode section 248. Pure water (ultrapure water) can thus be supplied to the surface of the substrate W from above and below simultaneously. According to this embodiment, as shown in FIG. 18, the processing electrodes 250 are connected to the cathode of a power source 280 and the feeding electrodes 252 are connected to the anode of the power source 280, via a slip ring 278.

A description will now be given of electrolytic processing of a substrate carried out by the substrate processing apparatus.

First, one substrate W is taken by the transport robot 238 out of a cassette set in the loading/unloading section 230 and housing substrates W, for example having a surface copper film 6 as a conductive film (processing object) as shown in FIG. 1B. The substrate W is transported to the reversing machine 232, if necessary, which reverses the substrate W so that the surface having the conductive film (copper film 6) faces downwardly. Next, the substrate W with its surface facing downwardly is transported by the transport robot 238 to the pusher 234 and placed on it.

The substrate W on the pusher 234 is attracted and held by the substrate holder 246 of the electrolytic processing apparatus 236, and the pivot arm 244 is pivoted to move the substrate holder 246 to a processing position right above the electrode section 248. Next, the vertical-movement motor 260 is actuated to lower the substrate holder 246 to thereby bring the substrate W, held by the substrate holder 246, into contact with the surfaces of the contact members (ion exchanger) 256 mounted to the upper surface of the electrode section 248.

A given voltage is applied from the power source 280 to between the processing electrodes 250 and the feeding electrodes 252, and the substrate holder 246 and the electrode section 248 are rotated, while pure water (ultrapure water) is supplied through the through-hole 248a, thus from below the electrode section 248, to the upper surface of the electrode section 248 and pure water (ultrapure water) is also supplied from the pure water nozzle 274, thus from above the electrode section 248, to the upper surface of the electrode section 248 simultaneously so as to fill the space between the processing electrodes 250, feeding electrodes 252 and the substrate W with pure water (ultrapure water), there by carrying out electrolytic processing.

During the processing, as with the above-described embodiment, the voltage applied between the processing electrodes 250 and the feeding electrodes 252, or an electric current flowing therebetween is monitored with the monitor section 242 to detect the end point of processing.

After the completion of electrolytic processing, the power source 280 is disconnected, and the rotations of the substrate holder 246 and the electrode section 248 are stopped. Thereafter, the substrate holder 246 is raised, and the pivot arm 244 is pivoted to transfer the substrate W to the pusher 234. The transport robot 238 receives the substrate W from the pusher 234 and, if necessary, transfers the substrate W to the reversing machine 232 where the substrate W is reversed, and the substrate W is returned to the cassette of the loading/unloading section 230.

Though in this embodiment pure water, preferably ultrapure water is supplied between the electrode section 248 and the substrate W, it is also possible to supply other liquid, such as an electrolyte solution.

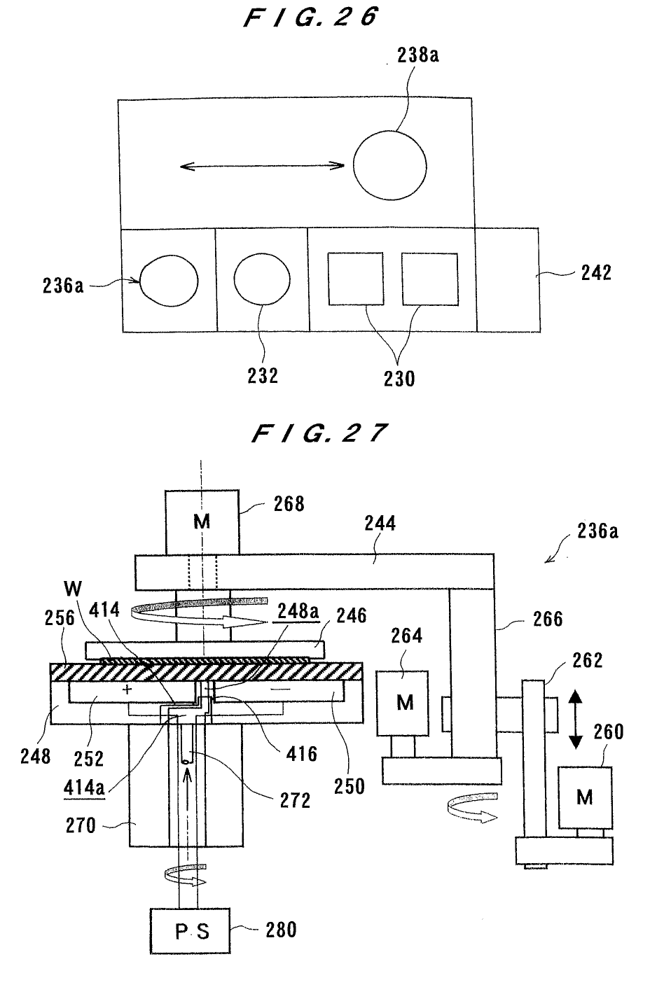

FIG. 26 is a planview showing the construction of a substrate processing apparatus incorporating an electrolytic processing apparatus according to yet another embodiment of the present invention, and FIG. 27 is a schematic vertical sectional view of the electrolytic processing apparatus shown in FIG. 26. The same or equivalent members as or to those shown in FIGS. 17 through 20 are given the same reference numerals, and a duplicate description thereof is omitted.

As shown in FIG. 26, the substrate processing apparatus comprises a pair of loading/unloading sections 230 as a carry-in and carry-out section for carrying in and carrying out a cassette housing a substrate, a reversing machine 232 for reversing the substrate W, and an electrolytic processing apparatus 236a. These devices are disposed in series. A transport robot 238a as a transport device, which can move parallel to these devices for transporting and transferring the substrate W therebetween, is provided. The substrate processing apparatus is also provided with a monitor section 242 for monitoring a voltage applied between the processing electrodes 250 and the feeding electrodes 252 during electrolytic processing in the electrolytic processing apparatus 236a, or an electric current flowing therebetween.

The electrolytic processing apparatus 236a includes the electrode section 248 which has the processing electrodes 250 and the feeding electrode 252, and has a diameter slightly larger than the diameter of the substrate W held by the substrate holder 246, as shown in FIG. 27. The electrode section 248 makes a revolutionary movement with the distance between the center of the rotation and the center of the electrode section 248 as radius, without rotation about its own axis, i.e. the so-called scroll movement (translational rotation movement) by the actuation of the hollow motor 270.

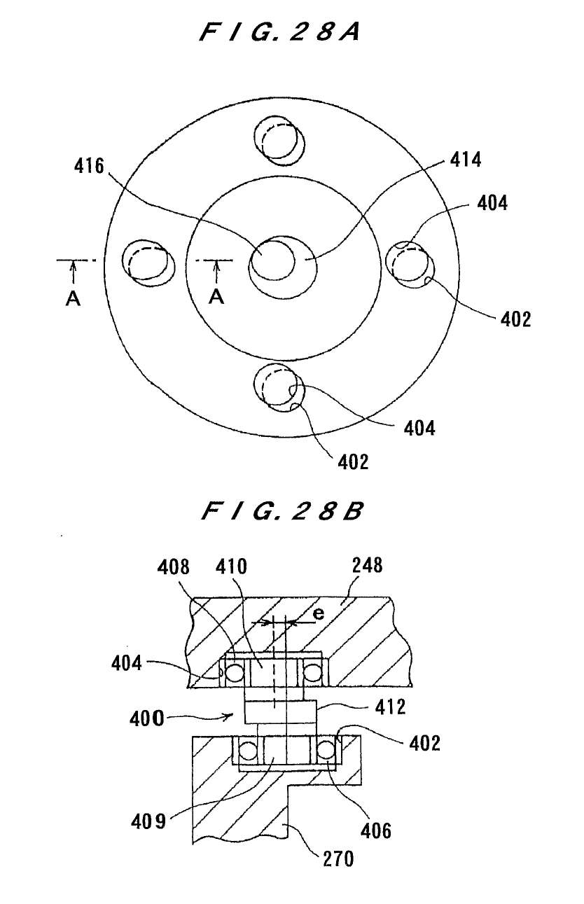

Specifically, as shown in FIGS. 28A and 28B, three or more (four in FIG. 28A) of rotation-prevention mechanisms 400 are provided in the circumferential direction between the electrode section 248 and the hollow motor 270. A plurality of depressions 402, 404 are formed at equal intervals in the circumferential direction at the corresponding positions in the upper surface of the hollow motor 270 and in the lower surface of the electrode section 248. Bearings 406, 408 are fixed in each depression 402, 404, respectively. A connecting member 412, which has two shafts 409, 410 that are eccentric to each other by eccentricity “e”, is coupled to each pair of the bearings 409, 410 by inserting the respective ends of the shafts 409, 410 into the bearings 406, 408. Further, a drive end 416, formed at the upper end portion of the main shaft 414 of the hollow motor 270 and arranged eccentrically position to the center of the main shaft, is rotatably connected, via a bearing (not shown), to a lower central portion of the electrode section 248. The eccentricity is also “e”. Accordingly, the electrode section 248 is allowed to make a translational movement along a circle with radius “e”.

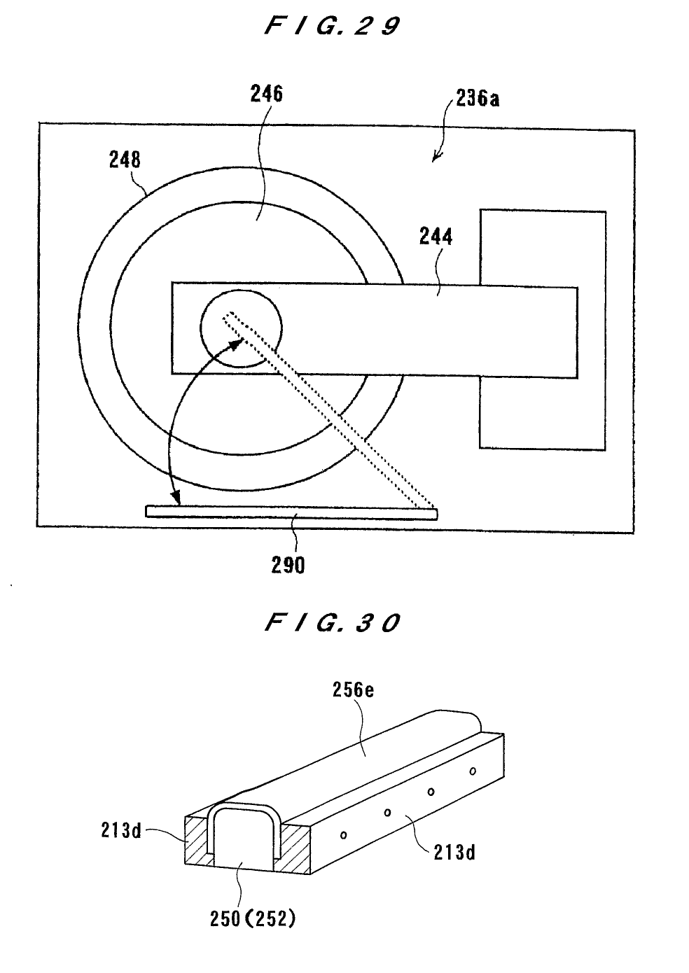

According to this embodiment, it is not possible to supply pure water or ultrapure water to the upper surface of the electrode section 248 from above the electrode section 248 during electrolytic processing. Thus, pure water or ultrapure water is supplied to the upper surface of the electrode section 248 only through a through-hole 414a formed in the main shaft 414 and the through-hole 248a formed in the electrode section 248. Further, since the electrode section 248 does not rotate about its own axis, the slip ring 278 is omitted. Furthermore, as shown in FIG. 29, a ultrapure water-spray nozzle 290 is retreatably provided beside the electrode section 248, which supplies ultrapure water to the contact members (ion exchanger) 256 for cleaning the electrode section 248 after the electrolytic processing. The other construction is the same as the embodiment shown in FIGS. 17 through 20.

According to the electrolytic processing apparatus 256a, electrolytic processing of the surface of the substrate W is carried out by supplying pure water (ultrapure water) to the upper surface of the electrode section 248 and applying a given voltage between the processing electrodes 250 and the feeding electrodes 252 while keeping the substrate W in contact with or close to the contact members (ion exchanger) 256, and rotating the substrate W together with the substrate holder 246 and, at the same time, allowing the electrode section 248 to make a scroll movement by the actuation of the hollow motor 270.

The flow of processing of the substrate W in the substrate processing apparatus is the same as the above-described embodiment shown in FIG. 17, except for directly transferring the substrate W between the transport robot 238a and the electrolytic processing apparatus 236a (not via a pusher), and hence a description thereof is omitted.

### EXAMPLE 1

Electrolytic processing was carried out using the electrolytic processing apparatus shown in FIGS. 18 through 20. The electrode section 248 used had twelve each processing electrodes 250 and feeding electrodes 252 arranged alternately. Further, a laminate of five rectangular cation-exchange membranes, the membrane being Nafion 117 manufactured by DuPont, was used as the contact member (ion exchanger) 256. The width of the end surface of contact member (ion exchanger) 256 comprising the laminate of five Nafion 117 membranes was about 1 mm.

A 200-mm copper-plated silicon substrate was used as a workpiece. While rotating the electrode section 248 at 30 rpm and rotating the substrate holder 246 holding the silicon substrate at 10 rpm, ultrapure water was supplied from the through-hole 248a of the electrode section 248 at a rate of 700 ml/min. A test cycle of one-minute electrolytic processing at a current density of 500 mA/cm² was repeated. Processing marks on the substrate surface and wear of the contact member (ion exchanger) 256 were observed visually.

As a result of the visual observation, partial wear of the twelve pair of contact members (ion exchanger) 256, especially wear in the edge portions, was observed already at the first processing, while no abnormal processing mark was observed on the substrate. Appreciable abnormal marks were observed after the 46th the processing, and considerable wear was observed in five of the twelve pair of contact members. The same test series was carried out three times (test Nos. 1-3). The results are shown in Table 1. As can be seen from Table 1, it took almost 40 test cycles to reach abnormal processing.

### COMPARATIVE EXAMPLE 1

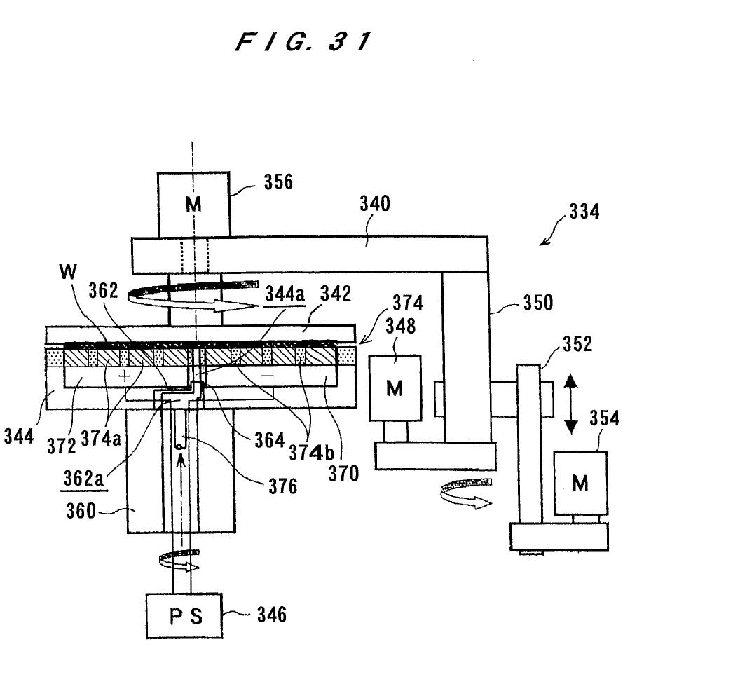

Electrolytic processing was carried out in the same manner as in Example 1, using the electrolytic processing apparatus shown in FIGS. 18 through 20. The electrode section 248 used had twelve each processing electrodes 250 and feeding electrodes 252 arranged alternately. A strip of cation-exchange membrane, Nafion 117 manufactured by DuPont, was used as a contact member (ion exchanger) 256e and, as shown in FIG. 30, the contact member 256e was fixed to each electrode by a support member 213d such that the contact member 256e covers the electrode. The width of the workpiece-facing surface of the contact member 256e was about 8 mm.

As in Example 1, while rotating the electrode section 248 at 30 rpm and rotating the substrate holder 246 holding the silicon substrate at 10 rpm, ultrapure water was supplied from the through-hole 248a of the electrode section 248 at a rate of 700 ml/min. A test cycle of one-minute electrolytic processing at a current density of 500 mA/cm² was repeated. Processing marks on the substrate surface and wear of the contact member (ion exchanger) 256e were observed visually. Wear of the contact member (ion exchanger) 256e proceeded much faster as compared to Example 1. Some membranes (contact members) tore before 10th processing, so that it was impossible to continue processing. The results are shown in Table 1.

As demonstrated by the results of Table 1, the life of the contact member (ion exchanger) of Example 1 is significantly longer, thus requiring fewer changes of contact member, as compared to the contact member of Comp. Example 1.

TABLE 1

| | Example 1 | | Comp. Example 1 | |
|---|---|---|---|---|
| | | Process- | | Proces- |
| Test | Wear of contact | ing | Wear of contact | sing |
| No. | member (membrane) | marks | member (membrane) | Marks |
| No. 1 | Considerable wear | 46^{th} | Tear of membrane | 6^{th} |
| | and partial breakage | process- | and considerable wear | process- |
| | | ing | | ing |
| No. 2 | Considerable wear | 39^{th} | Tear of membrane | 11^{th} |
| | and partial breakage | process- | and considerable wear | process- |
| | | ing | | ing |
| No. 3 | Considerable wear | 36^{th} | Tear of membrane | 4^{th} |
| | and partial breakage | process- | and considerable wear | process- |
| | | ing | | ing |

According to the present invention, the degree of deformation of a contact member by a contact load applied from a workpiece can be reduced. This can maintain a difference in electric resistance between a recessed portion and a raised portion in the surface of the workpiece and can thus produce a difference in processing rate between the recessed portion and the raised portion, providing a processed surface with enhanced flatness.

By using a contact member, for example an ion exchanger, in the form of a thin sheet or film, and disposing the contact member such that its one end surface faces a workpiece so that only the end surface contacts the workpiece during processing, the contact member is allowed to make a linear contact with the workpiece with a narrow contact width. This can reduce wear or breakage of the contact member due to its contact with a processing object, thereby eliminating troubles caused by breakage or tear of the contact member due to its wear and remarkably decreasing the frequency of change of contact member, enabling a long-term processing.

FIG. 31 is a vertical sectional view schematically showing an electrolytic processing apparatus 334 according to yet another embodiment of the present invention. As shown in FIG. 31, the electrolytic processing apparatus 334 includes a arm 340 that can move vertically and pivot horizontally, a substrate holder 342, supported at the free end of the arm 340, for attracting and holding the substrate W with its front surface facing downwardly (face-down), a disk-shaped electrode section 344 of an insulator, positioned beneath the substrate holder 342, and a power source 346 to be connected to the electrode section 344.

The arm 340 is mounted to the upper end of a pivot shaft 350 that is connected to a pivot motor 348, and pivot horizontally by the actuation of the pivot motor 348. The pivot shaft 350 is engaged with a ball screw 352 that extends vertically, and moves vertically together with the arm 340 by the actuation of a vertical-movement motor 354 that is connected to the ball screw 352.

The substrate holder 342 is connected to a substrate-rotating motor 356 as a first drive section, which is allowed to move the substrate W held by a substrate holder 342 and the electrode section 344 relatively to each other. The substrate holder 342 is rotated (about its own axis) by the actuation of the substrate-rotation motor 356. The arm 340 can move vertically and pivot horizontally, as described above, the substrate holder 342 can move vertically and pivot horizontally together with the pivot arm 340. The electrode section 344 is directly connected to a hollow motor 360 as a second drive section, which is allowed to move the substrate W and the electrode section 344 relatively to each other. Therefore, the electrode section 344 makes a translational rotation movement (scroll movement) by the actuation of the hollow motor 360.

The electrode section 344 has fan-shaped processing electrodes 370 and feeding electrodes 372 that are disposed alternatively with their surfaces (upper surfaces) exposed. When processing copper, for example, the processing electrodes 370 are connected to a cathode of the power source 346, and the feeding electrodes 372 are connected to an anode of the power source 346.

A sheet-form contact member 374, which contacts the surface (lower surface) of the substrate W during electrolytic processing, is mounted to the upper surface of the electrode section 344 such that it integrally covers the upper surfaces of the processing electrodes 370 and the feeding electrodes 372. The contact member 374 comprises a non-electrolyte portion 374a not containing an electrolyte, for example, a polishing pad composed of an insulating material, and a large number of electrolyte portions 374b, for example, ion-exchange group portions comprising a solid electrolyte having an ion-exchange group, distributed in the non-electrolyte portion 374a and dotted over substantially the entire contact member 374.

The contact member 374 allows an ion current to pass through only the electrolyte portions 374b of the contact member 374 while inhibiting passage of an ion current through the non-electrolyte portion 374a during processing. This allows one processing electrode 370 to act as if a plurality of processing electrodes were present, or allows each of a plurality of electrolyte portions 374b present in the region corresponding to one processing electrode 370 to act like a processing electrode. The provision of such a contact member 374, which allows one processing electrode 370 to act as if a plurality of processing electrodes were present, makes it possible to dispose the processing sites (electrolyte portions 374b), which act like processing electrodes, efficiently and uniformly between the processing electrodes 370 and the substrate W while moderating restrictions on the arrangement of the processing electrodes 370 and the feeding electrodes 372 taking account of prevention of a short circuit, on the fixing of the contact member 374 and on the provision of a fluid supply section for supplying a fluid. This holds for the feeding electrode 372.

According to this embodiment, the electrolyte portions 374b of the contact member 374 are disposed such that they pass any point in the processing surface of the substrate W, held by the substrate holder 342, a plurality of times and substantially evenly during the relative movement between the substrate W and the electrode section 344. Even when a variation in the processing rate is produced in those portions in the processing surface of the substrate W which are close to or in contact with the electrolyte portions 374b as processing sites, the various processing rates can be averaged by allowing the electrolyte portions 374b, which permit passage of an ion current and can therefore act as processing sites, to pass any point in the processing surface of the substrate W a plurality of times and substantially evenly, thus uniformizing the processing rate over the entire surface of the substrate W.

According to this embodiment, as with the above-described embodiment shown in FIGS. 27 through 29, it is not possible to supply ultrapure water to the upper surface of the electrode section 344 from above the electrode section 344 during electrolytic processing. Pure water, preferably ultrapure water, is supplied to the upper surface of the electrode section 344 only through a through-hole 362a provided in a main shaft 362 and a through-hole 344a provided in the electrode section 344. The through-hole 344a is thus provided as a pure water supply section for supplying pure water, preferably ultrapure water, at the center of the electrode section 344. The through-hole 344a is connected, via the through-hole 362a provided in the main shaft 362, to a pure water supply pipe 376 extending in the hollow portion of the hollow motor 360. Pure water (ultrapure water) is supplied through the through-hole 344a to the upper surface of the electrode section 344, and is then supplied to the entire processing surface.

Beside the electrode section 344 is retreatably disposed an ultrapure water jet nozzle 290 (see FIG. 29) for jetting ultrapure water toward the contact member 374 to clean the electrode section 344 after the completion of electrolytic processing.

According to the electrolytic processing apparatus 334 of this embodiment, similarly to the above-described embodiment shown in FIGS. 27 through 29, the substrate W held by the substrate holder 342 is brought into contact with the upper surface of the contact member 374 of the electrode section 344. The substrate-rotating motor 356 is actuated to rotate the substrate W together with the substrate holder 342 and, at the same time, the hollow motor 360 is actuated to allow the electrode section 344 to make a scroll movement, thus moving the substrate W and the electrode section 344 relative to each other, while a liquid such as pure water, preferably ultrapure water is supplied through the pure water supply pipe 376, the through-hole 362a provided in the main shaft 362, and the through-hole 344a provided in the electrode section 344 to between the substrate W and the contact member 374.

A given voltage is applied from the power source 346 to between the processing electrodes 370 and the feeding electrodes 372 to carry out electrolytic processing of the surface conductive film (copper film 6) of the substrate W at the processing electrodes 370 by the action of hydrogen ions and hydroxide ions produced by the electrolyte portions 374b, comprising a solid electrolyte having an ion-exchange group, of the contact member 374. During electrolytic processing, as described above, each of a plurality of electrolyte portions 374b present in the region corresponding to each processing electrode 370 acts like a processing electrode, and, the electrolyte port ions 374b pass any point in the processing surface of the substrate W, held by the substrate holder 342, a plurality of times and substantially uniformly during the relative movement between the substrate W and the electrode section 344. Accordingly, even when a variation in the processing rate is produced in those portions in the processing surface of the substrate W which are close to or in contact with the electrolyte portions 374b as processing sites, the various processing rates can be averaged, thus enabling processing of the entire surface of the substrate W at a uniform processing rate. Especially when the rotating speed of the substrate holder 342 is zero or very slow, the relative speed between the substrate W and the electrode section 344 can be made substantially equal for any point in the processing surface of the substrate W.

As with the preceding embodiments, during electrolytic processing, the voltage applied between the processing electrodes 370 and the feeding electrodes 372, or an electric current flowing therebetween is monitored with a monitor section to detect the end point of processing.

Instead of pure water or more preferable ultrapure water, it is also possible to supply other liquid having an electric conductivity of not more than 500 μS/cm, for example, an electrolyte solution, i.e. a solution of an electrolyte in pure water or ultrapure water, to between the substrate W and the contact member 374 of the electrode section 344 during electrolytic processing.

The electrolyte portions (ion-exchange group portions) 374b, having an ion-exchange group, of the contact member 374 should preferably have good water permeability. By allowing pure water or ultrapure water to pass through the electrolyte portions 374b, it becomes possible to supply a sufficient amount of water to functional groups (e.g. sulfonic acid groups in a strongly acidic cation-exchange material) that promote the dissociation reaction of water, thereby increasing the amount of dissociated products. Furthermore, processing products (including gas) produced by a reaction between a processing object and hydroxide ions (or OH radicals) can be remove by the flow of water, thereby increasing the processing efficiency.

It is preferred that the electrolyte portion (ion-exchange group portion) 374b be comprised of a non-woven fabric or the like having an anion-exchange group or a cation-exchange group, as described above. It is also possible to use as the electrolyte portion (ion-exchange group portion) 374b a laminate of an anion exchanger having an anion-exchanger group and a cation exchanger having a cation-exchange group. Alternatively, the ion-exchange group portion itself can have both an anion-exchange group and a cation-exchange group. The electrolytic processing apparatus 334 according to the present invention does not involve a mechanical polishing action, and hence a strong pressing of a substrate W against a processing face, as in CMP, is not necessary.

The present invention is applicable to various types of electrolytic processing apparatuses that may employ various combinations of processing liquids and contact members. Further, besides a solid electrolyte having an ion-exchange group, it is possible to use a material containing an electrolyte solution, for example, an electrolyte solution-impregnated ceramic material, for an electrolyte portion.

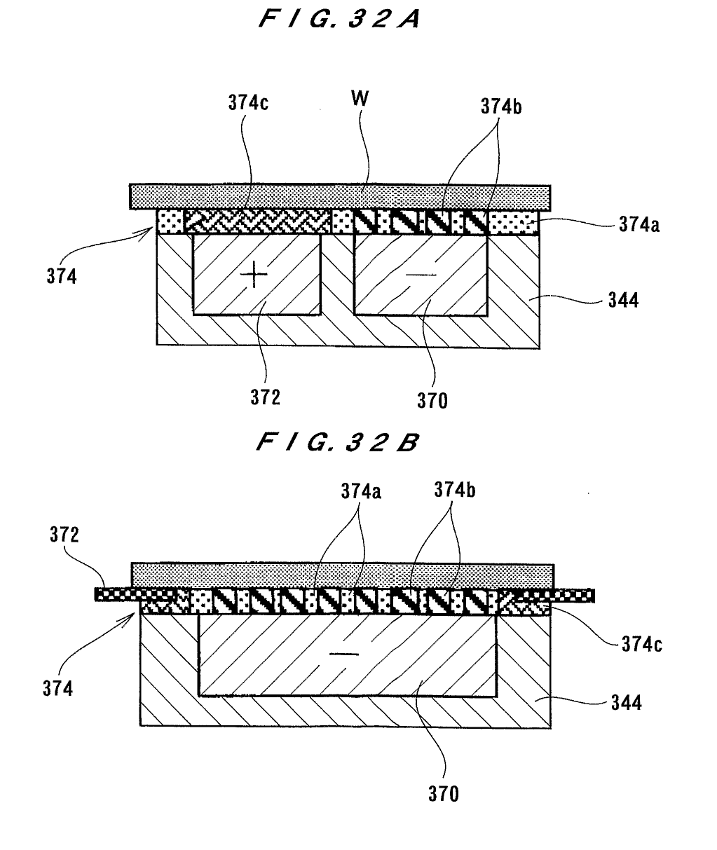

In the above-described embodiment, the contact member 374 comprises the non-electrolyte portion 374a, for example, a polishing pad composed of an insulating material, and the large number of electrolyte portions 374b, dotted in the non-electrolyte portion 374a, comprising a solid electrolyte having an ion-exchange group. As shown in FIG. 32A, it is also possible to use a contact member 374 comprising the same non-electrolyte portion 374a, for example, a polishing pad composed of an insulating material, in which a large number of the same electrolyte portions 374b comprising a solid electrolyte having an ion-exchange group are dotted in the region corresponding to the processing electrode 370, and an electrolyte portion 374c composed of a conductive material, such as a conductive pad or a carbon fiber, is provided in the region corresponding to the feeding electrode 372 such that it covers the feeding electrode 372 so that upon contact of the substrate W with the upper surface of the contact member 374, electricity can be fed from the feeding electrode 372 directly to the surface conductive film (copper film 6) of the substrate W via the electrolyte portion 374c.

As shown in FIG. 32B, it is also possible to use an electrode section 344 having a disc-shaped or radially-extending processing electrode(s) 370 embedded in the surface, and a feeding electrode 372 disposed above the processing electrode(s) 370 and in a peripheral position, and use a contact member 374 comprising the non-electrolyte portion 374a, for example, a polishing pad composed of an insulating material, in which a large number of the electrolyte portions 374b comprising a solid electrolyte having an ion-exchange group are dotted in the region except a peripheral region, and the electrolyte portion 374c composed of a conductive material, such as a conductive pad or a carbon fiber, is provided in the peripheral region such that it is in contact with the feeding electrode 372 so that upon contact of the substrate W with the upper surface of the contact member 374, electricity can be fed from the feeding electrode 372 directly to the surface conductive film (copper film 6) of the substrate W via the electrolyte portion 374c.

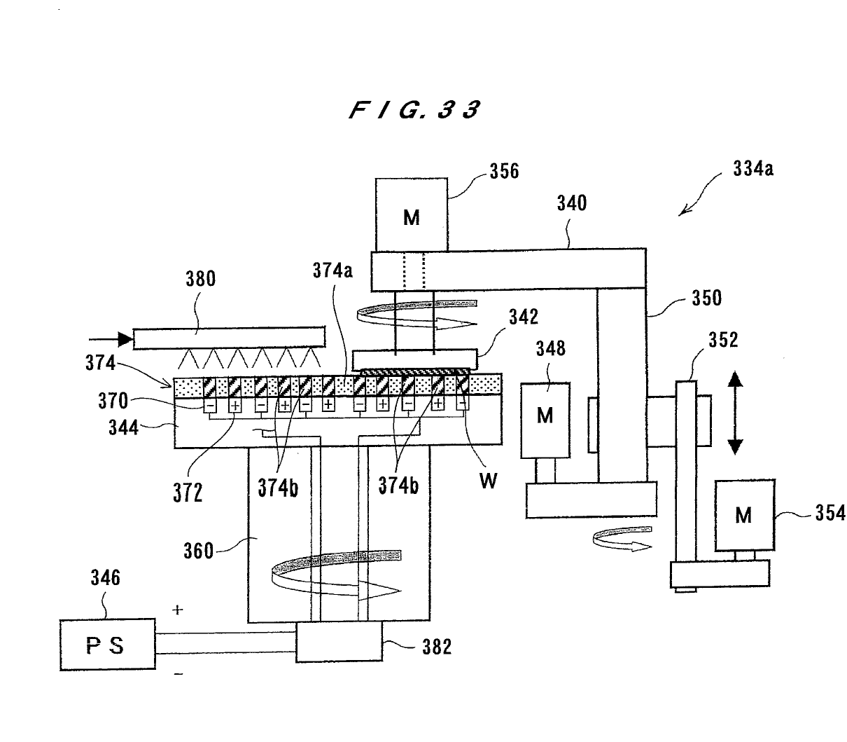

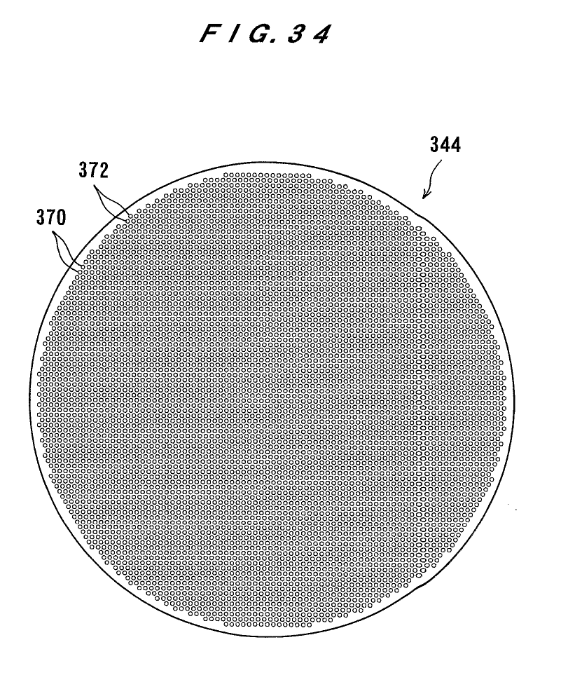

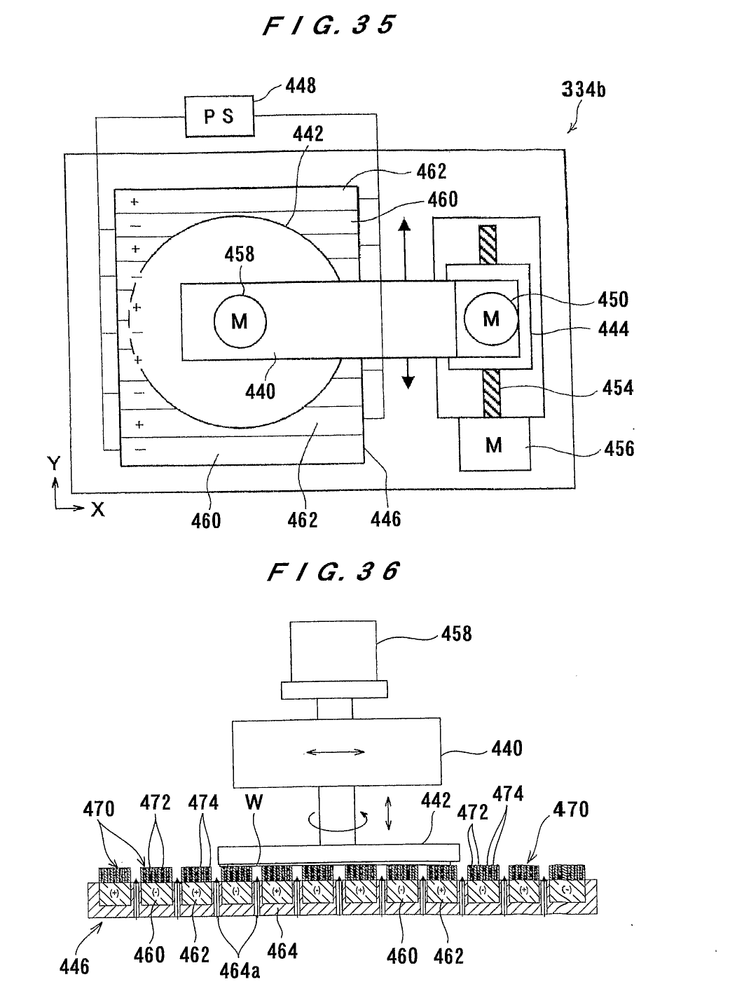

FIGS. 33 and 34 show an electrolytic processing apparatus according to yet another embodiment of the present invention. The electrolytic processing apparatus 334a includes an electrode section 344, having a diameter that is at least twice the diameter of the substrate W, which rotates (about its own axis) by the actuation of a hollow motor 360. A pure water jet nozzle (fluid supply section) 380, extending in a radial direction of the electrode section 344, for supplying pure water, preferably ultrapure water onto the upper surface of the electrode section 344, is disposed above the electrode section 344. The electrode section 344 is composed of an insulating material, and has a large number of columnar processing electrodes 370 connected, via a slip ring 382, to the cathode of a power source 346, and a large number of columnar feeding electrodes 372 connected, via the slip ring 382, to the anode of the power source 346, the electrodes 370, 372 being disposed over substantially the entire upper surface of the electrode section 344. The processing electrodes 370 and the feeding electrodes 372 each have the same shape, and are disposed uniformly over substantially the entire surface of the electrode section 344 so that when the substrate W and the electrode section 344 are moved relative to each other, the frequency of the presence of the electrodes at any point in the processing surface of the substrate W becomes substantially equal.

The processing electrodes 370 and the feeding electrodes 372 are covered integrally with a contact member 374. The contact member 374 comprises a non-electrolyte portion 374a, for example, a polishing pad composed of an insulating material, and a large number of electrolyte portions 374b comprising a solid electrolyte having an ion-exchange group, the electrolyte portions 374b being dotted in the non-electrolyte portion 374a at positions corresponding to the processing electrodes 370 and the feeding electrodes 372. The other construction of the electrolytic processing apparatus 334a is the same as the preceding embodiment.

According to this embodiment, the substrate W, held by the substrate holder 342, is brought into contact with the surface of the contact member 374 of the electrode section 344, and the hollow motor 360 is actuated to rotate the electrode section 344 and, at the same time, the substrate-rotating motor 356 is actuated to rotate the substrate holder 342 and the substrate W, thereby moving the substrate W and the electrode section 344 relative to each other (eccentric rotations), while pure water, preferably ultrapure water, is jetted from the orifices of the pure water jet nozzle 380 to between the substrate W and the electrode section 344. A given voltage is applied from the power source 346 to between the processing electrodes 370 and the feeding electrodes 372 to carry out electrolytic processing of the surface conductive film (copper film 6) at the processing electrodes (cathodes) 370.

According to this embodiment, when the electrode section 344 moves relative to the substrate W during electrolytic processing, a plurality of processing electrodes 370, whose processing amounts per unit time may be uneven, pass any point in the processing surface of the substrate W. Specifically, the processing electrodes 370 and the substrate W are moved relative to each other in such a manner that as many processing electrodes 370 as possible, whose processing amounts per unit time may be uneven, can pass any point in the processing surface of the substrate W. Accordingly, even when there is variation in processing rate among processing electrodes 370, the various processing rates can be averaged, enabling nm/min-order equalization of the processing rate.

Furthermore, during electrolytic processing, by permitting passage of an ion current through the electrolyte portions 374b independently covering the upper surfaces of the processing electrodes 370 and the feeding electrodes 372, and inhibiting passage of an ion current through the non-electrolyte portion 374a surrounding the upper surfaces of the processing electrodes 370 and the feeding electrodes 372, the flow of an ion current through each electrolyte portion 374b can be control led with ease.

It is possible to control a voltage or an electric current independently for each processing electrode 370 or each grouped processing electrodes 370.

FIGS. 35 and 36 show an electrolytic processing apparatus according to yet another embodiment of the present invention. The electrolytic processing apparatus 334b includes an arm 440 that can move vertically and make a reciprocation movement in a horizontal plane, a substrate holder 442, supported at the free end of the arm 440, for attracting and holding the substrate W with its front surface facing downward (face-down), moveable flame 444 to which the arm 440 is attached, a rectangular electrode section 446, and a power source 448 electrically connected to bellow-described processing electrodes 460 and feeding electrodes 462 of electrode section 446.

A vertical-movement motor 450 is mounted on the upper end of the moveable flame 444. A ball screw (not shown), which extends vertically, is connected to the vertical-movement motor 450 The base of the arm 440 is engaged with the ball screw, and the arm 440 moves up and down via the ball screw by the actuation of the vertical-movement motor 450. The moveable flame 444 is connected to a ball screw 454 that extends horizontally, and moves back-and-forth in a horizontal plane with the arm 440 by the actuation of a reciprocating motor 456.

The substrate holder 442 is connected to a substrate-rotating motor 458 supported at the free end of the arm 440. The substrate holder 442 is rotated (about its own axis by the actuation of the substrate-rotating motor 458. The arm 440 can move vertically and make a reciprocation movement in the horizontal direction, as described above. The substrate holder 442 can move vertically and make a reciprocation movement in the horizontal direction integrated with the arm 440.

The electrode section 446 has a plurality of processing electrodes 460 and feeding electrodes 462, extending in an X direction (see FIG. 35), which are arranged alternately in parallel on a rectangular tabular electrode base 464. According to this embodiment, as with the preceding embodiments, thee processing electrodes 460 are connected to the cathode of a power source 448 and the feeding electrodes 462 are connected to the anode of the power source 448. Pure water supply holes 464a for supplying pure water, preferably ultrapure water, to the upper surfaces of each processing electrode 460 and each feeding electrode 462, are provided in the electrode base 464 and between each processing electrode 460 and each feeding electrode 462 at a given pitch along the long direction of the electrodes.

By thus providing the processing electrodes 460 and the feeding electrodes 462 alternately in the Y direction (direction perpendicular to the long direction of the processing electrodes 460 and the feeding electrodes 462) of the electrode section 446, there is no need to provide a feeding section for feeding electricity to the conductive film (processing object) of the substrate W, enabling processing of the entire surface of the substrate W. Further, by applying a pulse voltage (preferably a square-wave voltage of positive potential and 0 potential), it becomes possible to dissolve a processing product and to enhance the flatness of the processed surface through the multiplicity of the repetition of processing.

To the upper surface of each of the processing electrodes 460 and the feeding electrodes 462 is fixed a contact member 470 comprising a laminate such that its one end surface faces upward. The contact member 470 is composed of an insulating material and, according to this embodiment, comprises a laminate of alternating layers of an electrolyte portion 472 comprising a solid electrolyte, for example, prepared by introducing an ion-exchange group into the insulating material, and a non-electrolyte portion 474 without introduction of an ion-exchange group. It is, of course, possible to use a laminate of alternating flat plate-shaped layers of an electrolyte portion comprising an ion exchanger, and a non-electrolyte portion comprising an insulating material, for example, a resin such as PVC or PPS.

The provision of the contact member 470, comprising a laminate of at least one layer of electrolyte portion 472, for example, comprising a solid electrolyte having an ion-exchange group, and at least one layer of non-electrolyte portion 474 not containing an electrolyte, on the surface of each processing electrode 460 allows an ion current to pass through only the electrolyte portion 472 of the contact member 470 while inhibiting passage of an ion current through the non-electrolyte portion 474. This allows one processing electrode 460 to act as if the processing electrode 460 were divided into a plurality of parts, or allows each of a plurality of electrolyte portions 472 of the contact member 470 covering one processing electrode 460 to act like a processing electrode. The provision of such a contact member 470, which allows one processing electrode 460 to act as if the processing electrode 460 were divided into a plurality of parts, makes it possible to dispose the processing sites (electrolyte portions 472), which act like processing electrodes, efficiently and uniformly between the processing electrode 460 and the substrate W. This holds for the feeding electrode 462.

According to this electrolytic processing apparatus 334b, the substrate W, held by the substrate holder 442, is brought into contact with the upper surfaces of the contact members 470 of the electrode section 446, and the substrate-rotating motor 458 is actuated to rotate the substrate W together with the substrate holder 442 and, at the same time, the reciprocating motor 456 is actuated to reciprocate the substrate W, together with the substrate holder 442, in the Y direction shown in FIG. 35, while a fluid, such as pure water, preferably ultrapure water, is supplied from the pure water supply holes 464a to between the substrate W and the processing electrodes 460, feeding electrodes 462.

A given voltage is applied from the power source 448 to between the processing electrodes 460 and the feeding electrodes 462 to carry out electrolytic processing of the surface conductive film (copper film 6) of the substrate W at the processing electrodes 460 by the action of hydrogen ions and hydroxide ions produced by the electrolyte portions 472, comprising a solid electrolyte having an ion-exchange group, of the contact member 470. During electrolytic processing, as described above, each of a plurality of electrolyte portions 472 of the contact member 470 covering the upper surface of each processing electrode 460 acts like a processing electrode, and the substrate W and the processing electrodes 460 are moved relative to each other, whereby uniform processing can be effected over the entire surface of the substrate W.

Though in this embodiment the processing electrodes 460 and the feeding electrode 462 are each independently covered with each contact member 470, it is also possible to integrally cover the processing electrodes 460 and the feeding electrodes 462 with a contact member comprising a laminate. This can facilitate the production of the laminate, and can dispose the contact member at a desired position with ease.

According to the present invention, the provision of the contact member, comprising at least one electrolyte portion containing an electrolyte and at least one non-electrolyte portion not containing an electrolyte, between a workpiece and at least one of a processing electrode and a feeding electrode allows an ion current to pass through only the electrolyte portion of the contact member while inhibiting passage of an ion current through the non-electrolyte portion. This allows one processing electrode, when covered with the contact member, for example, to act as if a plurality of processing electrodes were present, which makes it possible to dispose a number of processing sites efficiently and uniformly between a processing electrode and a workpiece and to process the processing surface of the workpiece at a uniform processing rate over the entire processing surface and provide a high-quality processed surface.

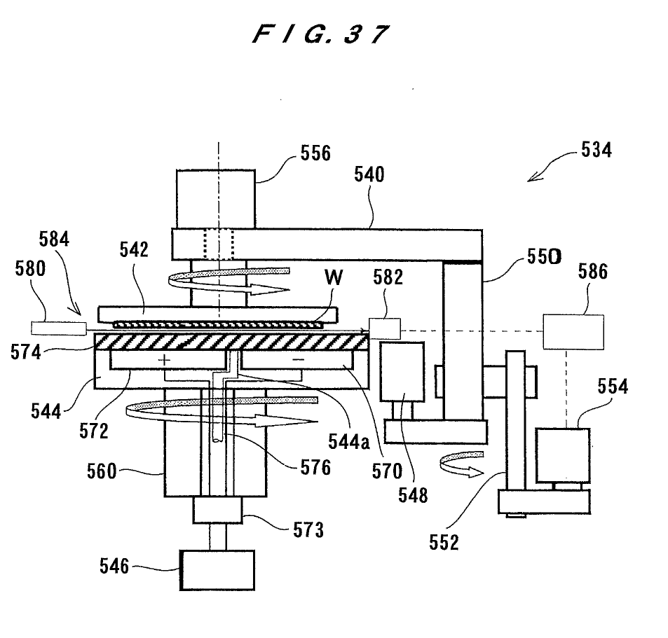

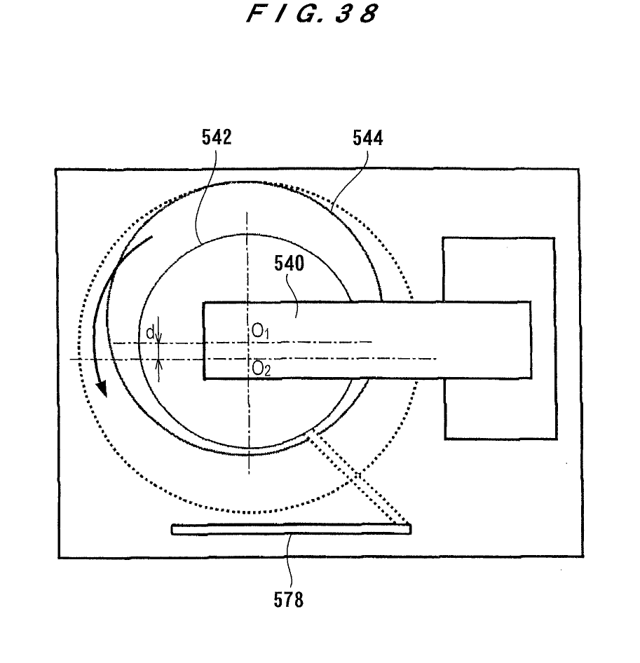

FIG. 37 is a schematic vertical sectional view of an electrolytic processing apparatus 534 according to yet another embodiment of the present invention, and FIG. 38 is a plan view of FIG. 37. As shown in FIG. 37, the electrolytic processing apparatus 534 includes a arm 540 that can move vertically and pivot horizontally, a substrate holder 542, supported at the free end of the arm 540, for attracting and holding the substrate W with its front surface facing downwardly (face-down), a disk-shaped electrode section 544 of an insulator, positioned beneath the substrate holder 542, and a power source 546 to be connected to the electrode section 544.

The arm 540 is mounted to the upper end of a pivot shaft 550 that is connected to a pivot motor 548, and pivots horizontally by the actuation of the pivot motor 548. The pivot shaft 550 is engaged with a ball screw 552 that extends vertically, and moves vertically together with the arm 540 by the actuation of a vertical-movement motor 554 that is connected to the ball screw 552.

The substrate holder 542 is connected to a substrate-rotating motor 556 as a first drive section for moving the substrate W, held by the substrate holder 542, and the electrode section. 544 relative to each other, and rotates about an axis O₁ by the actuation of the substrate-rotating motor 556. The arm 540 is vertically movable and horizontally pivotable, as described above, and therefore the substrate holder 542 can move vertically and pivot horizontally together with the arm 540. The electrode section 544 is directly connected to a hollow motor 560 as a second drive section for moving the substrate W and the electrode section 544 relative to each other, and rotates about an axis 02 by the actuation of the hollow motor 560. The axis O₂ of the electrode section 544 is spaced a distance “d” from the axis O₁ of the substrate holder 542.

A plurality of processing electrodes 570 and feeding electrodes 572, for example, each having the shape of a fan, are embedded alternately in the electrode section 544 with their upper surfaces exposed. As with the preceding embodiments, the processing electrodes 570 are connected, via a rotary connector 573, to the cathode of a power source 546, and the feeding electrodes 572 are connected, via the rotary connector 573, to the anode of the power source 546.

A sheet-form contact member 574, which integrally covers upper surfaces of the processing electrodes 570 and the feeding electrodes 572, and contacts the surface (lower surface) of the substrate W during electrolytic processing, is mounted on the upper surface of the electrode section 544. According to this embodiment, the contact member 574 is comprised of a member containing an electrolyte, for example, an ion exchanger. By thus interposing the contact member 574 containing an electrolyte between the substrate W and the processing electrodes 570, feeding electrodes 572, the processing rate can be increased significantly.

For example, electrochemical processing using ultrapure water is effected by a chemical interaction between hydroxide ions in ultrapure water and a material to be processed. However, the amount of the reactant hydroxide ions in ultrapure water is as small as 10⁻⁷ mol/L under normal temperature and pressure conditions, so that the removal processing efficiency can decrease due to reactions (such as an oxide film-forming reaction) other than the reaction for removal processing. It is therefore necessary to increase hydroxide ions in order to carry out removal processing efficiently. A method for increasing hydroxide ions includes a method which promotes the dissociation reaction of ultrapure water by a catalytic material, and an ion exchanger can be effectively used as such a catalytic material. More specifically, the activation energy relating to water-molecule dissociation reaction is lowered by the interaction between functional groups in an ion exchanger and water molecules, whereby the dissociation of water is promoted to thereby enhance the processing rate.

Further, according to this embodiment, the contact member 574 composed of an ion exchanger is brought into contact with the substrate W during electrolytic processing. When the contact member 574 composed of an ion exchanger is positioned close to the substrate W, though depending on the distance therebetween, the electric resistance is large to some degree and, therefore, a somewhat large voltage is necessary to provide a requisite electric current density. On the other hand, because of the non-contact relation, it is easy to form flow of pure water or ultrapure water along the surface of the substrate W, whereby the reaction product produced on the substrate surface can be efficiently removed. In the case where the contact member 574 composed of an ion exchanger is brought into contact with the substrate W, the electric resistance becomes very small and therefore only a small voltage needs to be applied, whereby the power consumption can be reduced.

If a voltage is raised to increase the current density in order to enhance the processing rate, an electric discharge can occur when the electric resistance between the electrode and the substrate (workpiece) is large. The occurrence of electric discharge causes pitching on the surface of the workpiece, thus failing to form an even and flat processed surface. To the contrary, since the electric resistance is very small when the contact member 574 composed of an ion exchanger is in contact with the substrate W, the occurrence of an electric discharge can be avoided.

According to this embodiment, pure water, preferably ultrapure water is supplied to the upper surface of the electrode section 544 through a through-hole 544a formed in the electrode section 544. Specifically, a through-hole 544a as a pure water supply section for supplying pure water, preferably ultrapure water, is provided at the center of the electrode section 544. The through-hole 544a is connected to a pure water supply pipe 576 extending in the hollow portion of the hollow motor 560. Pure water (ultrapure water) is supplied to the upper surface of the electrode section 544 through the through-hole 544a, and then supplied to the entire processing surface.

As shown in FIG. 38, an ultrapure water-spray nozzle 578 is retreatably provided beside the electrode section 544, which sprays ultrapure water onto the contact member 574 after the electrolytic processing, thereby cleaning and regenerating the contact member 574 with ultrapure water.

Above the electrode section 544 is provided an optical sensor 584 that comprises a laser source 580 for emitting a laser beam and a photo-receiving section 582 for receiving the laser beam. The laser source 580 and the photo-receiving section 582 are disposed on the opposite sides of the substrate W. The optical sensor 584 detects contact or non-contact between the substrate W and the contact member 574 based on receipt or non-receipt by the photo-receiving section 582 of a laser beam emitted from the laser source 580 to between the substrate W held by the substrate holder 542 and the contact member 574. In this regard, when the substrate W contacts the contact member 574 and thus the gap between them becomes zero, the photo-receiving section 582 does not receive a laser beam anymore. The moment of contact between the substrate W and the contact member 574 can therefore be determined by the point of time at which the receipt of a laser beam by the photo-receiving section 582 ceases.

An output from the photo-receiving section 582 of the optical sensor 584 is inputted to a control section 586, and an output from the control section 586 is inputted to the vertical-movement motor 554 so as to control the vertical-movement motor 554 in a feedback manner. According to this embodiment, from the start and throughout electrolytic processing, the optical sensor 584 continually detects contact of the substrate W held by the substrate holder 542 with the contact member 574, i.e., the zero gap between the substrate W and the contact member 574.

In particular, at the start of electrolytic processing, the substrate W is lowered and, upon detection of the zero gap between the substrate W and the contact member 574, the downward feed of the substrate holder 542 by the actuation of the vertical-movement motor 554 is controlled proportionally so that the degree of contact between the substrate W and the contact member 574 reaches a predetermined level. During electrolytic processing, upon detection of separation of the substrate W from the contact member 574 of the electrode section 544, the vertical-movement motor 554 is actuated to lower the substrate holder 542 and, upon detection of contact of the substrate W with the upper surface of the contact member 574, the downward feed of the substrate holder 542 by the actuation of the vertical-movement motor 554 is controlled proportionally so that the degree of contact between the substrate W and the contact member 574 is kept at a constant level.

Though depending also on the rigidity and the surface irregularities of the contact member 574, the degree of contact between the contact member 574 and the substrate W is determined taking account of the contact pressure between the contact member 574 and the substrate W, the processing state (degree of defects such as scratches) of the surface of the substrate W, wear of the contact member 574, etc. From the viewpoint of preference to low contact pressure, the contact pressure between the contact member 574 and the substrate W is generally not more than 13.7 kPa (140 gf/cm², 2.0 psi), preferably not more than 6.86 kPa (70 gf/cm², 1.0 psi), more preferably not more than 3.43 kPa (35 gf/cm², 0.5 psi). By determining the relation between the degree of contact and the contact pressure between the contact member 574 and the substrate W in advance, the contact pressure can be determined from the degree of contact between the contact member 574 and the substrate W.

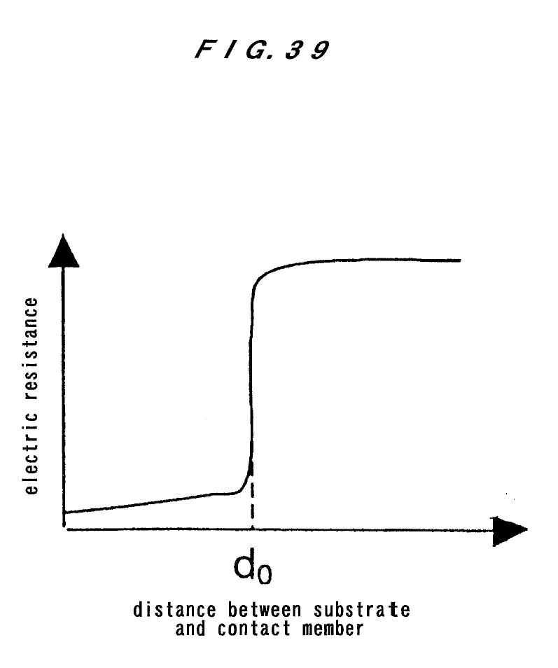

When the substrate W is brought closer to the contact member 574 while applying a very low voltage, for example on the order of 1V, between the processing electrodes 570 and the feeding electrodes 572, the electric resistance between the processing electrodes 570 and the feeding electrodes 572 rises rapidly at the point dₒ at which the substrate W comes into contact with the contact member 574, as shown in FIG. 39. Accordingly, it is also possible to determine contact of the substrate W held by the substrate holder 542 with the contact member 574 by detecting the rapid rise of electric resistance with an electric sensor (not shown). Thus, upon detection of the rapid rise of electric resistance, the downward feed of the substrate holder 542 through the ball screw 552 by the actuation of the vertical-movement motor 554 is controlled proportionally so that the degree of contact between the substrate W and the contact member 574 is kept at a predetermined level.

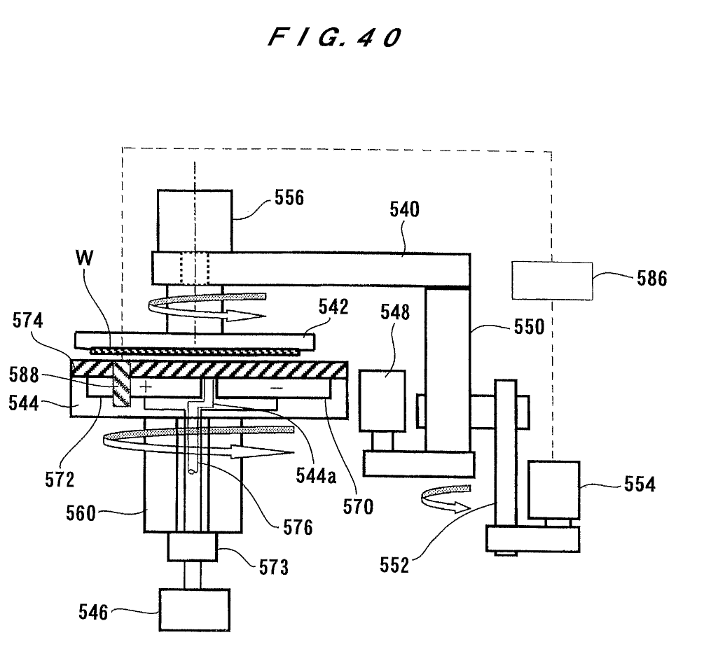

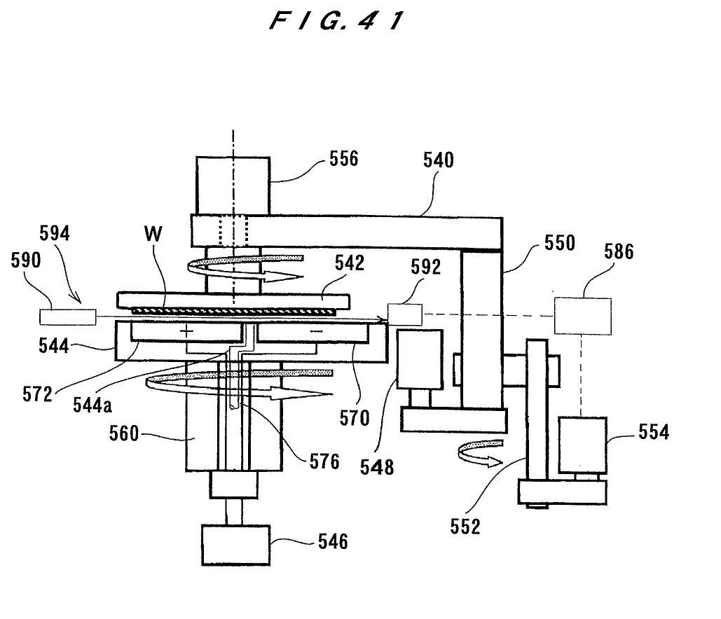

In a case where the contact pressure between the substrate W held by the substrate holder 542 and the contact member 574 is detected with a pressure sensor 588, as in the below-described embodiment shown in FIG. 40, the relationship between the degree of contact and the contact pressure between the contact member 574 and the substrate W may be determined in advance. Based on the relationship, a contact pressure value detected with the pressure sensor 588 can be converted into the degree of contact. Thus, it is possible to control the vertical-movement motor 554 by the control section 586 in a feedback manner to keep the contact pressure at a particular value corresponding to a desired degree of contact, thereby maintaining the desired degree of contact.

According to the electrolytic processing apparatus 534 of this embodiment, similarly to the preceding embodiments, the substrate W held by the substrate holder 542 is brought into contact with the upper surface of the contact member 574 of the electrode section 544. The optical sensor 584 detects contact or non-contact of the substrate W held by the substrate holder 542 with the contact member 574 of the electrode section 544. Upon detection of contact of the substrate W with the upper surface of the contact member 574 of the electrode section 544, the downward feed of the substrate holder 542 by the actuation of the vertical-movement motor 554 is controlled proportionally so that the degree of contact between the substrate W and the contact member 574 is kept at a predetermined level.

Thereafter, the substrate-rotating motor 556 is actuated to rotate the substrate W, together with the substrate holder 542, about the axis O₁ and, at the same time, the hollow motor 560 is actuated to rotate the electrode section 544 about the axis O₂, thereby moving the substrate W and the electrode section 544 relative to each other, while a fluid such as pure water, preferably ultrapure water is supplied through the pure water supply pipe 576 and through the through-hole 544a provided in the electrode section 544 to between the substrate W and the contact member 574.

A given voltage is applied from the power source 546 to between the processing electrodes 570 and the feeding electrodes 572 to carry out electrolytic processing of the surface conductive film (copper film 6) of the substrate W at the processing electrodes 570 by the action of hydrogen ions and hydroxide ions produced by the contact member (ion exchanger) 574 comprising a solid electrolyte.

During electrolytic processing, the voltage applied between the processing electrodes 570 and the feeding electrodes 572, or an electric current flowing therebetween is monitored with a monitor section to detect the end point of processing.

Further, during electrolytic processing, the optical sensor 584 continually detects contact or non-contact of the substrate W held by the substrate holder 542 with the upper surface of the contact member 574 of the electrode section 544 and, upon detection of separation of the substrate W from the upper surface of the contact member 574, the vertical-movement motor 554 is actuated to lower the substrate holder 542 and, upon contact of the substrate W with the upper surface of the contact member 574, the downward feed of the substrate holder 542 by the actuation of the vertical-movement motor 554 is controlled proportionally so that the degree of contact between the substrate W and the contact member 574 is kept at a predetermined level.

As with the preceding embodiments, instead of pure water or more preferable ultrapure water, it is also possible to supply other liquid having an electric conductivity of not more than 500 μS/cm, for example, an electrolyte solution, i.e. a solution of an electrolyte in pure water or ultrapure water, to between the substrate W and the contact member 574 of the electrode section 544 during electrolytic processing.

The contact member (ion exchanger) 574 should preferably have good water permeability. The ion exchanger, constituting the contact member 574, may be comprised of, for example, a non-woven fabric having an anion-exchange group or a cation-exchange group.

The present invention is applicable to various types of electrolytic processing apparatuses that may employ various combinations of processing liquids and contact members. Further, besides an ion exchanger, it is possible to use a material containing an electrolyte solution, for example, an electrolyte solution-impregnated ceramic material, for a contact member. It is also possible to use as a contact member an insulating or conductive pad, or a combination of such a pad and an electrolyte-containing material.

According to this embodiment, in carrying out electrolytic processing by bringing the substrate W into contact with the contact member 574, the degree of contact between the contact member 574 and the substrate W is controlled by, for example, feedback control so that a desired degree of contact can be maintained. This can prevent the degree of contact between the substrate W and the contact member 574 from changing due to a dimensional change before and after a change of contact member 574, deterioration of the contact member 574, etc., there by always maintaining desired processing characteristics, such as processing rate and in-plane uniformity of processing, and extending the life of the contact member 574.

FIG. 40 shows an electrolytic processing apparatus according to yet another embodiment of the present invention. According to the electrolytic processing apparatus shown in FIG. 40, instead of the optical sensor 584 used in the electrolytic processing apparatus shown in FIGS. 37 and 38, a pressure sensor 588 for detecting the contact pressure between the substrate W held by the substrate holder 542 and the contact member 574 is mounted to the electrode section 544. A signal from the pressure sensor 588 is inputted to the control section 586, and a signal from the control section 586 is inputted to the vertical-movement motor 564, thereby controlling the vertical-movement motor 564 in a feedback manner so that the contact pressure between the substrate W and the contact member 574 is kept at a predetermined value. The other construction is the same as the embodiment shown in FIGS. 37 and 38.

According to this embodiment, electrolytic processing is carried out by keeping the contact member 574 and the substrate W in contact while continually detecting the contact pressure between the contact member 574 and the substrate w with the pressure sensor 588, and controlling the vertical-movement motor 554 in a feedback manner so that from the viewpoint of preference to low contact pressure, the contact pressure is kept at a predetermined value which is, as in the preceding embodiment, generally not more than 13.7 kPa (140 gf/cm², 2.0 psi), preferably not more than 6.86 kPa (70 gf/cm², 1.0 psi), more preferably not more than 3.43 kPa (35 gf/cm², 0.5 psi). This can prevent the contact pressure between the substrate W and the contact member 574 from changing due to a dimensional change before and after a change of contact member 574, deterioration of the contact member 574, etc., thereby always maintaining desired processing characteristics, such as processing rate and in-plane uniformity of processing, and extending the life of the contact member 574.

As with the preceding embodiment shown in FIG. 37 and 38, during electrolytic processing, the optical sensor 584 continually detects contact or non-contact of the substrate W held by the substrate holder 542 with the contact member 574 of the electrode section 544 and, upon detection of separation of the substrate W from the contact member 574, the vertical-movement motor 554 is actuated to lower the substrate holder 542 and, upon contact of the substrate W with the contact member 574, the downward feed of the substrate holder 542 by the actuation of the vertical-movement motor 554 is controlled proportionally so that the contact pressure between the substrate W and the contact member 574 is kept at a predetermined level.

FIG. 41 shows an electrolytic processing apparatus according to yet another embodiment of the present invention. According to this embodiment, the plurality of fan-shaped processing electrodes 570 and feeding electrodes 572 are disposed alternately in the upper surface of the electrode section 544, with their upper surfaces exposed, i.e., without being covered with a contact member. In carrying out electrolytic processing, the processing electrodes 570 and the feeding electrodes 572 are brought close to a substrate W without contact, and a voltage is applied between the processing electrodes 570 and the feeding electrodes 572 while supplying pure water, preferably ultrapure water to between the substrate W and the surfaces (upper surfaces) of the processing electrodes 570 and the feeding electrodes 572, thereby electrolytically processing those portions of the substrate W which face the processing electrodes 570. When carrying out electrolytic processing of a substrate W in the presence of pure water or ultrapure water without using an ion exchanger, as in this embodiment, the processing rate is inevitably lowered. This manner of electrolytic processing, however, is especially effective for removing a very thin film. Furthermore, there is no adhesion of unnecessary impurities to the surface of the substrate W.

According to this embodiment, positioned above the electrode section 544, there is provided an optical sensor 594 that comprises a laser source 590 for emitting a laser beam and a photo-receiving section 592 for receiving the laser beam. The laser source 590 and the photo-receiving section 592 are disposed on the opposite sides of the substrate W. The optical sensor 594 detects the distance between the substrate W and the processing electrodes 570, feeding electrodes 572 during electrolytic processing based on receipt by the photo-receiving section 592 of a laser beam emitted from the laser source 590 to between the substrate W held by the substrate holder 542 and the processing electrodes 570, feeding electrodes 572.

An output from the photo-receiving section 592 of the optical sensor 594 is inputted to the control section 586, and an output from the control section 586 is inputted to the vertical-movement motor 554 to control the vertical-movement motor 554 in a feedback manner so that the distance between the substrate W held by the substrate holder 542 and the processing electrodes 570, feeding electrodes 572 is kept at a predetermined value.

According to this embodiment, in carrying out electrolytic processing while keeping the substrate W apart from the processing electrodes 570 and the feeding electrodes 572 without contact, the distance between the substrate W and the processing electrodes 570, feeding electrodes 572 is continually detected with the optical sensor 594, and the vertical-movement motor 554 is controlled in a feedback manner so that the distance is kept at a predetermined value during electrolytic processing. This can prevent the actual distance between the substrate W and the processing electrodes 570, feeding electrodes 572 from differing from the intended distance due to a dimensional change before and after a change of processing electrodes 570 and/or feeding electrodes 572, etc., thereby always maintaining desired processing characteristics, such as processing rate and in-plane uniformity of processing.

In this embodiment processing is carried out while keeping the substrate W apart from the processing electrodes 570 and the feeding electrodes 572. It is also possible to carry out processing by keeping feeding electrodes in contact with a substrate to feed electricity to the substrate while keeping processing electrodes at a certain distance from the substrate. In that case, the distance between the substrate and the processing electrodes may be continually detected with the optical sensor to keep the distance at a predetermined value by feedback control.

It is also possible to use an electric sensor or a pressure sensor instead of the optical sensor and continually detect contact (zero gap) or non-contact between the substrate W and the processing electrodes 570 and/or the feeding electrodes 572 and, upon detection of the contact (zero gap), separate the substrate W from the processing electrodes 570 and/or the feeding electrodes 572.

Further, it is of course possible to use an electrolyte solution, in particular a solution of an electrolyte in a liquid having an electric conductivity of not more than 500 μS/cm, for example, pure water or ultrapure water, or use a liquid having an electric conductivity of not more than 500 μS/cm, preferably not more than 50 μS/cm, more preferably not more than 0.1 μS/cm, prepared by adding e.g. a surfactant to pure water or ultrapure water.

According to the present invention, when carrying out electrolytic processing while keeping a contact member and a workpiece in contact, the degree of contact or the contact pressure between the contact member and the workpiece can be controlled, for example, by feedback control, to maintain a predetermined value. This makes it possible to stabilize processing characteristics and extend the life of the contact member.

Further, when carrying out electrolytic processing while keeping a workpiece and at least one of a processing electrode and a feeding electrode apart from each other, the distance between the workpiece and the at least one of the processing electrode and the feeding electrode can be controlled, for example, by feedback control, to maintain a predetermined distance. This makes it possible to stabilize processing characteristics.

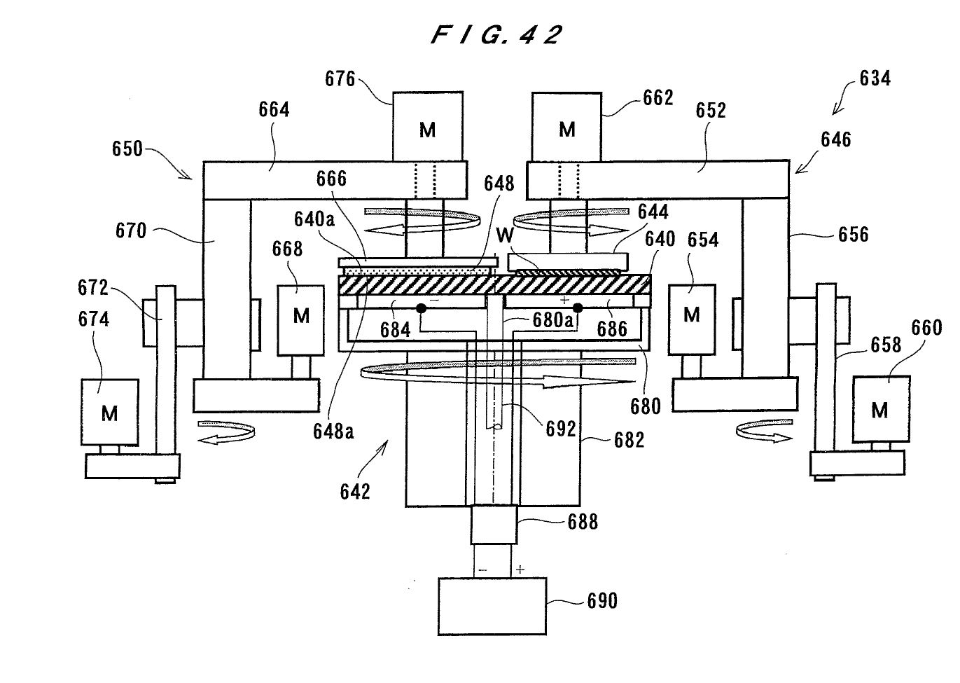

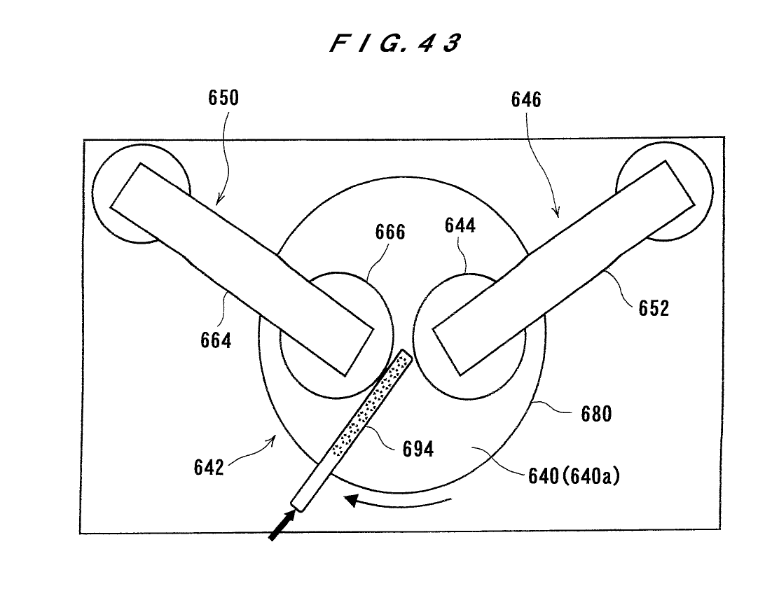

FIG. 42 is a vertical sectional view schematically showing an electrolytic processing apparatus 634 according to yet another embodiment of the present invention, and FIG. 43 is a plan view of the apparatus 634 of FIG. 42. As shown in FIGS. 42 and 43, the electrolytic processing apparatus 634 includes an electrode section 642 having a contact member 640 mounted on the surface, an electrolytic processing section 646 for detachably holding a substrate W by a substrate holder 644 and carrying out electrolytic processing of the substrate W between it and the electrode section 642, and a conditioning section 650 for conditioning the surface (upper surface) of the contact member 640 with a conditioner 648.

According to this embodiment, the electrode section 642 has a diameter which is at least twice the diameter of the substrate W to be held by the substrate holder 644, and the substrate holder 644 and the conditioner 648 can be positioned above the electrode section 642 on the opposite sides of the center of the electrode section 642 so that electrolytic processing of the entire surface of the substrate W and conditioning of the contact member 640 of the electrode section 642 can be carried out simultaneously.

The electrolytic processing section 646 includes an arm 652 which is vertically movable and horizontally pivotable, and the substrate holder 644, for attracting and holding the substrate W with its front surface facing downwardly (face down), is mounted to and suspended from the free end of the arm 652. The arm 652 is mounted to the upper end of a pivot shaft 656 that is coupled to a pivoting motor 654, and pivots horizontally by the actuation of the pivoting motor 654. The pivot shaft 656 is coupled to a vertically-extending ball screw 658 and moves vertically, together with the arm 652, by the actuation of a vertical-movement motor 660 which is coupled to the ball screw 658.

The substrate holder 644 is connected to a substrate-rotating motor 662 as a first drive section for moving the substrate W, held by the substrate holder 644, and the electrode section 642 relative to each other, and rotates (about its own axis) by the actuation of the substrate-rotating motor 662. The arm 652 is vertically movable and horizontally pivotable, as described above, and therefore the substrate holder 644 can move vertically and pivot horizontally together with the arm 652.

Similarly, the conditioning section 650 includes an arm 664 that is vertically movable and horizontally pivotable, and a support 666 is mounted to and suspended from the free end of the arm 664. The conditioner 648 is mounted to the lower surface of the support 666. The arm 664 is mounted to the upper end of a pivot shaft 670 that is coupled to a pivoting motor 668, and pivots horizontally by the actuation of the pivoting motor 668. The pivot shaft 670 is coupled to a vertically-extending ball screw 672, and moves vertically, together with the arm 664, by the actuation of a vertical-movement motor 674 which is coupled to the ball screw 672.

The support 666 is connected to a substrate-rotating motor 676 as a drive section for moving the conditioner 648, mounted to the support 666, and the electrode section 642 relative to each other, and rotates (about its own axis) by the actuation of the substrate-rotating motor 676. The arm 664 is vertically movable and horizontally pivotable, as described above, and therefore the support 666 can move vertically and pivot horizontally together with the arm 664.

The conditioner 648, according to this embodiment, is comprised of a plate-shaped polishing body (fixed abrasive) comprising abrasive grains, such as ceric oxide (CeO₂), fixed in a binder such as a phenolic resin. Conditioning of the contact surface (upper surface) 640a of the contact member 640, i.e., the surface for contact with the substrate W, by polishing is carried out by pressing the polishing surface (lower surface) 648a of the conditioner 648 against the contact surface 640a of the contact member 640 at a given pressure in the presence of a liquid (polishing liquid) while moving the conditioner 648 and the contact member 640 relative to each other.

The use as the conditioner 648 of the polishing body (fixed abrasive) comprising fixed abrasive grains can provide a rigid polishing surface 648a, which makes it possible to polish the contact surface 640a of the contact member 640 at a stable polishing rate and provide a highly flat polished surface while preventing the formation of scratches in the contact surface 640a of the contact member 640. Furthermore, conditioning of the contact member 640 can be carried out while supplying a polishing liquid not containing a polishing abrasive, pure water, ultrapure water or a liquid having an electric conductivity of not more than 500 μS/cm. This makes it possible to carry out conditioning (polishing) of the contact member 640 simultaneously with electrolytic processing of the substrate W and to reduce burdens on the environment.

It is preferred that the flatness of the polishing surface 648a of the conditioner (polishing body) 648 for contact with the contact surface 640a of the contact member 640 be not more than 100 μm, and the diameter of the fixed abrasive grains be not more than 5 μm. This makes it possible to condition (polish) the contact member 640 so that the flatness of the contact surface 640a of the contact member 640 for contact with the substrate W becomes not more than 100 μm and the surface roughnes s of the contact surface 640a becomes not more than 5 μm.

It is also possible to use as a conditioner a polishing pad, for example, composed of a non-woven fabric, a sponge, or a resin material such as a urethane foam, and carry out polishing (conditioning) using free abrasive grains. Such a polishing pad generally has a low rigidity. The use of a polishing pad having a high rigidity can provide a flatter polished surface. Further, the use of free abrasive grains having a diameter of not more than 5 μm can condition (polish) the contact surface 640a of the contact member 640 so that its surface roughness becomes not more than 5 μm.

When a polishing pad is used as the conditioner 648, a conditioning amount (polishing amount) can be controlled by, for example, the material and grain size of the abrasive grains, the contact pressure of the conditioner 648 on the contact surface 640a of the contact member 640, the degree of contact between the conditioner 648 and the contact surface 640a of the contact member 640, the relative movement speed between the conditioner 648 and the contact member 640, the conditioning time (polishing time), etc.

The electrode section 642 includes a disc-shaped table 680 of insulating material, and a hollow motor 682, connected directly to the table 680, as a drive section for rotating (about its own axis) the table 680. A plurality of fan-shaped processing electrodes 684 and feeding electrodes 686 are embedded, with their upper surfaces exposed, in the upper surface of the table 680 and are integrally covered with the contact member 640 in the form of a sheet, which contacts the surface (lower surface) of the substrate W during electrolytic processing.

As with the preceding embodiments, the processing electrodes 684 are connected, via a slip ring 688, to the cathode of a power source 690, and the feeding electrodes 686 are connected, via the slip ring 688, to the anode of the power source 690. The contact member 640, according to this embodiment, is comprised of a member containing an electrolyte, for example, an ion exchanger.

According to this embodiment, pure water, preferably ultrapure water is supplied through a through-hole 680a provided in the table 680 of the electrode section 642 to the upper surface of the electrode section 642. Thus, the through-hole 680a as a pure water supply section for supplying pure water, preferably ultrapure water is provided at the center of the table 680. The through-hole 680a is connected to a pure water supply pipe 692 extending in the hollow portion of the hollow motor 682. Pure water (ultrapure water) is passed through the through-hole 680a and supplied to the upper surface of the electrode section 642 and is then supplied to the entire contact member 640.

Further, as shown in FIG. 43, above the electrode section 642 is disposed a pure water nozzle 694, having a number of orifices and extending in a radial direction of the electrode section 642, as a liquid supply section for supplying pure water, preferably ultra pure water onto the upper surface of the electrode section 642. Pure water, preferably ultrapure water can thus be supplied to the electrode section 642 from above and below simultaneously.

According to the electrolytic processing apparatus 634 of this embodiment, similarly to the preceding embodiments, the substrate W held by the substrate holder 644 is brought into contact with the upper surface of the contact member 640 of the electrode section 642 at a predetermined pressure. From the viewpoint of preference to low contact pressure, the contact pressure between the contact member 640 and the substrate W is generally not more than 13.7 kPa (140 gf/cm², 2.0 psi), preferably not more than 6.86 kPa (70 gf/cm², 1.0 psi), more preferably not more than 3.43 kPa (35 gf/cm², 0.5 psi).

Thereafter, the substrate-rotating motor 662 is actuated to rotate (about its own axis) the substrate W together with the substrate holder 644 and, at the same time, the hollow motor 682 is actuated to rotate (about its own axis) the electrode section 642, thereby moving the substrate W and the electrode section 642 relative to each other, while a fluid, such as pure water, preferably ultrapure water, is supplied through the pure water supply pipe 692 and the through-hole 680a provided in the table 680 of the electrode section 544, and also through the pure water nozzle 694 to the upper surface of the electrode section 642.

It is also possible to supply pure water or the like through either one of the pure water supply pipe 692 and the through-hole 680 provided in the table 680 of the electrode section 642, or the pure water nozzle 694 to the upper surface of the electrode section 642. Further, it is possible to supply pure water or the like through the support 666 and the conditioner 648 of the conditioning section 650 to the upper surface of the electrode section 642.

A given voltage is applied from the power source 690 to between the processing electrodes 684 and the feeding electrodes 686 to carry out electrolytic processing of the surface conductive film (copper film 6) of the substrate W at the processing electrodes 684 by the action of hydrogen ions and hydroxide ions produced by the contact member (ion exchanger) 640 comprising a solid electrolyte.

As with the preceding embodiments, during electrolytic processing, the voltage applied between the processing electrodes 684 and the feeding electrodes 686, or an electric current flowing therebetween is monitored with the monitor section to detect the end point of processing.

Simultaneously with the electrolytic processing, conditioning of the contact member 640 of the electrode section 642 with the conditioner 648 is carried out, according to necessity. In particular, the arm 664 of the conditioning section 650 is moved to move the conditioner 648 mounted to the support 666 to a conditioning position right above the electrode section 642. Next, the vertical-movement motor 674 is actuated to lower the conditioner 648 to thereby bring it into contact with the contact surface (upper surface) 640a, which is for contact with the substrate W, of the contact member 640 of the electrode section 642 at a predetermined pressure and, at the same time, the substrate-rotating motor 676 is actuated to rotate (about its own axis) the conditioner 648, thereby carrying out polishing (conditioning) of the contact surface 640a of the contact member 640 with substrate W in the presence of pure water, preferably ultrapure water by the conditioner 648 comprised of the polishing body (fixed abrasive).

As described above, pure water, preferably ultrapure water is continually supplied to the upper surface of the electrode section 642. Accordingly, polishing (conditioning) of the contact surface 640a of the contact member 640 with the conditioner 648 can be effected by moving the conditioner 648 and the contact member 640 relative to each other while keeping the conditioner 648 in contact with the contact surface 640a of the contact member 640 at a predetermined contact pressure.

The polishing (conditioning) with the conditioner 648 can be controlled by the contact pressure of the conditioner 648 on the contact surface 640a of the contact member 640, the degree of contact of the conditioner 648 with the contact surface 640a of the contact member 640, and the relative movement speed between the conditioner 648 and the contact member 640. The contact pressure and the degree of contact may be changed as desired during conditioning. For example, the contact pressure and the degree of contact may be lowered upon finishing.

After the completion of conditioning, the rotation of the conditioner 648 is stopped, and the conditioner 648 is then raised and the arm 664 is moved to return the conditioner 648 to the original position.

According to this embodiment, the contact pressure of the conditioner 648 on the contact surface 640a of the contact member 640, etc. is controlled by the feed of the ball screw. It is also possible to use a cylinder to move the conditioner 648 up and down, and control the contact pressure of the conditioner 648 on the contact surface 640a of the contact member 640, etc. by adjusting the pressure of the cylinder. It is also possible to employ both the control methods.

It is possible to carry out conditioning of the contact member 640 independent of electrolytic processing, for example, after setting of a contact member 640 and before carrying out electrolytic processing with the contact member 640, after a change of contact member 640 and before carrying out electrolytic processing with the new contact member 640, during an interval between electrolytic processings, etc. In that case, while supplying pure water, preferably ultrapure water to the upper surface of the electrode section 642 and keeping the conditioner 648 in contact with the contact surface 640a of the contact member 640 at a predetermined pressure, the conditioner 648 and the contact member 640 are moved relative to each other, without applying a voltage between the processing electrodes 684 and the feeding electrodes 686.

The use as the conditioner 648 of the polishing body comprising fixed abrasive grains enables conditioning of the contact member 640 to be carried out while supplying pure water or ultrapure water to the upper surface of the electrode section 642. This makes it possible to carry out conditioning of the contact member 640 simultaneously with electrolytic processing of the substrate W and to reduce burdens on the environment.

Instead of pure water or ultrapure water, it is also possible to use other liquid having an electric conductivity of not more than 500 μS/cm, for example, an electrolyte solution, i.e. a solution of an electrolyte in pure water or ultrapure water.

The contact member (ion exchanger) 640 should preferably have good water permeability. The ion exchanger, constituting the contact member 640, may be comprised of, for example, a non-woven fabric having an anion-exchange group or a cation-exchange group.

The present invention is applicable to various types of electrolytic processing apparatuses that may employ various combinations of processing liquids and contact members. Further, besides an ion exchanger, it is possible to use a material containing an electrolyte solution, for example, an electrolyte solution-impregnated ceramic material, for a contact member. It is also possible to use as a contact member an insulating or conductive pad, or a combination of such a pad and an electrolyte-containing material.

According to this embodiment, the contact surface 640a of the contact member 640, which contacts the substrate W during electrolytic processing, can be conditioned by the conditioner 648 of the conditioning section 650 so that the flatness and the surface roughness of the contact surface 640a each become a predetermined value or lower. This can prevent the surface state (flatness and surface roughness) of the contact surface 640a of the contact member 640 from changing due to a change in the state of the contact surface 640a before and after a change of contact member 640, deterioration of the contact surface 640a of the contact member 640 due to its use, etc. The contact state between the contact member 640 and the surface of the substrate W can thus be maintained constant, leading to stabilization of processing characteristics in electrolytic processing and extension of the life of the contact member 640.

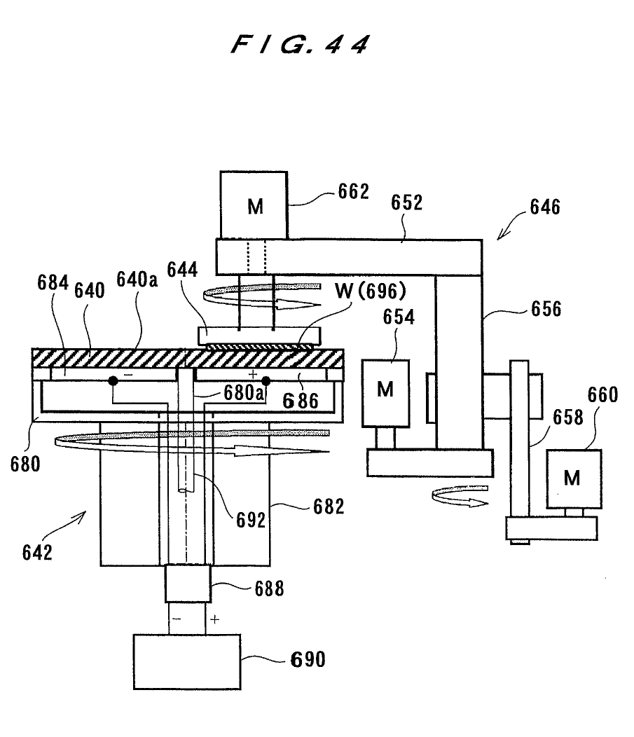

FIG. 44 shows an electrolytic processing apparatus according to yet another embodiment of the present invention. The electrolytic processing apparatus shown in FIG. 44 differs from the electrolytic processing apparatus shown in FIGS. 42 and 43 in that the conditioning section 650 is omitted and a conditioner 696 having a similar shape to the substrate W and comprised of, for example, a polishing body comprising fixed abrasive grains, is provided and that the substrate holder 644 selectively holds the substrate W or the conditioner 696.

According to this embodiment, a substrate W is held by the substrate holder 644, and electrolytic processing of the substrate W is carried out by moving the substrate W held by the substrate holder 644 and the electrode section 642 relative to each other, and applying a given voltage from the power source 690 to between the processing electrodes 684 and the feeding electrodes 686, while supplying pure water or the like to the upper surface of the electrode section 642 and keeping the substrate W in contact with the contact member 640 of the electrode section 642 at a predetermined pressure. Separately, the conditioner 696 is held by the substrate holder 644, and conditioning (polishing) of the contact member 640 is carried out by moving the conditioner 696 held by the substrate holder 644 and the contact member 40 of the electrode section 642 relative to each other, while supplying pure water or the like to the upper surface of the electrode section 642 and keeping the conditioner 696 in contact with the contact member 640 at a predetermined pressure.

It is not possible with this embodiment to carry out conditioning of the contact member 640 simultaneously with electrolytic processing of the substrate W. Conditioning of the contact member 640 must be carried out independent of electrolytic processing, for example, after setting of a contact member 640 and before carrying out electrolytic processing with the contact member 640, after a change of contact member 640 and before carrying out electrolytic processing with the new contact member 640, during an interval between electrolytic processings, etc. This embodiment, however, can simplify the apparatus by the omission of conditioning section.

According to the present invention, the contact surface of a contact member, which contacts a workpiece during electrolytic processing, can be conditioned by a conditioner so that the flatness and the surface roughness of the contact surface each become a predetermined value or lower. This makes it possible to maintain the contact state constant between the contact member and the surface of a workpiece, thereby stabilizing processing characteristics in electrolytic processing and extending the life of the contact member.

### INDUSTRIAL APPLICABILITY

The present invention is used for processing a conductive material formed in a surface of a substrate, such as a semiconductor wafer, or for removing impurities adhering to a surface off a substrate.

1. An electrolytic processing apparatus comprising:
a processing electrode capable of bringing into contact with or closing to a workpiece;
a feeding electrode for feeding electricity to the workpiece;
a contact member disposed between the workpiece and at least one of the processing electrode and the feeding electrode, the degree of deformation of said contact member by a contact load applied from the workpiece being smaller than the initial level difference of surface irregularities of the workpiece;
a power source for applying a voltage between the processing electrode and the feeding electrode; and
a fluid supply section for supplying a fluid between the workpiece and at least one of the processing electrode and the feeding electrode.

2. An electrolytic processing apparatus comprising:
a processing electrode capable of bringing into contact with or closing to a workpiece;
a feeding electrode for feeding electricity to the workpiece;
a contact member disposed between the workpiece and at least one of the processing electrode and the feeding electrode, said contact member having a Young's modulus of not less than 100 MPa;
a power source for applying a voltage between the processing electrode and the feeding electrode; and
a fluid supply section for supplying a fluid between the workpiece and at least one of the processing electrode and the feeding electrode.

3-4. (canceled)

5. An electrolytic processing apparatus comprising:
a processing electrode capable of bringing into contact with or closing to a workpiece;
a feeding electrode for feeding electricity to the workpiece;
a contact member disposed between the workpiece and at least one of the processing electrode and the feeding electrode, said contact member comprising a rigid support covered with a cover material for contact with the workpiece;
a power source for applying a voltage between the processing electrode and the feeding electrode; and
a fluid supply section for supplying a fluid between the workpiece and at least one of the processing electrode and the feeding electrode.

6. The electrolytic processing apparatus according to claim 1, wherein the contact member is comprised of an ion exchanger, an insulator or an electric conductor, or a laminate of any combination thereof.

7. The electrolytic processing apparatus according to claim 5, wherein the support has a Young's modulus of not less than 100 MPa.

8. The electrolytic processing apparatus according to claim 5, wherein the support is composed of an insulating material.

9. The electrolytic processing apparatus according to claim 5, wherein the cover material is comprised of an ion exchanger, an insulator or an electric conductor, or a laminate of any combination thereof.

10. The electrolytic processing apparatus according to claim 1, wherein the contact member is supported floatingly by at least one of the processing electrode and the feeding electrode.

11. The electrolytic processing apparatus according to claim 1, wherein the contact member is a polishing pad or cloth.

12. The electrolytic processing apparatus according to claim 1, wherein the fluid is pure water, ultrapure water or a liquid having an electric conductivity of not more than 500 μS/cm, or an electrolyte solution.

13. An electrolytic processing method comprising:
bringing a processing electrode close to a workpiece;
applying a voltage between the processing electrode and a feeding electrode for feeding electricity to the workpiece;
disposing a contact member between the workpiece and at least one of the processing electrode and the feeding electrode;
supplying a fluid between the workpiece and at least one of the processing electrode and the feeding electrode; and
bringing the contact member into contact with a surface of the workpiece such that the degree of deformation of the contact member by a contact load is smaller than the initial level difference of surface irregularities of the workpiece, thereby processing the surface of the workpiece.

14. An electrolytic processing method comprising:
bringing a processing electrode close to a workpiece;
applying a voltage between the processing electrode and a feeding electrode for feeding electricity to the workpiece;
disposing a contact member having a Young's modulus of not less than 100 MPa between the workpiece and at least one of the processing electrode and the feeding electrode;
supplying a fluid between the workpiece and at least one of the processing electrode and the feeding electrode; and
bringing the contact member into contact with a surface of the workpiece, thereby processing the surface of the workpiece.

15-16. (canceled)

17. An electrolytic processing method comprising:
bringing a processing electrode close to a workpiece;
applying a voltage between the processing electrode and a feeding electrode for feeding electricity to the workpiece;
disposing a contact member between the workpiece and at least one of the processing electrode and the feeding electrode, said contact member comprising a rigid support covered with a cover material for contact with the workpiece;
supplying a fluid between the workpiece and at least one of the processing electrode and the feeding electrode; and
bringing the contact member into contact with a surface of the workpiece, thereby processing the surface of the workpiece.

18. The electrolytic processing method according to claim 13, wherein the contact member is comprised of an ion exchanger, an insulator or an electric conductor, or a laminate of any combination thereof.

19. The electrolytic processing method according to claim 17, wherein the cover material is comprised of an ion exchanger, an insulator or an electric conductor, or a laminate of any combination thereof.

20. The electrolytic processing apparatus according to claim 13, wherein the fluid is pure water, ultrapure water or a liquid having an electric conductivity of not more than 500 μS/cm, or an electrolyte solution.

21-70. (canceled)

71. The electrolytic processing apparatus according to claim 2, wherein the contact member is comprised of an ion exchanger, an insulator or an electric conductor, or a laminate of any combination thereof.

72. The electrolytic processing apparatus according to claim 2, wherein the contact member is supported floatingly by at least one of the processing electrode and the feeding electrode.

73. The electrolytic processing apparatus according to claim 2, wherein the contact member is a polishing pad or cloth.

74. The electrolytic processing apparatus according to claim 2, wherein the fluid is pure water, ultrapure water or a liquid having an electric conductivity of not more than 500 μS/cm, or an electrolyte solution.

75. The electrolytic processing apparatus according to claim 5, wherein the fluid is pure water, ultrapure water or a liquid having an electric conductivity of not more than 500 μS/cm, or an electrolyte solution.

76. The electrolytic processing method according to claim 14, wherein the contact member is comprised of an ion exchanger, an insulator or an electric conductor, or a laminate of any combination thereof.

77. The electrolytic processing apparatus according to claim 14, wherein the fluid is pure water, ultrapure water or a liquid having an electric conductivity of not more than 500 μS/cm, or an electrolyte solution.

78. The electrolytic processing apparatus according to claim 17, wherein the fluid is pure water, ultrapure water or a liquid having an electric conductivity of not more than 500 μS/cm, or an electrolyte solution.
